(19) United States
(12) Patent Application Publication
(10) Pub. No.: US 2026/0363929 A1
(43) Pub. Date: Nov. 19, 2026

(54) Patient Transport Apparatus With Auxiliary Wheel Override Assembly

(71) Applicant: Stryker Corporation, Portage, MI (US)

(72) Inventors: Connor Feldpausch St. John, Kalamazoo, MI (US); Megan Bair, Portage, MI (US); Charles Donald Baker, JR., Portage, MI (US); Gary L. Bartley, Kalamazoo, MI (US); William Dwight Childs, Plainwell, MI (US); Tyler Ethen, Portage, MI (US)

(73) Assignee: Stryker Corporation, Portage, MI (US)

(21) Appl. No.: 19/121,971

(22) PCT Filed: Oct. 18, 2023
(86) PCT No.: PCT/US2023/035372

§ 371 Date: Apr. 17, 2025

Related U.S. Application Data
(60) Provisional application No. 63/417,069, filed on Oct. 18, 2022.

(51) Int. Cl. A61G 7/08; A61G 7/05

(52) U.S. Cl. CPC A61G 7/08; A61G 7/0528

(57) ABSTRACT

A patient transport apparatus includes a support structure including a base and a patient support deck. The patient transport apparatus also includes a plurality of wheels and a braking system being operable between a braked state and a released state. The patient transport further includes a brake input device arranged for user engagement to change operation of the braking system between the braked state and the released state. The patient transport apparatus also further includes an auxiliary wheel assembly including an auxiliary wheel and an actuator configured to move the auxiliary wheel between a plurality of auxiliary support positions including a deployed position and a stowed position. The patient transport apparatus additionally includes an override assembly for move the auxiliary wheel away from the deployed position and toward the stowed position in response to movement of the braking system from the released state to the braked state.

### CROSS-REFERENCE TO RELATED APPLICATION(S)

The subject patent application claims priority to and all the benefits of U.S. Provisional Patent Application No. 63/417,069 filed on Oct. 18, 2022, the disclosure of which is hereby incorporated by reference in its entirety.

### BACKGROUND

Patient transport apparatuses, such as hospital beds, stretchers, cots, wheelchairs, and transport chairs facilitate care of patients in a health care setting. Conventional patient transport apparatuses include a support structure having a patient support deck upon which the patient is supported, wheels to allow the patient transport apparatus to move along the floor, and a braking system having brakes to stop movement of the patient transport apparatus.

At least some known braking systems include manual foot pedals mounted to the support structure to engage or disengage the brakes. Often, the braking system includes a linkage having a plurality of links wherein each of the links is operatively coupled to the brakes such that movement of one link causes movement of the other links and corresponding engagement or disengagement of all the brakes.

Additionally, patient transport apparatuses often include auxiliary wheel assemblies including at least one deployable wheel configured to engage a floor surface to at least partially support the patient transport apparatus. There can be challenges associated with braking the patient transport apparatus while these deployable wheels are contacting the floor surface.

A patient transport apparatus that addresses one or more of the aforementioned challenges is desired.

### SUMMARY

One general aspect of the present disclosure includes a patient transport apparatus. The patient transport apparatus includes a support structure including a base and a patient support deck, and a plurality of wheels coupled to the base for supporting movement of the patient transport apparatus over a floor surface. The patient transport apparatus also includes a braking system including a linkage coupled to one or more of the plurality of wheels. The braking system is operable between a braked state to inhibit movement of the base along the floor surface, and a released state. The patient transport apparatus further includes a brake input device in communication with the linkage and arranged for user engagement to change operation of the braking system between the braked state and the released state. Where the linkage is in a brake state where the braking system is in the braked state, and the brake input device is further configured to move the linkage between a neutral state and a steer state where the braking system is in the released state. The patient transport apparatus also further includes an auxiliary wheel assembly including an auxiliary wheel, an axle assembly supporting the auxiliary wheel, with the axle assembly coupled to the base for pivoting movement relative to the base, and an actuator configured to move the axle assembly and the auxiliary wheel between a plurality of auxiliary support positions. The plurality of auxiliary support positions includes a deployed position where the auxiliary wheel engages the floor surface to at least partially support movement of the patient transport apparatus over the floor surface, and a stowed position where the auxiliary wheel is spaced from the floor surface. The patient transport apparatus additionally includes an override assembly coupled to the linkage of the braking system and to the auxiliary wheel assembly to move the auxiliary wheel from the deployed position to the stowed position in response to movement of the linkage from the steer state to one of the neutral state and the brake state to at least partially disengage the auxiliary wheel from the floor surface.

Another general aspect of the present disclosure provides a patient transport apparatus including: a support structure with a base and a patient support deck; a plurality of wheels coupled to the base for supporting movement of the patient transport apparatus over a floor surface; a braking system including a linkage coupled to one or more of the plurality of wheels and being operable between: a braked state to inhibit movement of the base along the floor surface, and a released state; a brake input device in communication with the linkage and arranged for user engagement to change operation of the braking system between the braked state and the released state; an auxiliary wheel assembly coupled to the support structure and including an auxiliary wheel and an actuator configured to move the auxiliary wheel between a plurality of auxiliary support positions including: a deployed position where the auxiliary wheel engages the floor surface to at least partially support movement of the patient transport apparatus over the floor surface, and a stowed position where the auxiliary wheel is spaced from the floor surface; and an override assembly coupled to the linkage of the braking system and to the auxiliary wheel assembly to move the auxiliary wheel away from the deployed position and toward the stowed position in response to movement of the braking system from the released state toward the braked state to concurrently: inhibit movement of the base along the floor surface in the braked state, and at least partially disengage the auxiliary wheel from the floor surface.

### BRIEF DESCRIPTION OF THE DRAWINGS

FIG. 1 is a perspective view of a patient transport apparatus including an auxiliary wheel assembly.

FIG. 2 is a side view of the patient transport apparatus of FIG. 1.

FIG. 3 is a perspective view of a portion of the patient transport apparatus illustrating a braking system.

FIG. 4 is a top view of the portion of the patient transport apparatus illustrating the braking system.

FIG. 5A is a cross-sectional view of a caster assembly that may be used with the braking system with a brake in a braked state.

FIG. 5B is a cross-sectional view of a caster assembly that may be used with the braking system with the brake in a released state.

FIG. 6A is a close-up perspective view of a portion of the braking system shown in a released state where linkage is in a neutral state.

FIG. 6B is a close-up perspective view of a portion of the braking system shown in a braked state.

FIG. 6C is a close-up perspective view of a portion of the braking system shown in the released state where the linkage is in a steer state.

FIG. 7 is a block diagram of components of the electro-mechanical braking system of some examples of the patient transport apparatus.

FIG. 8A is a schematic partial side view of the patient transport apparatus including an auxiliary wheel assembly with an auxiliary wheel in a stowed position.

FIG. 8B is a schematic partial side view of the patient transport apparatus including an auxiliary wheel assembly with an auxiliary wheel in a deployed position.

FIG. 8C is a schematic partial side view of the patient transport apparatus including an auxiliary wheel assembly with an auxiliary wheel in another configuration of the deployed position.

FIGS. 9A and 9B are schematic partial side views of the patient transport apparatus including the auxiliary wheel assembly and a spring cartridge for biasing the auxiliary wheel toward the deployed position 302D.

FIGS. 10A and 10B are schematic partial side views of the patient transport apparatus including an override assembly for moving the auxiliary wheel away from the deployed position (FIG. 10A) and toward the stowed position (FIG. 10B) in response to movement of the braking system from the released state to the braked state.

FIG. 11A is a perspective view of one example of the auxiliary wheel assembly in the deployed position and the override assembly including an override linkage in an extended state.

FIG. 11B is a perspective view of the auxiliary wheel assembly in an intermediate position and the override assembly including the override linkage in an intermediate state.

FIG. 11C is a perspective view of the auxiliary wheel assembly in the stowed position and the override assembly including the override linkage in a collapsed state.

FIG. 12 is a perspective view of one example of the auxiliary wheel assembly including a suspension system.

FIG. 13 is an exploded view of FIG. 12.

FIG. 14A is a side view of the auxiliary wheel assembly and the override assembly of FIG. 11A illustrated relative to a floor surface.

FIG. 14B is a side view of the auxiliary wheel assembly and the override assembly of FIG. 11B illustrated relative to a floor surface.

FIG. 14C is a side view of the auxiliary wheel assembly and the override assembly of FIG. 11C illustrated relative to a floor surface.

FIG. 14D is a side view of the auxiliary wheel assembly where the one or more auxiliary wheels is in the deployed position due to operation of the actuator.

FIG. 14E is a side view of the auxiliary wheel assembly where the one or more auxiliary wheels is in the intermediate position due to operation of the actuator.

FIG. 14F is a side view of the auxiliary wheel assembly where the one or more auxiliary wheels is in the stowed position due to operation of the actuator. FIG. 15A is a partial perspective view of one example of the override assembly.

FIG. 15B is an exploded view of the override assembly of FIG. 15A.

FIG. 16A is a partial front view of the patient transport apparatus including a linkage of the braking system disposed in a first base rail with the braking system in the released state and the linkage in the steer state.

FIG. 16B is a partial front view of the patient transport apparatus including the linkage of the braking system disposed in a first base rail with the braking system in the released state and the linkage in the neutral state.

FIG. 16C is a partial front view of the patient transport apparatus including the linkage of the braking system disposed in a first base rail with the braking system and the linkage in the braked state.

FIG. 17A is a partial top view of the auxiliary wheel assembly and the override assembly of FIG. 15A, with the actuator in an operational position.

FIG. 17B is a partial top view of the auxiliary wheel assembly and the override assembly of FIG. 15A, with the actuator between the operational position and an override position.

FIG. 17C is a partial top view of the auxiliary wheel assembly and the override assembly of FIG. 15A, with the actuator in the override position.

FIG. 18A is a perspective view of another example of the auxiliary wheel assembly and the override assembly where the auxiliary wheel is in the deployed position.

FIG. 18B is a perspective view of the auxiliary wheel assembly and the override assembly of FIG. 18A where the auxiliary wheel is in an intermediate position.

FIG. 18C is a perspective view of the auxiliary wheel assembly and the override assembly of FIG. 18A where the auxiliary wheel is in the stowed position.

FIG. 19A is a side view of the auxiliary wheel assembly and the override assembly of FIG. 18A illustrated relative to a floor surface.

FIG. 19B is a side view of the auxiliary wheel assembly and the override assembly of FIG. 18B illustrated relative to a floor surface.

FIG. 19C is a side view of the auxiliary wheel assembly and the override assembly of FIG. 18C illustrated relative to a floor surface.

FIG. 20A is another perspective view of the auxiliary wheel assembly and the override assembly of FIG. 18A.

FIG. 20B is an exploded view of FIG. 20B.

FIG. 20C is a bottom perspective view of the auxiliary wheel assembly and the override assembly, including a biasing member.

FIG. 21 is a perspective view of one example of the override assembly.

FIG. 22A is a front view of the auxiliary wheel assembly and the override assembly where the auxiliary wheels are in the deployed state and moving toward the stowed state due to operation of the override assembly.

FIG. 22B is a front view of the auxiliary wheel assembly and the override assembly where the auxiliary wheels are in an intermediate state and moving toward the stowed state due to operation of the override assembly.

FIG. 22C is a front view of the auxiliary wheel assembly and the override assembly where the auxiliary wheels reach the stowed state due to operation of the override assembly.

FIG. 23A is a partial section view of the auxiliary wheel assembly and the override assembly of FIG. 22A illustrating the override assembly moving a cam driver to move the auxiliary wheels from the deployed state toward the stowed state.

FIG. 23B is a partial section view of the auxiliary wheel assembly and the override assembly of FIG. 22B illustrating the override assembly continuing to move the cam driver to move the auxiliary wheels from the deployed state toward the stowed state.

FIG. 23C is a partial section view of the auxiliary wheel assembly and the override assembly of FIG. 22C illustrating the override assembly continuing to move the cam driver to move the auxiliary wheels from the deployed state toward the stowed state.

FIG. 24A is a front view of the auxiliary wheel assembly and the override assembly where the auxiliary wheels are in the deployed state and moving toward the stowed state due to operation of the actuator.

FIG. 24B is a front view of the auxiliary wheel assembly and the override assembly where the auxiliary wheels are in an intermediate state and moving toward the stowed state due to operation of the actuator.

FIG. 24C is a front view of the auxiliary wheel assembly and the override assembly where the auxiliary wheels reach the stowed state due to operation of the actuator.

FIG. 25A is a partial section view of the auxiliary wheel assembly and the override assembly of FIG. 24A illustrating the actuator moving the cam driver to move the auxiliary wheels from the deployed state toward the stowed state.

FIG. 25B is a partial section view of the auxiliary wheel assembly and the override assembly of FIG. 24B illustrating the actuator continuing to move the cam driver to move the auxiliary wheels from the deployed state toward the stowed state.

FIG. 25C is a partial section view of the auxiliary wheel assembly and the override assembly of FIG. 24C illustrating the actuator continuing to move the cam driver to move the auxiliary wheels from the deployed state toward the stowed state.

FIG. 26A is a front view of the auxiliary wheel assembly and the override assembly where the auxiliary wheels reach the deployed state due to operation of the actuator.

FIG. 26B is a front view of the auxiliary wheel assembly and the override assembly where the auxiliary wheels are in an intermediate state and moving toward the deployed state due to operation of the actuator.

FIG. 26C is a front view of the auxiliary wheel assembly and the override assembly where the auxiliary wheels are in the stowed state and moving toward the deployed state due to operation of the actuator.

FIG. 27A is a partial section view of the auxiliary wheel assembly and the override assembly of FIG. 26A illustrating the actuator moving the cam driver to move the auxiliary wheels from the stowed state toward the deployed state.

FIG. 27B is a partial section view of the auxiliary wheel assembly and the override assembly of FIG. 26B illustrating the actuator continuing to move the cam driver to move the auxiliary wheels from the stowed state toward the deployed state.

FIG. 27C is a partial section view of the auxiliary wheel assembly and the override assembly of FIG. 26C illustrating the actuator continuing to move the cam driver to move the auxiliary wheels from the stowed state toward the deployed state.

FIG. 28 is a partial perspective view of a portion of a patient transport apparatus shown depicting a version of a brake input device.

FIG. 29A is a front view of portions of the brake input device of FIG. 28, shown with a pedal arranged in a horizontal arrangement and coupled to a linkage arranged in a neutral state.

FIG. 29B is another front view of the portions of the brake input device of FIG. 29A, shown with the pedal having been rotated in a first direction to move the linkage.

FIG. 29C is another front view of the portions of the brake input device of FIG. 29B, shown with the pedal having been rotatably urged in a second direction back to the horizontal arrangement but without having moved the linkage.

FIG. 29D is another front view of the portions of the brake input device of FIG. 29C, shown with the pedal having been rotated further in the second direction and having moved the linkage back to the neutral state.

FIG. 29E is another front view of the portions of the brake input device of FIG. 29D, shown with pedal having been rotatably urged in the first direction back to the horizontal arrangement with the linkage remaining in the neutral state.

FIG. 30A is a perspective view of yet another example of the auxiliary wheel assembly and the override assembly where the auxiliary wheel is in the deployed position.

FIG. 30B is a perspective view of the auxiliary wheel assembly and the override assembly of FIG. 30A where the auxiliary wheel is in the stowed position.

FIG. 31A is a side view of the auxiliary wheel assembly and the override assembly of FIG. 30A illustrated relative to a floor surface.

FIG. 31B is a side view of the auxiliary wheel assembly and the override assembly of FIG. 30B illustrated relative to a floor surface.

FIG. 32 is an exploded view of the auxiliary wheel assembly and the override assembly of FIGS. 30A-31B.

FIG. 33 is a perspective view of one configuration of a cam assembly of the override assembly.

FIG. 34 is a perspective view of the auxiliary wheel assembly and the override assembly where a number of components have been hidden to reveal the cam assembly.

FIG. 35 is a top view of the auxiliary wheel assembly and the override assembly including a first section line K-K taken through a cam driver and a second section line L-L taken though a roller arm.

FIG. 36 is a partial cross-sectional representation of the auxiliary wheel assembly and the override assembly taken along line L-L to reveal one configuration of the roller arm.

FIG. 37 is a partial cross-sectional representation of the auxiliary wheel assembly and the override assembly taken along line L-L to reveal another configuration of the roller arm.

FIG. 38A is a partial perspective view of the auxiliary wheel assembly and the override assembly illustrating a first pedal in a first pedal steer position and the linkage in the steer state.

FIG. 38B is a partial perspective view of the auxiliary wheel assembly and the override assembly illustrating the first pedal in a first pedal neutral position and the linkage in the neutral state.

FIG. 38C is a partial perspective view of the auxiliary wheel assembly and the override assembly illustrating the first pedal in a first pedal brake position and the linkage in the brake state.

FIG. 39A is a partial cross-sectional representation of the auxiliary wheel assembly and the override assembly of FIG. 38A taken along line K-K.

FIG. 39B is a partial cross-sectional representation of the auxiliary wheel assembly and the override assembly of FIG. 38B taken along line K-K.

FIG. 39C is a partial cross-sectional representation of the auxiliary wheel assembly and the override assembly of FIG. 38C taken along line K-K.

FIG. 40A is a partial cross-sectional representation of the auxiliary wheel assembly and the override assembly of FIG. 38A taken along line L-L.

FIG. 40B is a partial cross-sectional representation of the auxiliary wheel assembly and the override assembly of FIG. 38B taken along line L-L.

FIG. 40C is a partial cross-sectional representation of the auxiliary wheel assembly and the override assembly of FIG. 38C taken along line L-L.

FIG. 41 is a partial perspective representation of the brake input device including the first pedal and a second pedal assembly.

FIG. 42 is a partial cross-section representation of the second pedal assembly.

FIG. 43 is an exploded view of the second pedal assembly.

FIG. 44A is a partial perspective view of the auxiliary wheel assembly and the override assembly illustrating the second pedal assembly where the linkage is in the brake state.

FIG. 44B is a partial perspective view of the auxiliary wheel assembly and the override assembly illustrating movement of the second pedal assembly in response to user engagement.

FIG. 44C is a partial perspective view of the auxiliary wheel assembly and the override assembly illustrating movement of the second pedal assembly in response to further user engagement to move the linkage of the steering system to the neutral state.

FIG. 44D is a partial perspective view of the auxiliary wheel assembly and the override assembly illustrating movement of the second pedal assembly via a second pedal biasing member.

FIG. 45 is a partial perspective representation of second pedal assembly moving in response to the user engagement illustrated in FIG. 44B.

FIG. 46 is a partial perspective representation of second pedal assembly moving in response to the user engagement illustrated in FIG. 44C.

FIG. 47 is a cross-sectional representation of the auxiliary wheel assembly and the override assembly taken along line K-K illustrating movement of the cam driver in response to the user engagement illustrated in FIG. 44C.

FIG. 48 is a cross-sectional representation of the auxiliary wheel assembly and the override assembly taken along line K-K illustrating movement of the cam assembly to the cam intermediate position in response to the user engagement illustrated in FIG. 44C.

FIG. 49A is a cross-sectional representation of the auxiliary wheel assembly and the override assembly taken along line K-K illustrating an actuator driving member.

FIG. 49B is a cross-sectional representation of the auxiliary wheel assembly and the override assembly taken along line K-K illustrating the actuator driving member moving in response to operation of the actuator to move the cam assembly to the cam lower position.

FIG. 49C is a cross-sectional representation of the auxiliary wheel assembly and the override assembly taken along line K-K illustrating the actuator driving member moving in response to operation of the actuator to move the cam assembly to the cam lift position.

FIG. 50A is a cross-sectional representation of the auxiliary wheel assembly and the override assembly taken along line L-L illustrating the cam assembly in the cam intermediate position.

FIG. 50B is a cross-sectional representation of the auxiliary wheel assembly and the override assembly taken along line L-L illustrating the cam assembly moving to the cam lower position in response to operation of the actuator.

FIG. 50C is a cross-sectional representation of the auxiliary wheel assembly and the override assembly taken along line L-L illustrating the cam assembly moving to the cam lift position in response to operation of the actuator.

### DETAILED DESCRIPTION

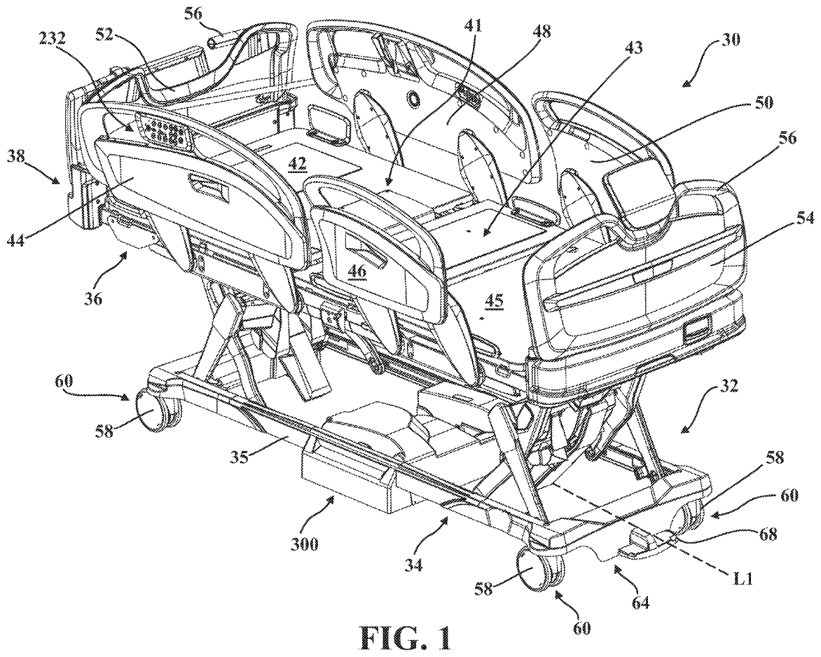

Referring to FIG. 1, a patient transport apparatus 30 is shown for supporting a patient in a health care setting. The patient transport apparatus 30 illustrated in FIG. 1 is a hospital bed. In other versions, however, the patient transport apparatus 30 may be a stretcher, cot, wheelchair, transport chair, or similar apparatus utilized in the care of a patient.

A support structure 32 provides support for the patient. The support structure 32 illustrated in FIG. 1 includes a base 34 and a support structure 36. The base 34 includes a base frame 35. The support structure 36 is spaced above the base frame 35 in FIG. 1. The support structure 32 also includes a patient support deck 38 disposed on the support structure 36. The patient support deck 38 includes several sections, some of which are capable of articulating (e.g., pivoting) relative to the support structure 36, such as a back (fowler) section 41, a seat section 43, a leg section 45, and a foot section 47. The patient support deck 38 provides a patient support surface 42 upon which the patient is supported.

A mattress (not shown) is disposed on the patient support deck 38 during use. The mattress includes a secondary patient support surface upon which the patient is supported. The base 34, support structure 36, patient support deck 38, and patient support surfaces 42 each have a head end and a foot end corresponding to designated placement of the patient's head and feet on the patient transport apparatus 30. The base 34 includes a longitudinal axis L1 along its length from the head end to the foot end. The construction of the support structure 32 may take on any known or conventional design and is not limited to that specifically set forth above. In addition, the mattress may be omitted in certain versions, such that the patient rests directly on the patient support surface 42.

Patient barriers, such as side rails 44, 46, 48, 50 are coupled to the support structure 36 and/or patient support deck 38 and are thereby supported by the base 34. A first side rail 44 is positioned at a right head end. A second side rail 46 is positioned at a right foot end. A third side rail 48 is positioned at a left head end. A fourth side rail 50 is positioned at a left foot end. In the version shown, the head end side rails 44, 48 are mounted to the back section 41 for movement with the back section 41. The foot end side rails 46, 50 are mounted to the support structure 36 for movement with the support structure 36. If the patient transport apparatus 30 is a stretcher or a cot, there may be fewer side rails. The side rails 44, 46, 48, 50 are movable relative to the back section 41/support structure 36 to a raised position in which they block ingress and egress into and out of the patient transport apparatus 30, one or more intermediate positions, and a lowered position in which they are not an obstacle to such ingress and egress. In the version shown, the side rails 44, 46, 48, 50 are connected to the back section 41 and/or the support structure 36 by pivotal support arms to form four bar linkages. Such side rails and the manner in which they may be raised/lowered are shown and described in U.S. Patent Application Publication No. 2017/0172829, filed on Dec. 15, 2016 and entitled “Powered Side Rail For A Patient Support Apparatus,” hereby incorporated by reference in its entirety.

A headboard 52 and a footboard 54 are coupled to the support structure 36. The headboard 52 and footboard 54 may be coupled to any location on the patient transport apparatus 30, such as the support structure 36 or the base 34. In still other versions, the patient transport apparatus 30 does not include the headboard 52 and/or the footboard 54.

Caregiver interfaces 56, such as handles, are shown integrated into the headboard 52, footboard 54, and side rails 44, 46, 48, 50 to facilitate movement of the patient transport apparatus 30 over a floor surface. Additional caregiver interfaces 56 may be integrated into other components of the patient transport apparatus 30. The caregiver interfaces 56 are graspable by the caregiver to manipulate the patient transport apparatus 30 for movement, to move the side rails 44, 46, 48, 50, and the like.

Other forms of the caregiver interface 56 are also contemplated. The caregiver interface may include one or more handles coupled to the support structure 36. The caregiver interface may simply be a surface on the patient transport apparatus 30 upon which the caregiver logically applies force to cause movement of the patient transport apparatus 30 in one or more directions, also referred to as a push location. This may include one or more surfaces on the support structure 36 or base 34. This could also include one or more surfaces on or adjacent to the headboard 52, footboard 54, and/or side rails 44, 46, 48, 50. In other versions, the caregiver interface may include separate handles for each hand of the caregiver. For example, the caregiver interface may include two handles.

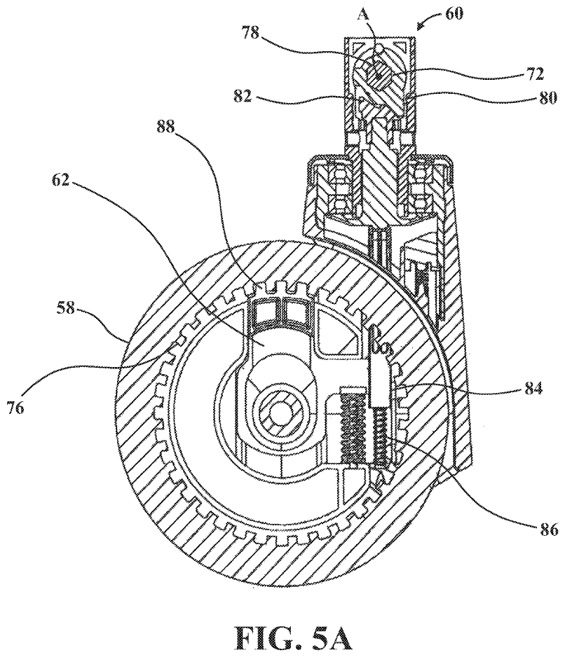

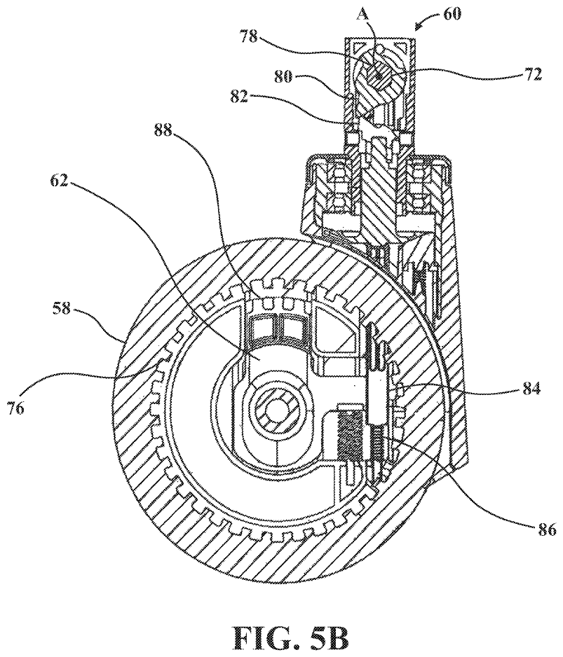

A mobility arrangement is coupled to the base 34 to facilitate transport over floor surfaces FS. The mobility arrangement includes a plurality of wheels 58. The wheels 58 are arranged in each of four quadrants of the base 34 adjacent to corners of the base 34. In the version shown, the wheels 58 are caster wheels able to rotate and swivel relative to the support structure 32 during transport. Each of the wheels 58 forms part of a caster assembly 60. Each caster assembly 60 is mounted to the base 34 and includes a brake 62 to brake the wheel 58 (one example of which is shown in FIGS. 5A-5B). It should be understood that various configurations of the caster assemblies 60 are contemplated. In addition, in some versions, the wheels 58 are not caster wheels and may be non-steerable, steerable, non-powered, powered, or combinations thereof. Additional wheels are also contemplated. For example, the patient transport apparatus 30 may include four non-powered, non-steerable wheels, along with one or more powered wheels.

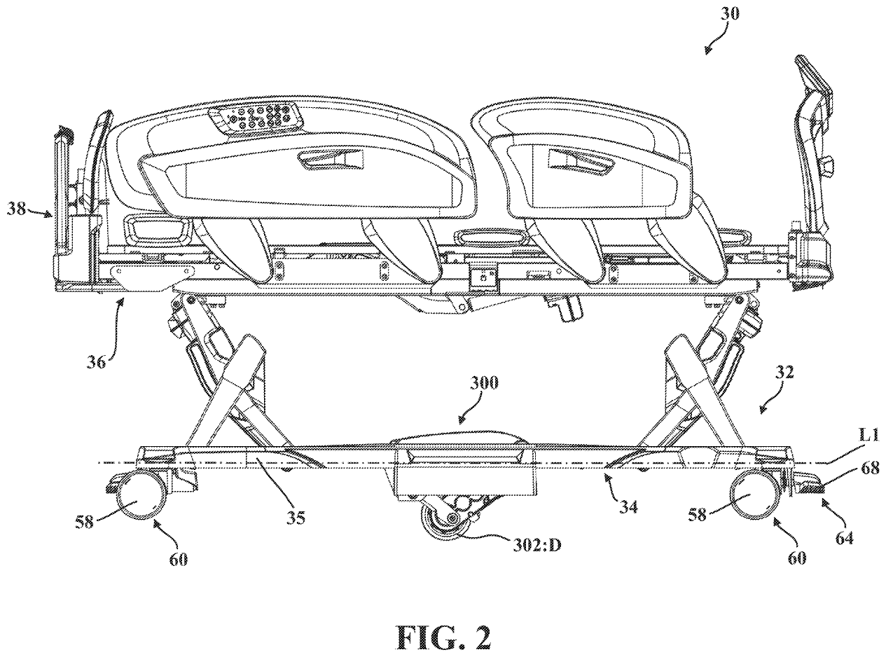

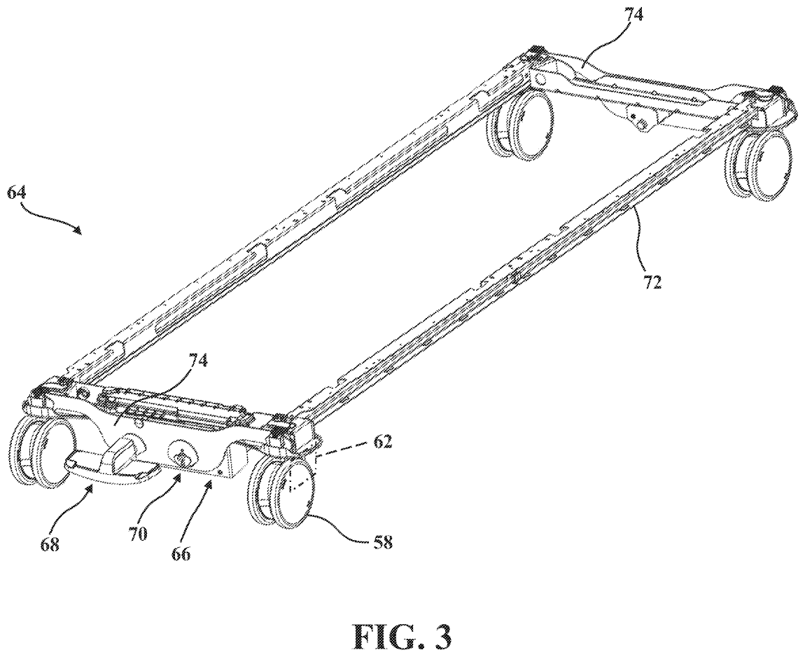

Referring to FIGS. 2-4, the patient transport apparatus 30 includes a braking system 64 to enable a user, such as a caregiver, to selectively engage or disengage the brakes 62 associated with the wheels 58. The patient transport apparatus 30 is shown in FIGS. 2-4 with the support structure 36 and the patient support deck 38 removed for illustration purposes. It should be appreciated that in the version shown, each of the wheels 58 has an associated brake 62, but in some versions, fewer than all the wheels 58 may have an associated brake 62, e.g., only one, two, or three of the four wheels 58 have an associated brake 62. In some versions, the braking system 64 may include a plurality of brakes 62 (e.g., two, three, four, etc.) arranged to brake the wheels 58.

The braking system 64 includes a linkage 66 that is operatively coupled to the brakes 62, and a brake input device 68 that is coupled to the linkage 66 in communication with the linkage 66 and arranged for user engagement to change operation of the braking system 64 between a braked state B and a released state R. In some versions, as will be described in further detail below, the braking system 64 may further include an electrical braking assembly 70 that is also coupled to the linkage 66. The linkage 66 is configured to move in response to actuation via the brake input device 68 or the electrical braking assembly 70 to operate the brakes 62 as described further below.

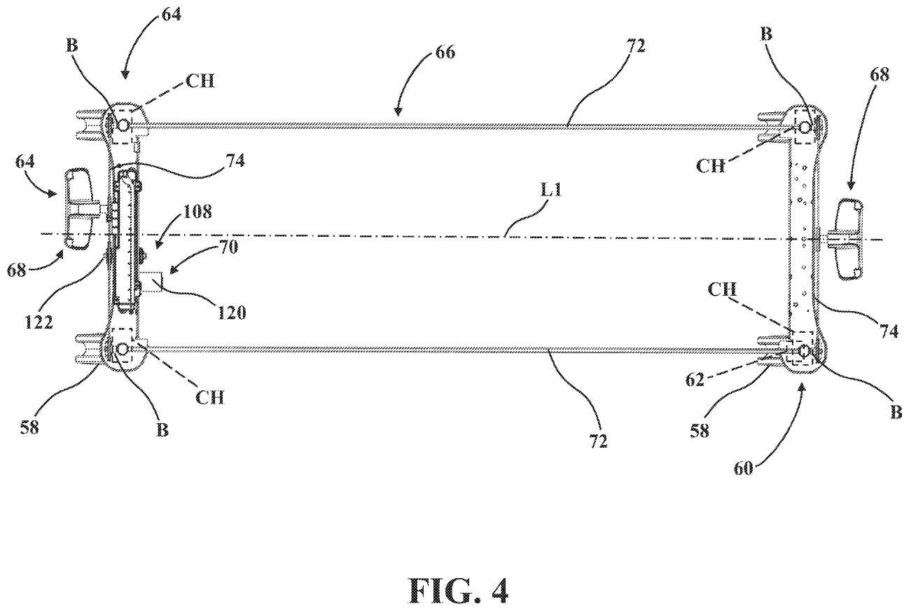

As shown in FIG. 4, the linkage 66 may include a pair of first links 72. In some versions, each of the first links 72 includes an elongated shaft having a hexagonal cross-sectional shape. The first links 72 may also be referred to as hex shafts. In some configurations, the first links 72 extend longitudinally, generally parallel to the longitudinal axis L1, from the head end to the foot end of the patient transport apparatus 30. The first links 72 are rotatably supported by the base 34 for rotation about their axes. For example, the first links 72 may be rotatably supported in a caster housing CH or other bracket of the base 34 via bushings B, bearings, or the like (caster housings CH shown in phantom in FIG. 4).

The linkage 66 may further include a pair of second links 74 arranged laterally at each of the head end and foot end. In some versions, the second links 74 include racks that are gear-driven as described further below. The second links 74 are supported by the base 34 to slide laterally relative to the base 34. Each of the second links 74 is operatively coupled to both the first links 72 such that movement of either of the second links 74 results in corresponding movement of both the first links 72 and movement of the other of the second links 74. In other words, the first links 72 and the second links 74 are operatively interconnected such that movement of any one of the links 72, 74 causes movement of the other links 72, 74. For instance, movement of one of the second links 74 via the brake input device 68 or the electrical braking assembly 70 functions to slide that second link 74 thereby rotating both the first links 72 to operate the brakes 62.

In the illustrated version, the linkage 66 is arranged and operable to place the braking system 64 in a braked state B (shown in FIG. 5A) in which each brake 62 acts to brake movement of a corresponding wheel 58 and a released state R (shown in FIG. 5B) in which each brake 62 is released from braking the wheel 58.

As shown in FIGS. 5A and 5B, in some versions, each caster assembly 60 includes a plurality of teeth 76 defined along an interior surface of the wheel 58. An eccentric member 78 is coupled to one of the first links 72 to rotate with the first link 72 about its axis A. The eccentric member 78 (also referred to as a cam) includes an actuating projection 80 that acts on a switching head 82. The switching head 82 is coupled to a switching pin 84 which is moveable in a vertical direction. A compression spring 86 is attached to the switching pin 84 to bias the switching pin 84 in an upward vertical direction toward the eccentric member 78. The brake 62 is coupled to the switching pin 84 and includes a plurality of brake teeth 88 that are arranged to engage the teeth 76 defined along the interior surface of the wheel 58. During operation, as the first link 72 is rotated about its axis A via actuation by the brake input device 68 or the electrical braking assembly 70, the eccentric member 78 is rotated to move the actuating projection 80 along a profiled surface of the switching head 82 to move the brake 62 between the braked state B (FIG. 5A) in which the brake teeth 88 engage the teeth 76 defined along the interior surface of the wheel 58, and the released state R (FIG. 5B) in which the brake teeth 88 are spaced a distance from the teeth 76 defined along the interior surface of the wheel 58.

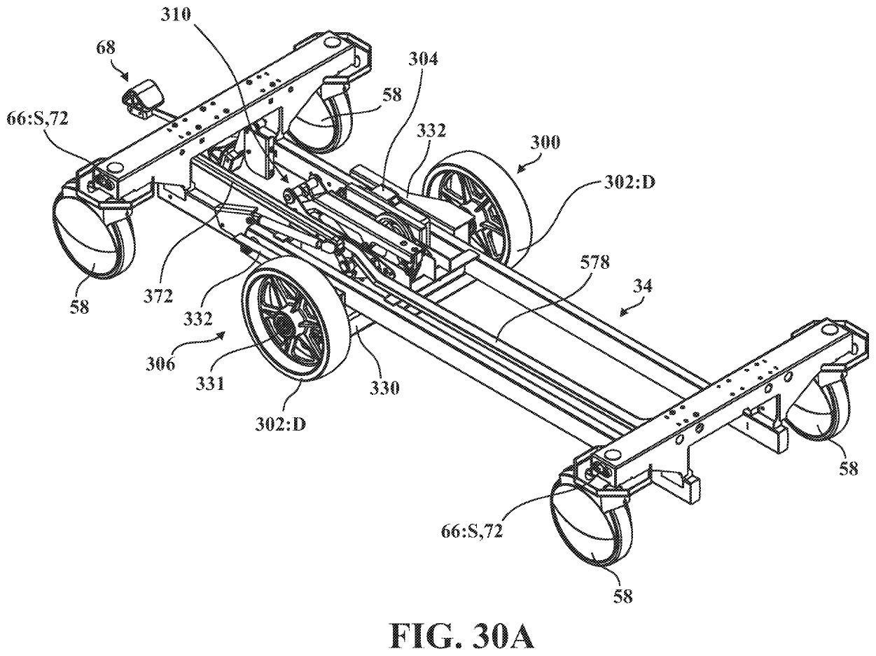

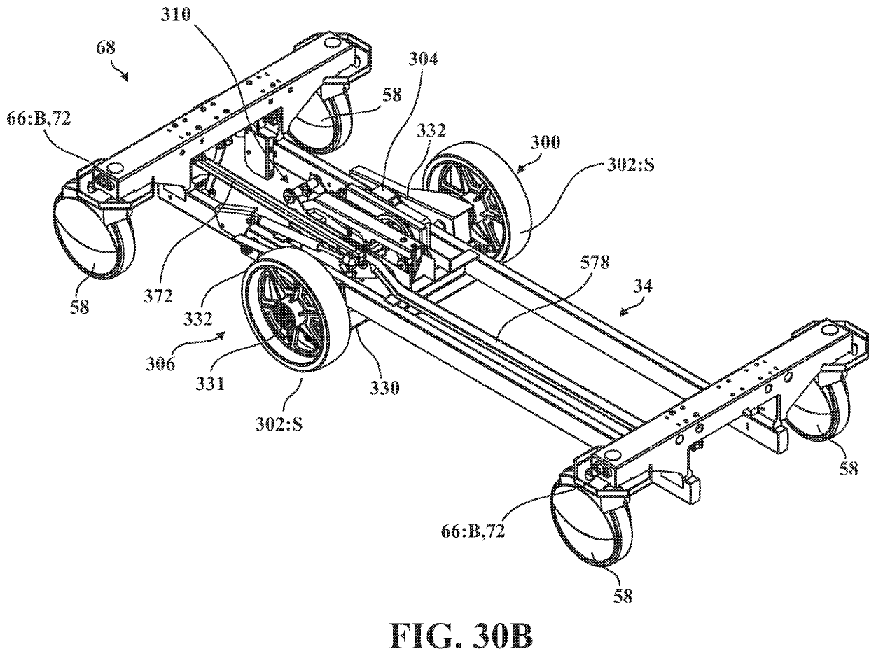

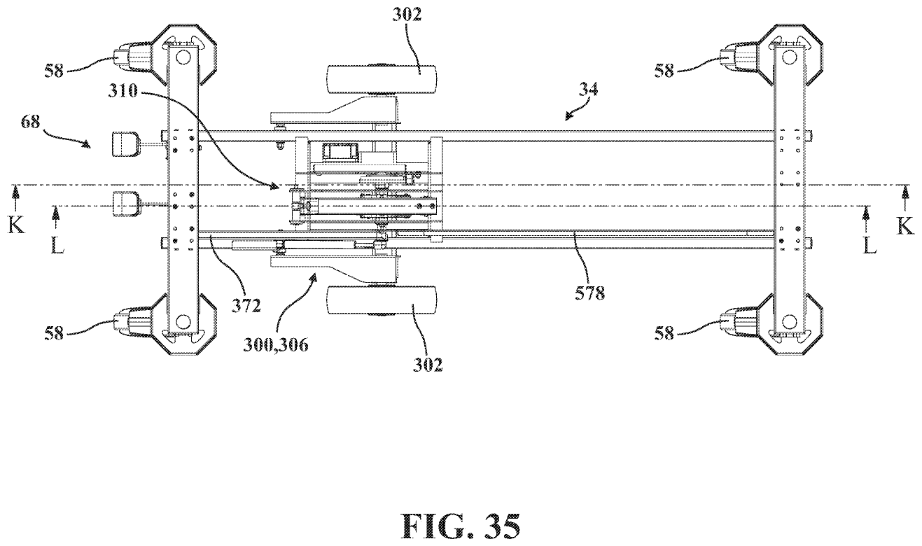

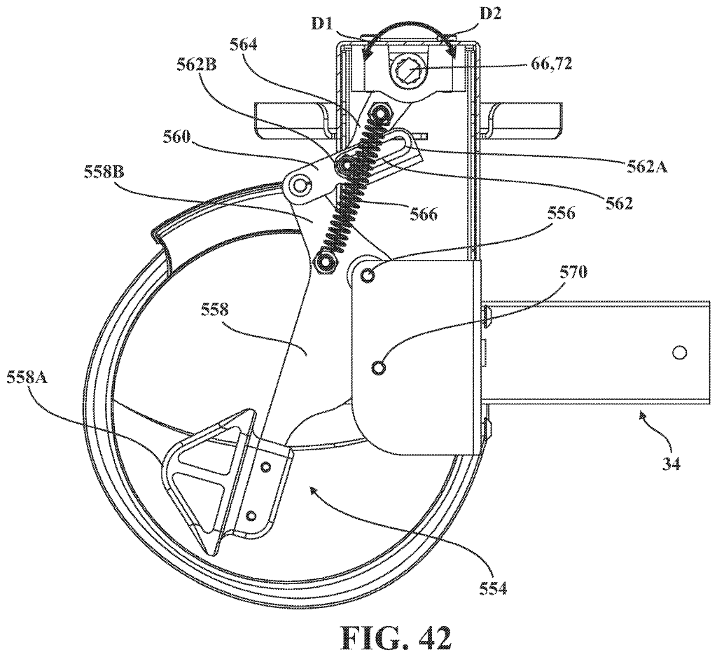

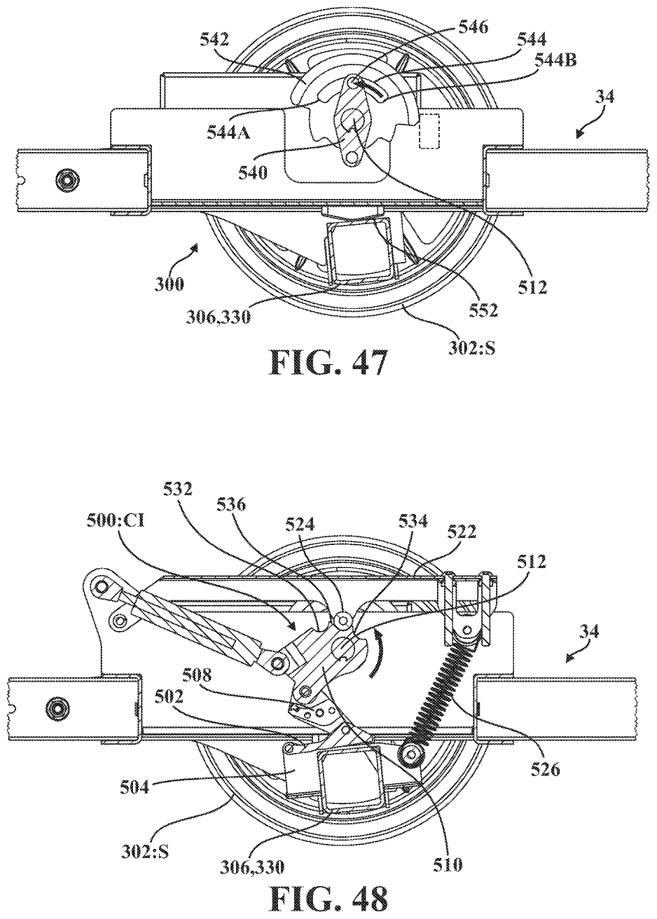

In other configurations, such as shown in FIGS. 30A-50C, the first links 72 are disposed near the head end and foot end of the patient transport apparatus 30 and extend laterally, generally transverse to the longitudinal axis L1. Here, the links 72 may be connected for concurrent rotation via an override member 372 and timing link 578 (discussed in further detail below).

In the version of the patient transport apparatus 30 that is shown, each of the pair of first links 72 extends between two caster assemblies 60 to operate the brakes 62 for two caster assemblies 60. In other words, rotation of one of the first links 72 operates two brakes for two caster assemblies 60 and rotation of the other of the first links 72 operates two brakes for two other caster assemblies 60 so that all four caster assemblies 60 are braked substantially simultaneously (substantially simultaneous owing to any slop or tolerances in the linkage 66).

Other suitable caster assemblies having brakes that operate via a hex shaft or other suitable actuation member could also be used. For example, the caster assemblies and associated brakes may be like those disclosed in U.S. Pat. No. 8,789,662, entitled, “Wheeled Carriage With Brake Lock System,” which is hereby incorporated herein by reference. Moreover, the brakes may also be external brakes or other forms of brakes that operate via a linkage but may not be part of a caster assembly.

In some configurations, when the braking system 64 is in the released state R, the linkage 66 may be further operable between a neutral state N and a steer state S. In the neutral state N, each brake 62 is released from braking the wheel 58 and at least one auxiliary wheel 302 (described in further detail below) may be spaced from a floor surface FS. In the steer state S, each brake 62 remains released from braking the wheel 58 and the at least one auxiliary wheel 302 is moved to a deployed position 302D (described in further detail below).

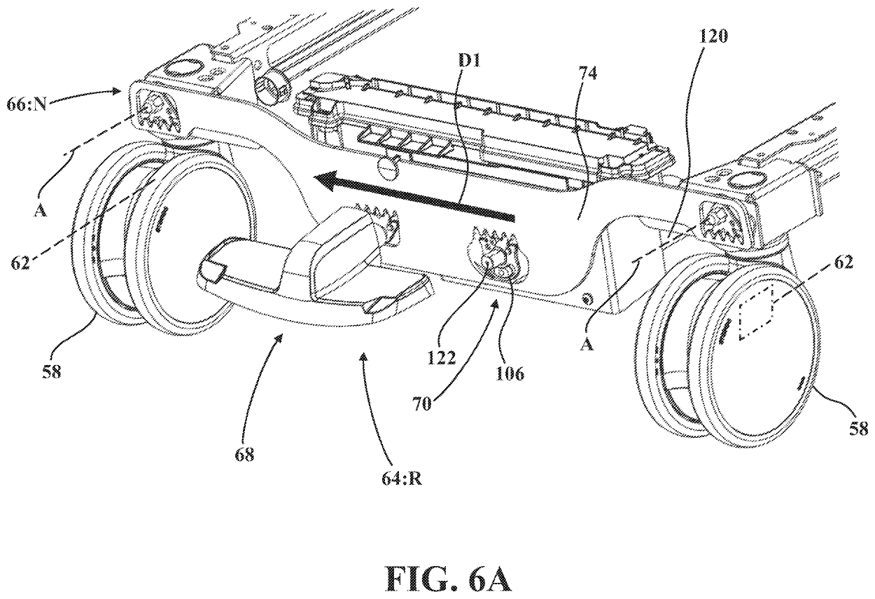

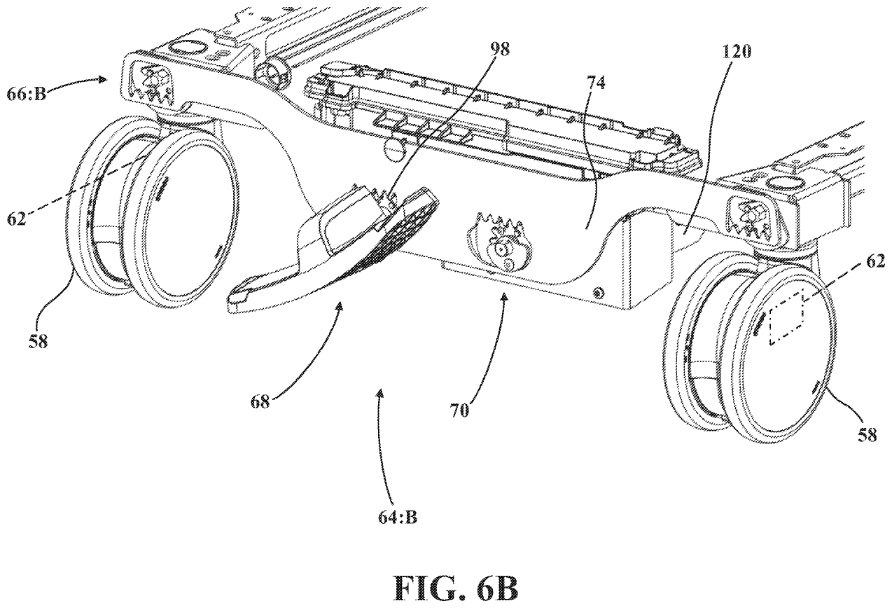

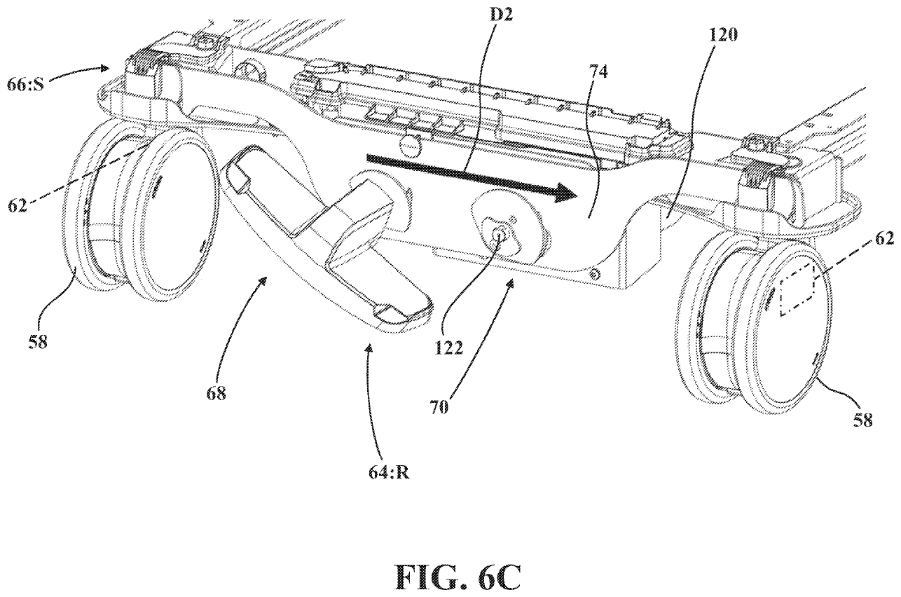

Referring to FIGS. 6A-6C, the brake input device 68 (one at each of the head end and foot end) is coupled to the linkage 66 to move the linkage 66 manually to place the braking system 64 in the braked state B, or in the released state R. In some configurations, the brake input device 68 may be further configured to move the linkage 66 between the neutral state N and the steer state S. Referring to FIG. 6A, the brake input device 68 may be operated by a caregiver to place the linkage 66 into the neutral state N and the braking system 64 in the released state R such that each brake 62 is released from braking the wheels 58. Referring to FIG. 6B, the brake input devices 68 may be operated by the caregiver to place the linkage 66 and the braking system 64 in the braked state B to such that each brake 62 brakes the wheels 58. Referring to FIG. 6C, the brake input devices 68 may be operated by the caregiver to place the linkage in the steer state S and maintain the braking system 64 in the released state R to release the brakes 62 from the wheels 58.

The brake input device 68 shown in FIGS. 6A-6C causes the second link 74 to move in a first direction D1 to place the braking system 64 in the braked state B (see transition from FIG. 6A to FIG. 6B) and causes the second link 74 to move in a second direction D2, opposite the first direction D1, to place the linkage 66 in the neutral state N and the braking system 64 in the released state R from the braked state B (see transition from FIG. 6B to FIG. 6A). Additionally, in some configurations, such as shown in FIGS. 6B-6C, the brake input device 68 causes the second link 74 to move in the second direction D2 to place the linkage 66 in the steer state S while maintaining the braking system 64 in the released state R (see transition from FIG. 6A to FIG. 6C) and causes the second link 74 to move in the first direction D1 to place the linkage 66 in the neutral state N and the braking system 64 in the released state R from the braked state B (see transition from FIG. 6C to FIG. 6A). As described in further detail below, in some configurations, the brake input device 68 is not operable to move the linkage 66 from the neutral state N to the steer state S, and only the electrical braking system 70 is configured to move the linkage 66 from the neutral state N to the steer state S. Note that various components of the braking system 64 are removed in FIGS. 6A-6C for purposes of illustrating motion of the linkage 66 between the various states.

The electrical braking assembly 70 is also coupled to the linkage 66 and includes a motor 120 and drive shaft 122 configured to move the linkage 66 to place the braking system 64 in the braked state B, the braking system 64 the released state R/the linkage 66 in the neutral state N, and/or the linkage 66 in the steer state S. The electrical braking assembly 70 includes a driving member 106 that is configured to be moved by the drive shaft 122 to cause the second link 74 to move in the first direction D1 and to cause the second link 74 to move in the second direction D2. The motor 120 and drive shaft 122 form part of a brake actuator assembly 108. The brake actuator assembly 108 is coupled to the driving member 106 to provide torque to move the second link 74 in the first direction D1 and to move the second link 74 in the second direction D2. One example of additional structural details and operation of braking systems 64 are described in U.S. Patent Application Publication No. 2019/0192364, entitled “Patient Transport Apparatus With Electro-Mechanical Braking System,” and U.S. patent application Ser. No. 17/825,536, entitled “Patient Transport Apparatus With Electro-Mechanical Braking Input Hold Circuit,” which are hereby incorporated herein by reference.

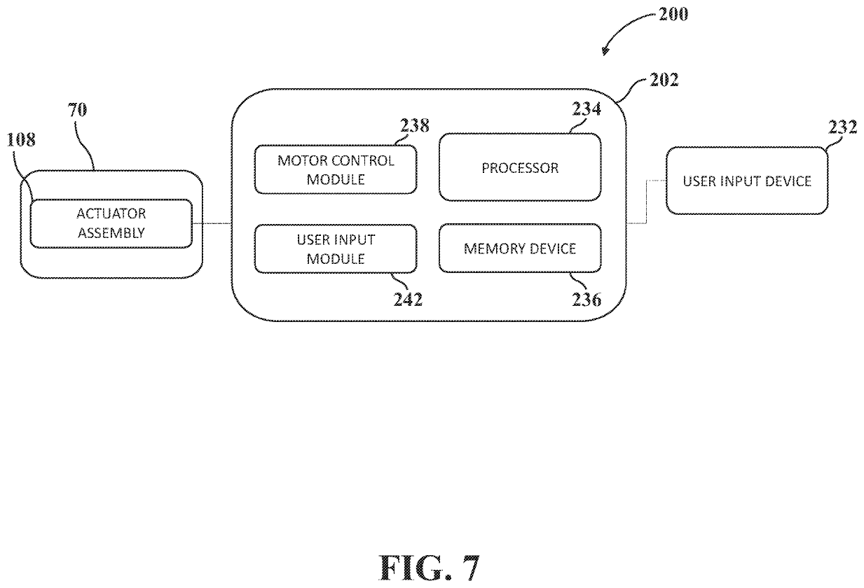

Referring to FIG. 7, the illustrated patient transport apparatus 30 includes a control system 200 to control, among other things, the electrical braking assembly 70. The control system 200 includes the controller 202 having one or more microprocessors, microcontrollers, field programmable gate arrays, systems on a chip, discrete circuitry, and/or other suitable hardware, software, or firmware that is capable of carrying out the functions described herein. The controller 202 may be carried on-board the patient transport apparatus 30 or may be remotely located. In some versions, the controller 202 is mounted to the base 34. In other versions, the controller 202 is mounted to the footboard 54. Power to the electrical braking assembly 70 and/or the controller 202 may be provided by a battery power supply and/or an external power source. The controller 202 is coupled to the electrical braking assembly 70 in a manner that allows the controller 202 to control the brake actuator assembly 108 (connections shown schematically in FIG. 7). The controller 202 may communicate with the brake actuator assembly 108 via wired or wireless connections to perform one of more desired functions.

The control system 200 may include a user interface with one or more user input devices 232 that are operated by the caregiver, and which transmit a corresponding input signal to the controller 202. The controller 202 controls operation of the brake actuator assembly 108 based on the input signal. The user input devices 232 may include any device capable of being actuated by the caregiver. The user input devices 232 may be configured to be actuated in a variety of different ways, including but not limited to, mechanical actuation (hand, foot, finger, etc.), hands-free actuation (voice, foot, etc.), and the like.

The user input devices 232 may also include a gesture sensing device for monitoring motion of hands, feet, or other body parts of the caregiver (such as through a camera), a microphone for receiving voice activation commands, a foot pedal, and a sensor (e.g., infrared sensor such as a light bar or light beam to sense a caregiver's body part, ultrasonic sensor, etc.). Additionally, the user input devices 232 may include buttons/pedals can be physical buttons/pedals or virtually implemented buttons/pedals such as through optical projection or on a touchscreen. The buttons/pedals may also be mechanically connected or drive-by-wire type buttons/pedals where a caregiver applied force actuates a sensor, such as a switch or potentiometer. It should be appreciated that any combination of user input devices 232 may also be utilized. The user input devices 232 may be located on one of the side rails 44, 46, 48, 50, the headboard 52, the footboard 54, or other suitable locations. The user input devices 232 may also be located on a portable electronic device (e.g., iWatch®, iPhone®, iPad®, or similar electronic devices).

In the illustrated version, the controller 202 includes a processor 234 and a memory device 236. Processor 234 includes any suitable programmable circuit which may include one or more systems and microcontrollers, microprocessors, reduced instruction set circuits (RISC), application specific integrated circuits (ASIC), programmable logic circuits (PLC), field programmable gate arrays (FPGA), and any other circuit capable of executing the functions described herein. The above examples are exemplary only, and thus are not intended to limit in any way the definition and/or meaning of the term “processor.” Memory device 236 includes a computer readable medium, such as, without limitation, random access memory (RAM), flash memory, a hard disk drive, a solid state drive, a diskette, a flash drive, a compact disc, a digital video disc, and/or any suitable device that enables processor 234 to store, retrieve, and/or execute instructions and/or data.

In the exemplary version, the controller 202 includes a motor control module 238 that is coupled to the brake actuator assembly 108 to control an operation of brake actuator assembly 108. The motor control module 238 is configured to execute programming code in response to inputs received by the caregiver via the user interface to operate the brake actuator assembly 108 based on the user input.

The controller 202 also includes a user input module 242 that is configured to receive input signals from the user input devices 232 and/or to generate and display images for display on one or more display devices of the user interface. For example, the user input module 242 may retrieve image data being stored in the memory device 236 and transmit the image data to the user interface to enable one or more display devices to display the images to the caregiver. The user input module 242 also transmits signals to the state indicator 230 to operate the state indicator 230 to indicate the sensed state.

During operation of the electrical braking assembly 70, when a caregiver wishes to engage or release the braking system 64 electronically, the caregiver actuates one or more of the user input devices 232 (as opposed to manually via the brake input device 68). For instance, in the event the caregiver wishes to brake the wheels 58 to stop movement of the patient transport apparatus 30, the caregiver actuates the appropriate user input device 232. Upon actuation, the controller 202 sends output signals to the brake actuator assembly 108 to cause operation of the brake actuator assembly 108 to move accordingly. Similarly, one or more of the user input devices 232 can be used to release the braking assembly 64, or to place the linkage 66 in the steer state S.

Additional details and operation of the control system 200 are described in U.S. patent application Ser. No. 17/825,536, entitled “Patient Transport Apparatus With Electro-Mechanical Braking Input Hold Circuit,” which is hereby incorporated herein by reference.

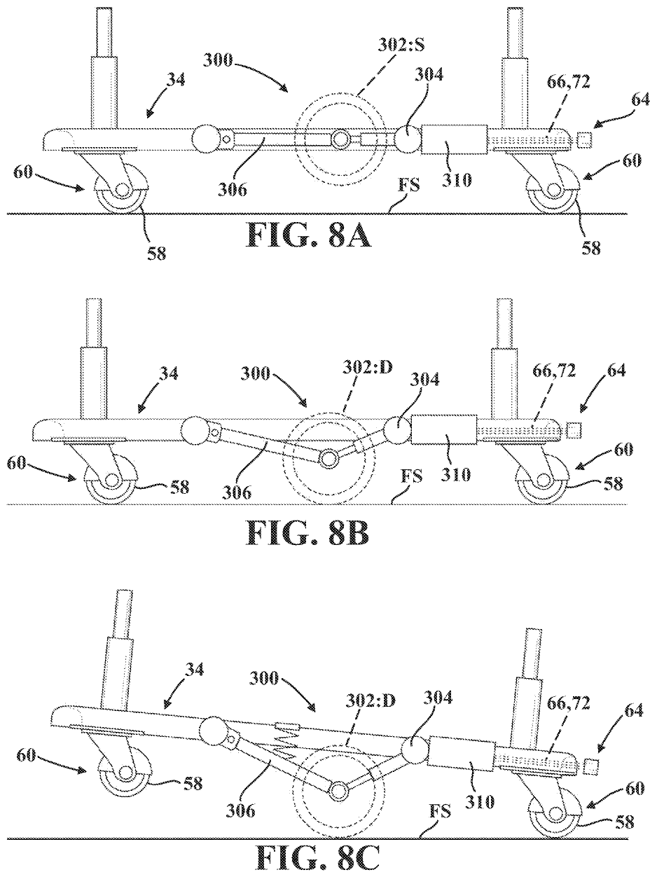

As shown in FIGS. 1 and 2, the patient transport apparatus 30 further includes an auxiliary wheel assembly 300 coupled to the support structure 36. Referring to FIGS. 8A through 8C, the auxiliary wheel assembly 300 includes at least one auxiliary wheel 302 and an actuator 304 configured to move the at least one auxiliary wheel 302 between a plurality of auxiliary support positions including a stowed position 302S and a deployed position 302D. FIG. 8A schematically illustrates the patient transport apparatus 30 including the auxiliary wheel assembly 300 where the at least one auxiliary wheel 302 is in the stowed position 302S such that the one or more auxiliary wheels 302 is spaced from the floor surface FS. FIG. 8B schematically illustrates the patient transport apparatus 30 including the auxiliary wheel assembly 300 where the at least one auxiliary wheel 302 is in the deployed position 302D such that the one or more auxiliary wheels 302 engages the floor surface FS to at least partially support movement of the patient transport apparatus 30 over the floor surface FS. In some configurations, the at least one auxiliary wheel 302 may be placed in the position shown in FIG. 8B in response to the linkage 66 being moved to the neutral state N. FIG. 8C schematically illustrates the patient transport apparatus 30 including the auxiliary wheel assembly 300 where, where the at least one auxiliary wheel 302 is located between caster assemblies 60 and contacts the floor surface FS in the deployed position 300D such that the at least one auxiliary wheel 302 causes two of the caster assemblies 60 to be lifted off the floor surface thereby shortening a wheelbase of the patient transport apparatus 30. Additionally, in some configurations, the at least one auxiliary wheel 302 does not swivel. Accordingly, when the at least one auxiliary wheel 302 is deployed as shown in FIG. 8C, the at least one auxiliary wheel 302 guides motion of the patient transport apparatus by limiting lateral movement along the floor surface FS. In some configurations, the at least one auxiliary wheel 302 may be placed in the position shown in FIG. 8C in response to the linkage 66 being moved to the steer state S.

With continued reference to FIGS. 8A through 8C, in some versions, the auxiliary wheel assembly 300 further comprises an axle assembly 306. The axle assembly 306 (illustrated schematically in FIGS. 8A through 8C) is configured to support the one or more auxiliary wheels 302 for rotational movement. The axle assembly 306 may be coupled to the base 34 for pivoting movement relative to the base 34 to move the one or more auxiliary wheels 302 between the plurality of auxiliary support positions including the deployed position 302D and the stowed position 302S, such as by one or more linkages, actuators, and the link. It will be appreciated that various configurations of the axle assembly 306 are contemplated. Exemplary arrangements of the axle assembly 306 are described below.

In some configurations, the auxiliary wheel assembly 300 further comprises an auxiliary wheel drive system (not shown) including a motor operatively attached to the one or more auxiliary wheels 302 and configured to generate torque to rotate the one or more auxiliary wheels 302 to influence motion of the patient transport apparatus 30 over the floor surface FS. Additionally, it is contemplated that the one or more auxiliary wheels 302 may take other forms than a conventional wheel such as, but not limited to, tracks. In some versions, the auxiliary wheel assembly 300 may be similar to as is disclosed in U.S. Patent Application Publication No. US 2019/0201255 entitled “Patient Transport Apparatus With Controlled Auxiliary Wheel Deployment,” and/or in U.S. Patent Application Publication No. US 2019/0201256 entitled “Patient Transport Apparatus With Controlled Auxiliary Wheel Speed,” the disclosures of each of which are hereby incorporated by reference in their entirety.

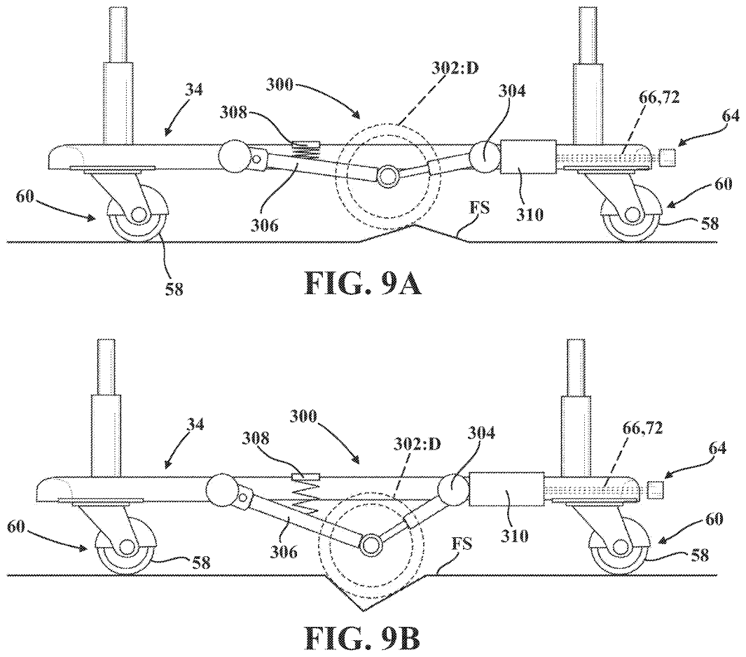

Referring to FIGS. 9A and 9B, in some versions the patient transport apparatus 30 may further include a spring cartridge 308 arranged between the support structure 36 and the one or more auxiliary wheels 302 to bias the one or more auxiliary wheels 302 toward the deployed position 302D and allow the one or more auxiliary wheels 302 to deflect in response to engagement with uneven floor surfaces FS. Accordingly, in some configurations, the deployed position 302D may be characterized as a plurality of deployed positions 302D where the one or more auxiliary wheels 302 is configured to deflect to maintain contact with uneven floor surfaces FS. Any suitable arrangement of the spring cartridge 308 between the support structure 36 and the one or more auxiliary wheels 302 is contemplated. Exemplary arrangements of the spring cartridge 308 are described below.

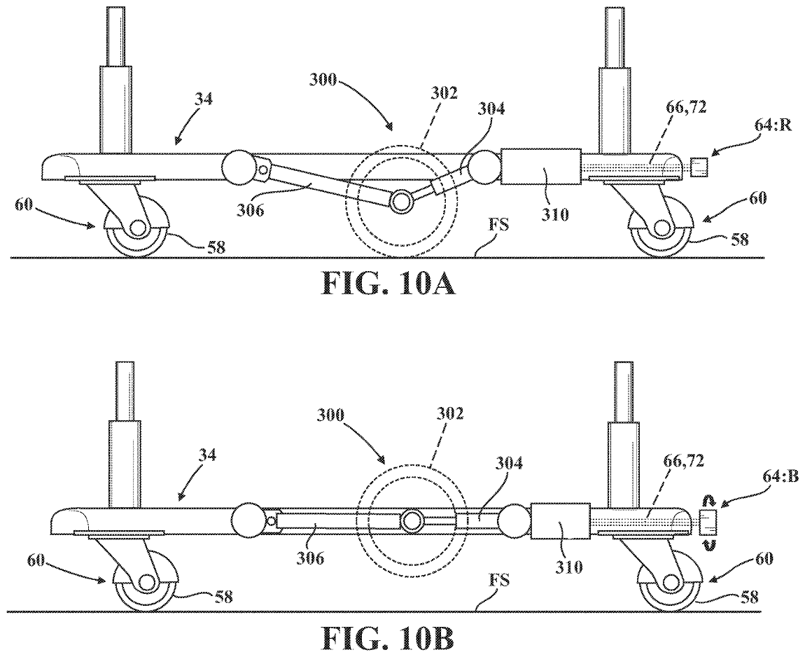

The patient transport apparatus 30 includes an override assembly 310 (schematically illustrated in FIGS. 10A and 10B) coupled to the linkage 66 of the braking system 64 and to the auxiliary wheel assembly 300. In one example, the override assembly 310 may be coupled to the link 72 of the braking assembly 64. Accordingly, the override assembly 310 is configured to move in response to movement of the linkage 66. The override assembly 310 is configured to move the one or more auxiliary wheels 302 away from the deployed position 302D (schematically illustrated in FIG. 10A) and toward the stowed position 302S in response to movement of the braking system 64 from the released state R toward the braked state B (schematically illustrated in FIG. 10B).

As will be appreciated from the subsequent description below, the override assembly 310 is configured to move in response to movement of the linkage 66 of the brake system 64 to inhibit movement of the base 34 along the floor surface FS in the braked state B and at least partially disengage the one or more auxiliary wheels 302 from the floor surface FS. In other words, as the brake system 64 moves toward the braked state B, the override assembly 310 is configured to lift the one or more auxiliary wheels 302 to at least partially disengage the one or more auxiliary wheels 302 from the floor surface FS. Accordingly, the weight of the patient transport apparatus 30 will be transferred off of the auxiliary wheels 302 and to the wheels 58 such that the brakes 62 of the wheels 58 inhibit movement of the base 34 along the floor surface FS, and such that any lifting of the wheels 58 via the auxiliary wheels 302 (particularly when the linkage 66 is in the steer state S) is inhibited. With this configuration, it will be appreciated that a powered actuator 304 is not required to facilitate moving the one or more auxiliary wheels 302 away from the deployed position 302D and out of engagement with the floor surface FS, in that manual actuation of the brake input device 68 can simultaneously disengage the one or more auxiliary wheels 302 from the floor surface FS and place the wheels 58 in the braked state B without battery power.

It will be appreciated that the override assembly 310 may move the one or more auxiliary wheels 302 without any actuation of the actuator 304. For example, comparing FIGS. 8A and 8B to FIGS. 10A and 10B, in FIGS. 8A and 8B, the actuator 304 decreases in length to move the one or more auxiliary wheels 302 from the deployed position 302D to the stowed position 302S. Meanwhile, in the illustrations of FIGS. 10A and 10B, the actuator 304 remains the same length while the override assembly 310 moves the one or more auxiliary wheels 302 from the deployed position 302D toward the stowed position 302S. Furthermore, it will be appreciated that the override assembly 310 may be configured to move the one or more auxiliary wheels 302 away from the deployed position 302D and toward the stowed position 302S in response to movement of the braking system 64 from the released state R to the braked state B in a number of different ways, examples of which are described below.

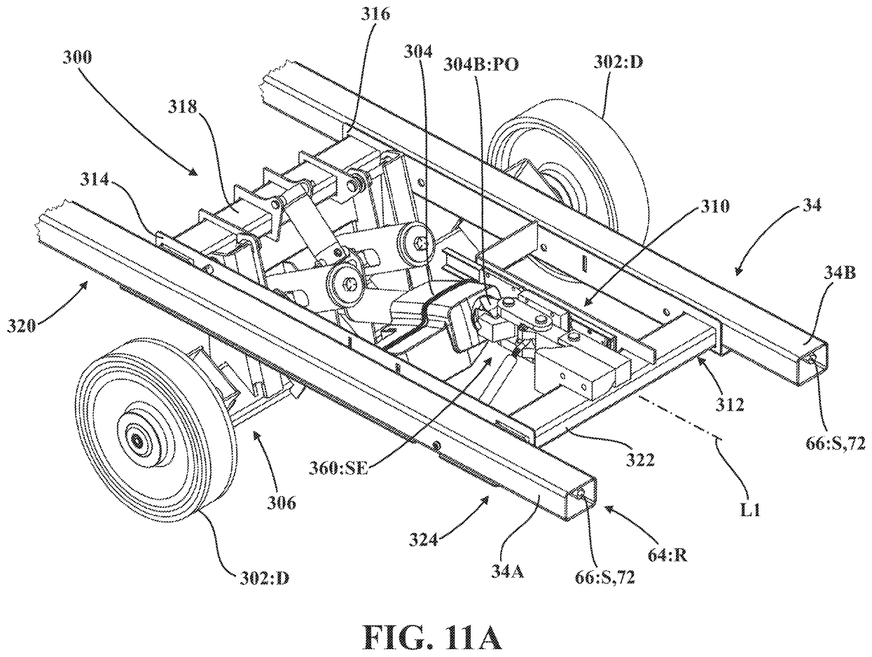

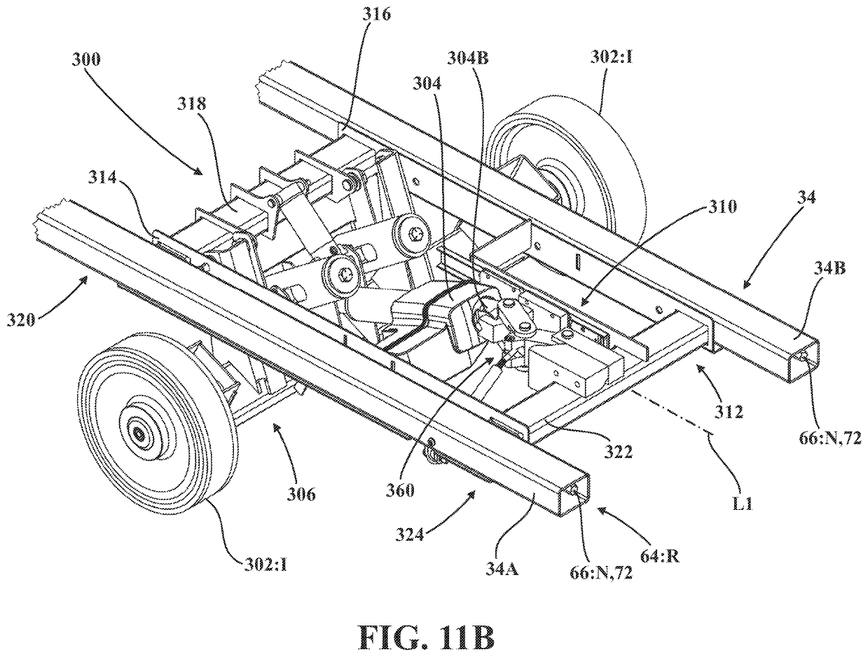

FIGS. 11A-17C illustrate a portion of the patient transport apparatus 30 including a versions of the auxiliary wheel assembly 300 and the override assembly 310. Referring first to FIG. 11A, in some versions, the auxiliary wheel assembly 300 includes an auxiliary frame 312 coupled to the base 34, with the one or more auxiliary wheels 302 and the actuator 304 operatively attached to the auxiliary frame 312. The auxiliary frame 312 may include a first auxiliary rail 314 extending longitudinally along the patient transport apparatus 30 (e.g., along the longitudinal axis L1) and coupled to a first base rail 34A of the base 34, and a second auxiliary rail 316 extending longitudinally along the patient transport apparatus 30 and coupled to a second base rail 34B of the base 34. The auxiliary frame 312 may further include a first crossmember 318 extending between the first auxiliary rail 314 and the second auxiliary rail 316 at a first end 320 of the auxiliary wheel assembly 300, and a second crossmember 322 extending between the first auxiliary rail 314 and the second auxiliary rail 316 at a second end 324 of the auxiliary wheel assembly 300. Other configurations for supporting the one or more auxiliary wheels 302 and the actuator 304 are contemplated including, but not limited to, crossmembers extending directly between the first base rail 34A and the second base rail 34B.

As best shown in FIG. 11C, the actuator 304 is coupled to the axle assembly 306 at a first actuator end 304A and is operatively attached (e.g., via the override assembly 310) to the second crossmember 322 (or another portion of the auxiliary frame 213) at a second actuator end 304B. Accordingly, the actuator 304 is configured to move the axle assembly 306 and, thus, to move the one or more auxiliary wheels 302, between the deployed position 302D and the stowed position 302S. In the configurations illustrated in FIGS. 11A-17C, the axle assembly 306 is operatively attached to the first crossmember 318 for pivoting movement relative to the first crossmember 318 to move the one or more auxiliary wheels 302 between the plurality of auxiliary support positions including the deployed position 302D and the stowed position 302S.

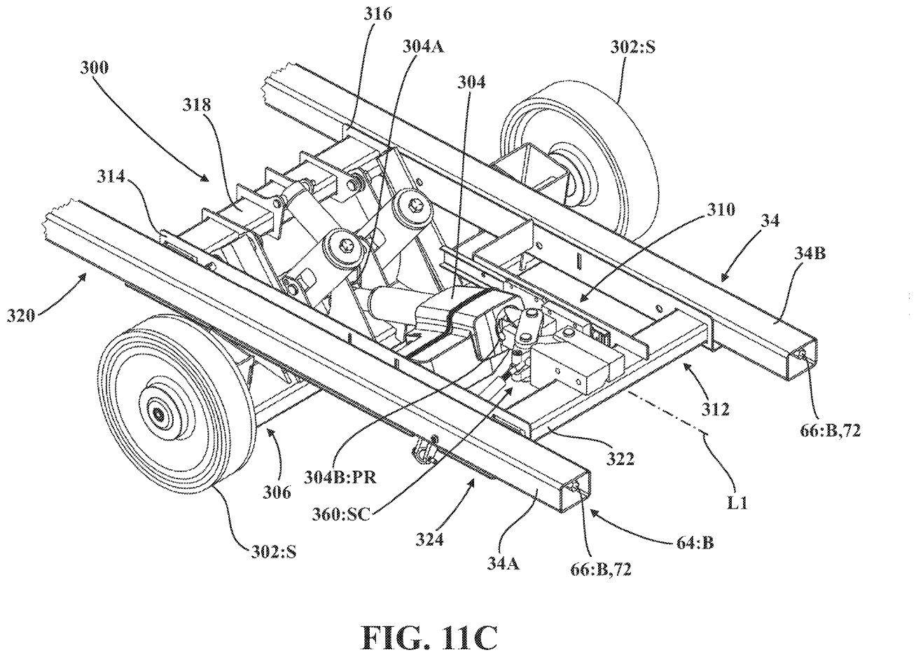

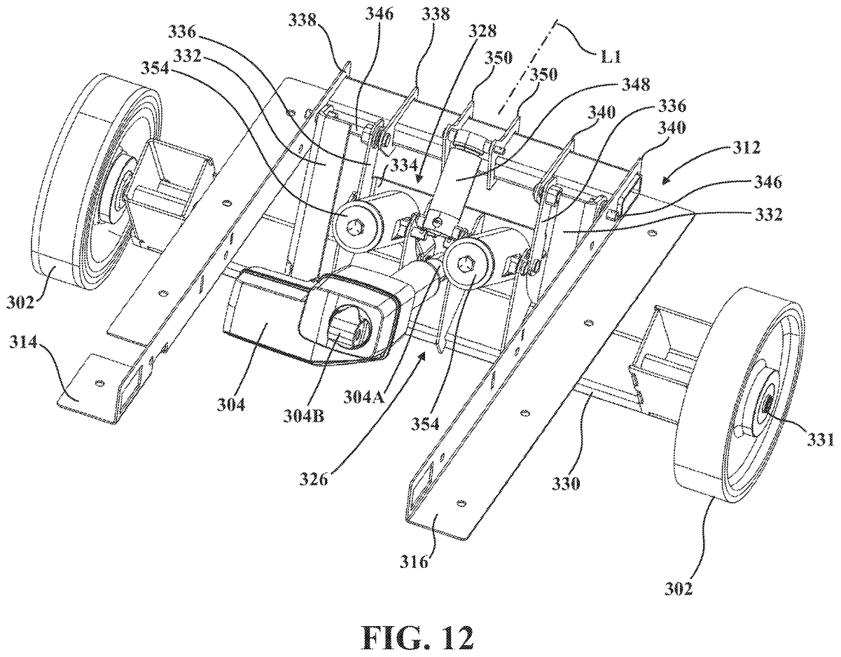

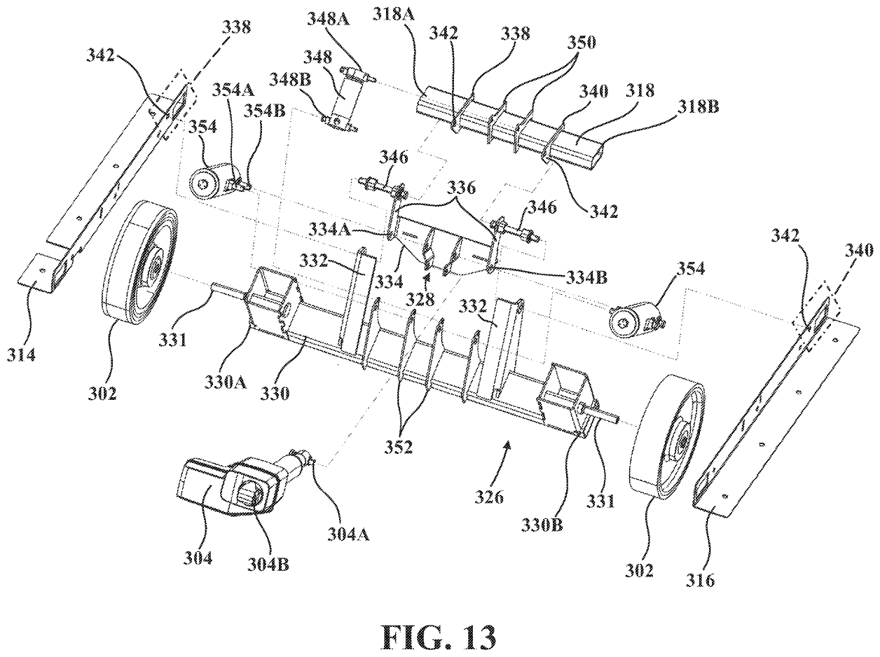

Referring to FIGS. 12 and 13, the axle assembly 306 may further include a first axle subassembly 326 and a second axle subassembly 328. In some versions, the first axle subassembly 326 may be operatively attached to the first crossmember 318 for pivoting movement relative to the first crossmember 318. For example, the first axle subassembly 326 may include a first axle member 330 extending between a first end 330A and a second end 330B. The first axle member 330 may also include at least one axle shaft 331 for rotatably supporting the at least one auxiliary wheel 302. The first axle subassembly 326 may further include a first pair of swing arms 332 coupled to and extending between the first axle member 330 and the first crossmember 318 to facilitate pivoting movement of the first axle member 330 relative to the first crossmember 318. It should be appreciated that the structure of the first axle subassembly 326 illustrated in FIGS. 12 and 13 is intended to be a non-limiting example, and any structure configured to support the one or more auxiliary wheels 302 and move relative to the auxiliary frame 312 to move the one or more auxiliary wheels 302 between the plurality of auxiliary support positions including the deployed position 302D and the stowed position 302S is contemplated.

The second axle subassembly 328 may be operatively attached to the first crossmember 318 for pivoting movement relative to the first crossmember 318 of the auxiliary frame 213. It will be appreciated that the second axle subassembly 328 may be configured to pivot relative to the first crossmember 318 of the auxiliary frame 312 independent from the first axle subassembly 326. However, as discussed below, the second axle subassembly 328 may be operatively attached (e.g., via a spring cartridge, as described below) to the first axle subassembly 326 to coordinate movement of the second axle subassembly 328 with the first axle subassembly 326. Accordingly, movement of the second axle subassembly 328 may effectuate movement of the first axle subassembly 326. In other words, moving one of the first axle subassembly 326 and the second axle subassembly 328 may cause the entire axle assembly 306 to pivot relative to the auxiliary frame 312.

The second axle subassembly 328 may include a second axle member 334 extending between a first end 334A and a second end 334B. In the illustrated version, the second axle member 334 is sized to fit between the first pair of swing arms 332 of the first axle subassembly 326. The second axle subassembly 328 may further include a second pair of swing arms 336 coupled to and extending between the second axle member 334 and the first crossmember 318 to facilitate pivoting movement of the second axle member 334 relative to the first crossmember 318. In the illustrated version, the first actuator end 304A is coupled to the second axle subassembly 328 (more specifically, to the second axle member 334) for moving the axle assembly 306 relative to the auxiliary frame 312 to move the one or more auxiliary wheels 302 between the deployed position 302D and the stowed position 302S. It should be appreciated that the structure of the first axle subassembly 326 illustrated in FIGS. 12 and 13 is intended to be a non-limiting example, and other configurations are contemplated.

FIGS. 12 and 13 depict an exemplary arrangement of the axle assembly 306 coupled to the auxiliary frame 312. In this version, the first crossmember 318 of the auxiliary frame 312 may further include a first pair of brackets 338 extending longitudinally (e.g., along the longitudinal axis L1) from a first end 318A of the first crossmember 318 and a second pair of brackets 340 extending longitudinally from a second end 318B of the first crossmember 318. It should be appreciated that one of the first pair of brackets 338 may be integral with the first auxiliary rail 314, as shown in FIG. 13. Likewise, it should be appreciated that one of the second pair of brackets 340 may be integral with the second auxiliary rail 316, as shown in FIG. 13. The first pair of brackets 338 and the second pair of brackets 340 may each define coaxial bores 342 defining a pivot axis 344. In some versions, the first axle subassembly 326 is coupled to the first and second pair of brackets 338, 340 via one or more pivot shafts 346 disposed in the coaxial bores 342 for pivoting movement of the first axle subassembly 326 about the pivot axis 344. Similarly, the second axle subassembly 328 is coupled to the first and second pair of brackets 338, 340 via one or more pivot shafts 346 disposed in the coaxial bores 342 for pivoting movement of the second axle subassembly 328 about the pivot axis 344.

With continued reference to FIGS. 12 and 13, a suspension system with a first spring cartridge 348 is shown arranged between the first axle subassembly 326 (more specifically, to the first axle member 330) and the first crossmember 318. The first spring cartridge 348 is configured to bias the axle assembly 306 toward the deployed position 302D and allow the axle assembly 306 to deflect toward the stowed position 302S in response to engagement of the one or more auxiliary wheels 302 with uneven floor surfaces. In this example, the first spring cartridge 348 extends between a first end 348A and a second end 348B. The first end 348A of the first spring cartridge 348 may be coupled to a third pair of brackets 350 extending longitudinally (e.g., along longitudinal axis L1) from the first crossmember 318. The second end 348B may be coupled to the first axle subassembly 326 (more specifically, to the first axle member 330) via a pair of first axle brackets 352 extending from the first axle member 330. Accordingly, the first spring cartridge 348 is configured to urge the first axle subassembly 326 away from the first crossmember 318 such that the one or more auxiliary wheels 302 is biased toward the deployed position 302D, yet still able to deflect if the one or more auxiliary wheels 302 encounters an uneven floor surface FS. One non-limiting example of a suitable first spring cartridge 348 includes a coilover shock absorber. Other spring cartridge configurations are contemplated.

The suspension system of the auxiliary wheel assembly 300 may further include at least one second spring cartridge 354 arranged between the second axle subassembly 328 and the first axle subassembly 326. The second spring cartridge 354 is configured to allow the second axle subassembly 328 to deflect relative to the first axle subassembly 326 in response to engagement of the one or more auxiliary wheels 302 with uneven floor surfaces FS. In this example, the at least one second spring cartridge 354 extends between a first end 354A and a second end 354B. The first end 354A may be coupled to the first axle member 330 of the first axle subassembly 326 (e.g., coupled to the first pair of axle brackets 352). The second end 354B may be coupled to the second axle subassembly 328 (e.g., couple to a second pair of axle brackets 355 extending from the second axle member 334). Accordingly, the second spring cartridge 354 is configured to allow the second axle subassembly 328 to deflect relative to the first axle subassembly 326 in response to engagement of the one or more auxiliary wheels 302 with uneven floor surfaces FS. One non-limiting example of a suitable second spring cartridge 354 includes a coilover shock absorber. Other spring cartridge configurations are contemplated.

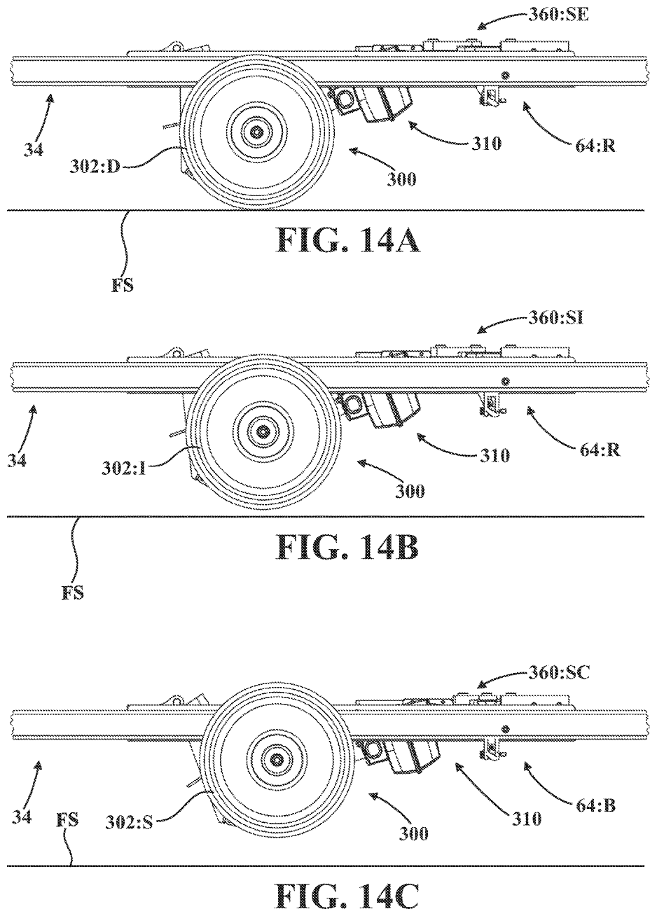

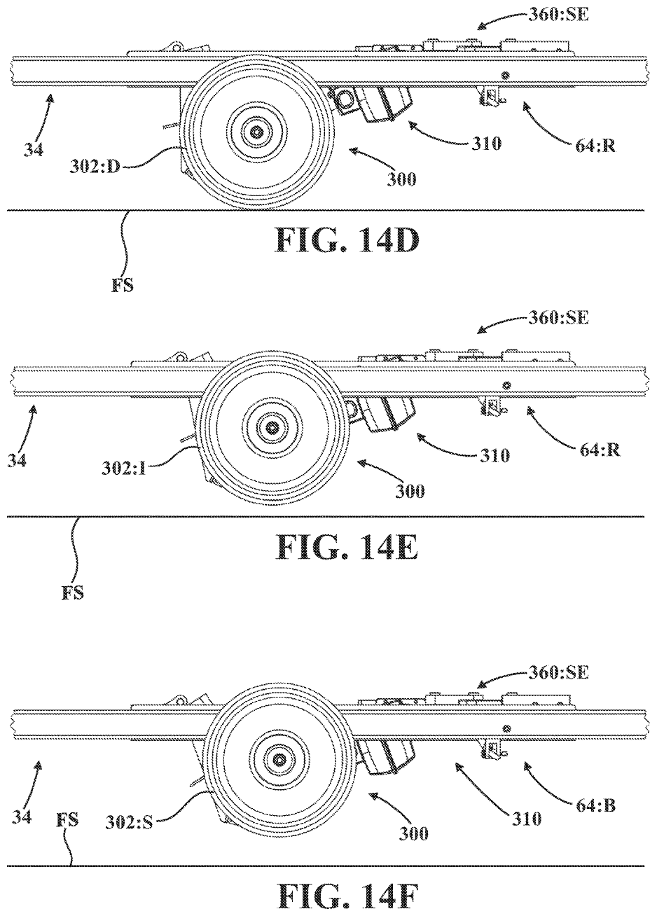

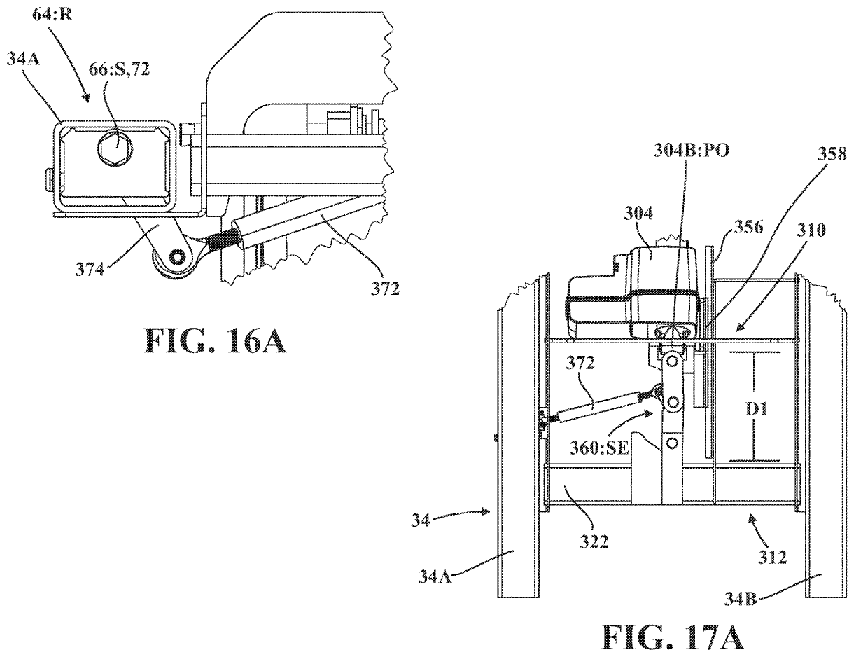

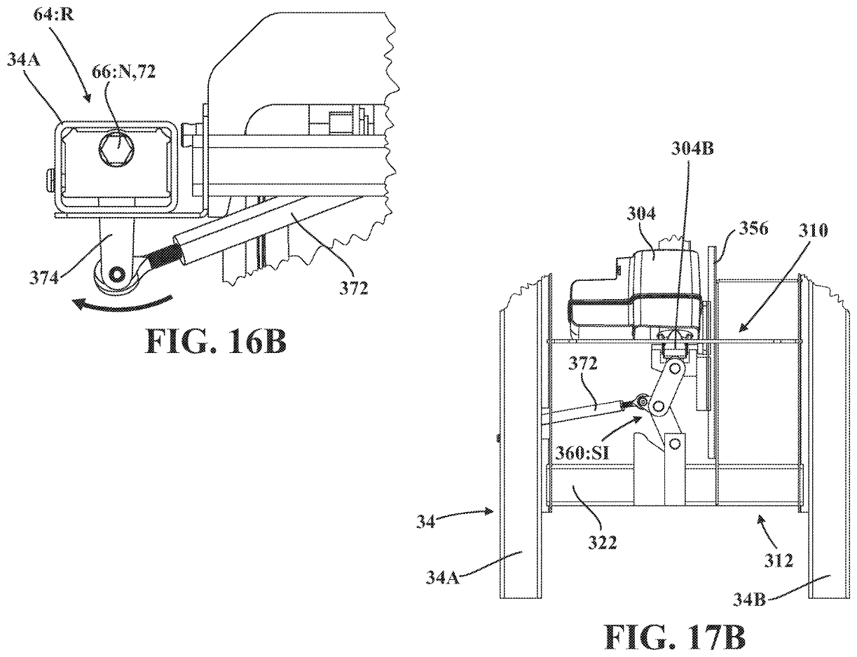

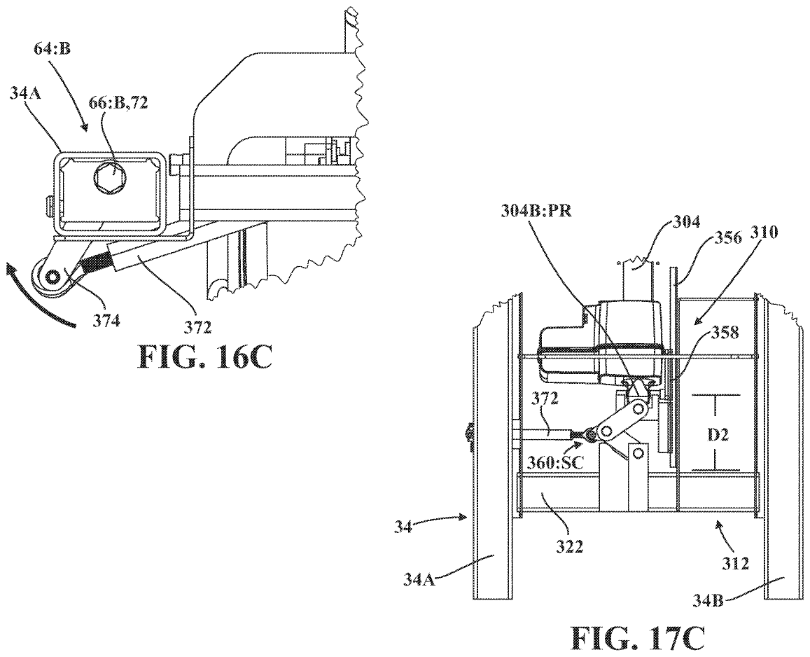

FIGS. 14A through 14C (and also FIGS. 14D through 14D illustrate a sequence of the one or more auxiliary wheels 302 of the auxiliary wheel assembly 300 moving from the deployed position 302D toward the stowed position 302S to at least partially disengage the one or more auxiliary wheels 302 from the floor surface FS. More specifically, FIGS. 14A through 14C represent disengagement which occurs via operation of the override assembly 310, and FIGS. 14D through 14F represent disengagement which occurs via operation of the actuator 304. FIG. 14A shows the one or more auxiliary wheels 302 of the auxiliary wheel assembly 300 in the deployed position 302D. FIGS. 16A and 17A, described in further detail below, show the arrangement of the linkage 66 and override assembly 310 corresponding to FIG. 14A, where the braking system 64 is in the released state R such that the brakes 62 are released from the wheels 58 and the linkage 66 is in the steer state S such that the linkage assembly 360 is in the extended state SE. FIG. 14B shows the one or more auxiliary wheels 302 of the auxiliary wheel assembly 300 in an intermediate position 302I. FIGS. 16B and 17B, described in further detail below, show the arrangement of the linkage 66 and override assembly 310 corresponding to FIG. 14B, where the braking system 64 is in the released state R such that the brakes 62 are released from the wheels 58 and the linkage 66 is in the neutral state N such that the linkage assembly 360 is in an intermediate state SI. FIG. 14C shows the one or more auxiliary wheels 302 of the auxiliary wheel assembly 300 in the stowed position 302S. FIGS. 16C and 17C, described in further detail below, show the arrangement of the linkage 66 and override assembly 310 corresponding to FIG. 14C, where the braking system 64 is in the braked state B such that the brakes 62 brake the wheels 58 and the linkage 66 is in the brake state B such that the linkage assembly 360 is in the collapsed state SC. It should be appreciated that no movement of the actuator 304 occurs in the sequence of FIGS. 14A through 14B; the one or more auxiliary wheels 302 are moved from the deployed position 302D to the stowed position 302S due to the movement of the linkage assembly 360 from the extended state SE to the collapsed state SC as a result of the linkage 66 moving from the steer state S to the brake state B.

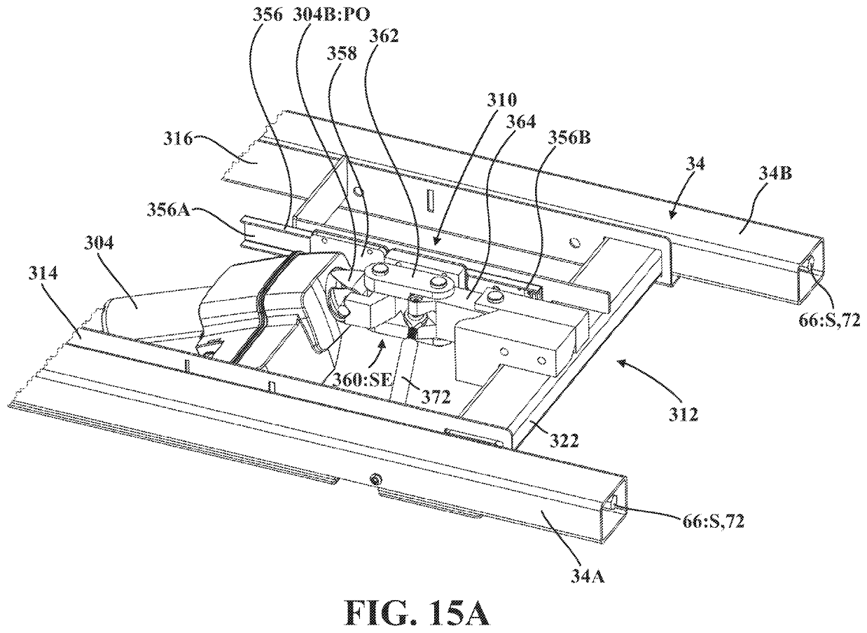

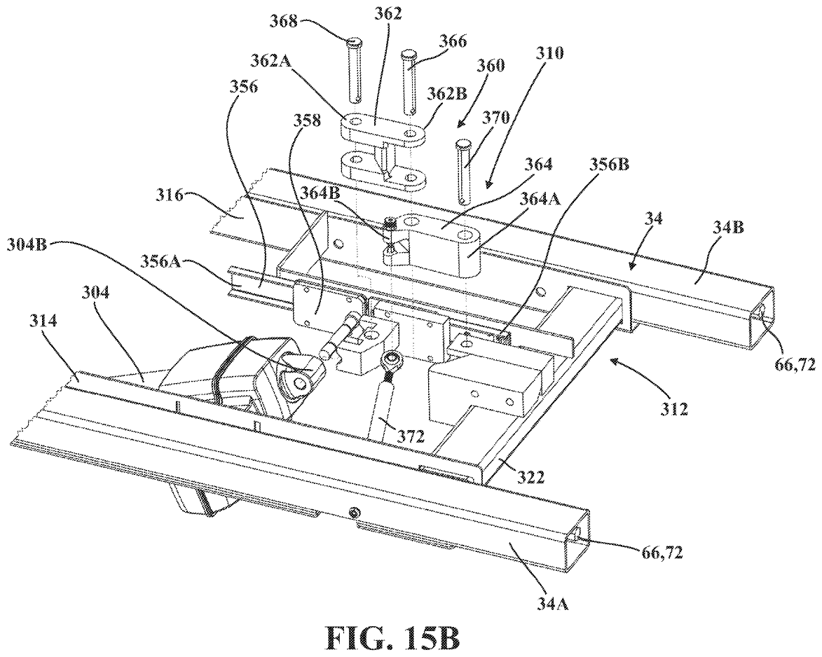

Referring to FIGS. 15A and 15B, in one configuration, the override assembly 310 includes a carriage 356 extending longitudinally between a first carriage end 356A spaced from the auxiliary frame 312 and a second carriage end 356B coupled to the auxiliary frame 312. For example, the second carriage end 356B may be coupled to the second crossmember 322. The override assembly 310 may further include a trolley 358 coupled to the second actuator end 304B of the actuator 304 and engaged with the carriage 356 to guide movement of the second actuator end 304B along the carriage 356. The carriage 356 is configured to guide motion of the trolley 358 to guide the second actuator end 304B between an operational position PO (shown in FIGS. 16A and 17A) and an override position PR (shown in FIGS. 16C and 17C). In the operational position PO, the second actuator end 304B is secured in spaced relation at a first distance D1 (shown in FIG. 17A) from the auxiliary frame 312 to support the actuator 304 for moving the one or more auxiliary wheels 302 between the deployed position 302D and the stowed position 302S. In the override position PR, the second actuator end 304B is secured in spaced relation at a second distance D2 (shown in FIG. 17C), less than the first distance D1, from the auxiliary frame 312 to move the actuator 304 to at least partially disengage the one or more auxiliary wheels 302 from the floor surface FS.

To move the second actuator end 304B between the operational position PO and the override position PR, the override assembly 310 may further include an override linkage 360 coupled to and arranged between the auxiliary frame 312 (e.g., the second crossmember 322) and the second actuator end 304B. The override linkage 360 may be configured for movement between an extended state SE (shown in FIGS. 16A and 17A) and a collapsed state SC (shown in FIGS. 16C and 17C). In the extended state SE, the override linkage 360 moves the second actuator end 304B to the operational position PO. In the collapsed state SC, the override linkage 360 moves the second actuator end 304B to the override position PR.

With continued reference to FIGS. 15A and 15B, in some versions, the override linkage 360 may include a first link 362 and a second link 364. The first link 362 may include a first link mounting end 362A coupled to the second actuator end 304B for pivoting movement relative to the second actuator end 304B, and a first link pivot end 362B. The second link 364 may include a second link mounting end 364A coupled to the auxiliary frame 312 (e.g., the second crossmember 322) for pivoting movement relative to the auxiliary frame 312, and a second link pivot end 364B coupled to the first link pivot end 362B for pivoting movement relative to the first link pivot end 362B. The first link pivot end 362B and the second link pivot end 364B may be coupled via a link pivot shaft 366; however, other arrangements for coupling the first link pivot end 362B and the second link pivot end 364B for pivoting movement are contemplated. The first link mounting end 362A may be coupled to the carriage 356 and/or the second actuator end 304B via a first mounting shaft 368 for pivoting movement relative to the carriage 356 and/or the second actuator end 304B. Similarly, the second link mounting end 364A may be coupled to the auxiliary frame 312 (e.g., the second crossmember 322) via a second mounting shaft 370 for pivoting movement relative to the auxiliary frame 312. Accordingly, the override linkage 360 is configured to hinge at the link pivot shaft 366 to move from the extended state SE to the collapsed state SC to move the second actuator end 304B from the operational position PO to the override position PR. Other arrangements for moving the second actuator end 304B between the operational position PO and the override position PR are contemplated.

The override assembly 310 may further include an override member 372 coupled to and extending between the linkage 66 (e.g., the links 72 of the braking system 64) and the override linkage 360 to concurrently move the override linkage 360 from the extended state SE to the collapsed state SC as the braking system 64 moves from the released state R to the braked state B. In one example, as best shown in FIGS. 16A-17C, the links 72 of the braking system 64 may be the hex shaft 72 which, as described above, is configured to rotate in response to the braking system 64 moving between the braked state B and the released state R. The hex shaft 72 may be coupled to the override member 372 to convert rotation of the hex shaft 72 into translation of the override member 372 to concurrently move the override linkage 360 from the extended state SE to the collapsed state SC as the braking system 64 moves from the released state R to the braked state B. In one example, the link 72 of the braking system 64 may further include a pivot arm 374 that extends from the hex shaft. In this example, the override member 372 is coupled to and extending between the pivot arm 374 of the link 72 and one of the first link pivot end 362B and the second link pivot end 364B to concurrently move the override linkage 360 from the extended state SE to the collapsed state SC as the braking system 64 moves from the released state R to the braked state B.

FIGS. 16A through 17C illustrate a sequence of operating the override assembly 310 of the present example to move the one or more auxiliary wheels 302 from the deployed position 302D toward the stowed position 302S to at least partially disengage the one or more auxiliary wheels 302 from the floor surface FS. FIGS. 16A and 17A show the linkage 66 in the steer state S and, as a result, the override linkage in the extended state SE and the second actuator end 304B in the operational position PO such that the actuator 304 is configured to move the axle assembly 306 to move the one or more auxiliary wheels 302 between the deployed position 302D and the stowed position 302S. FIGS. 16B and 17B show the linkage 66 in the neutral state N, and, as a result, the override linkage 360 in an intermediate state SI as the hex shaft 72 rotates to move the braking system 64 from the released state R toward the braked state B. The override member 372 translates in response to the rotation of the hex shaft 72 to move the override linkage 360 toward the collapsed state SC. As a result, the override linkage 360 moves the second actuator end 304B along the carriage 356 toward the override position PR. FIGS. 16C and 17C show the linkage 66 in the brake state S, and, as a result, the override linkage 360 in the collapsed state SC. Here, the override linkage 360 moves to the collapsed state SC as a result of the hex shaft 72 continuing to rotate to place the braking system 64 in the braked state B. The override member 372 moves the override linkage 360 concurrently with the hex shaft 72 to the collapsed state SC as the braking system 64 reaches the braked state B. As a result, the override linkage 360 moves the second actuator end 304B along the carriage 356 to the override position PR such that the actuator 304 moves toward the auxiliary frame 312 to lift the axle assembly 306 to at least partially disengage the one or more auxiliary wheels 302 from the floor surface FS.

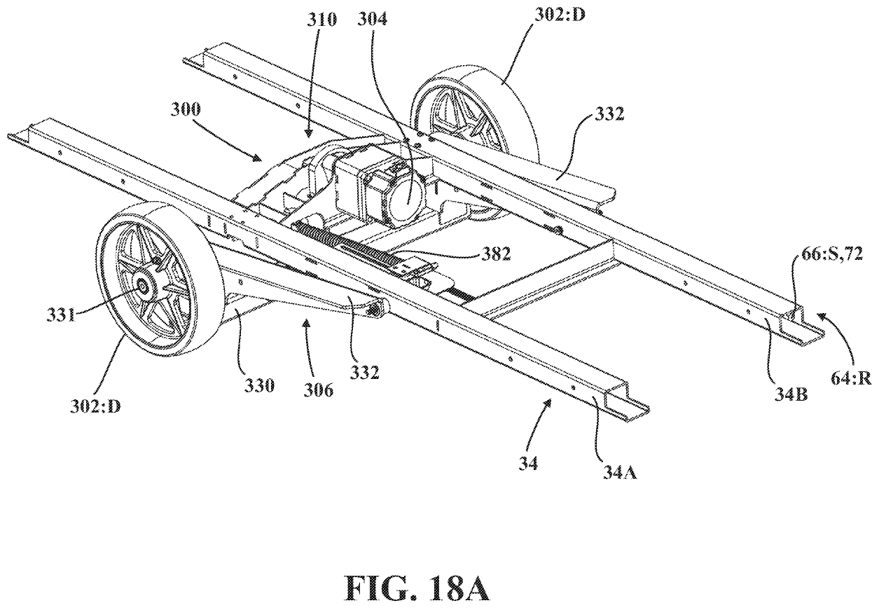

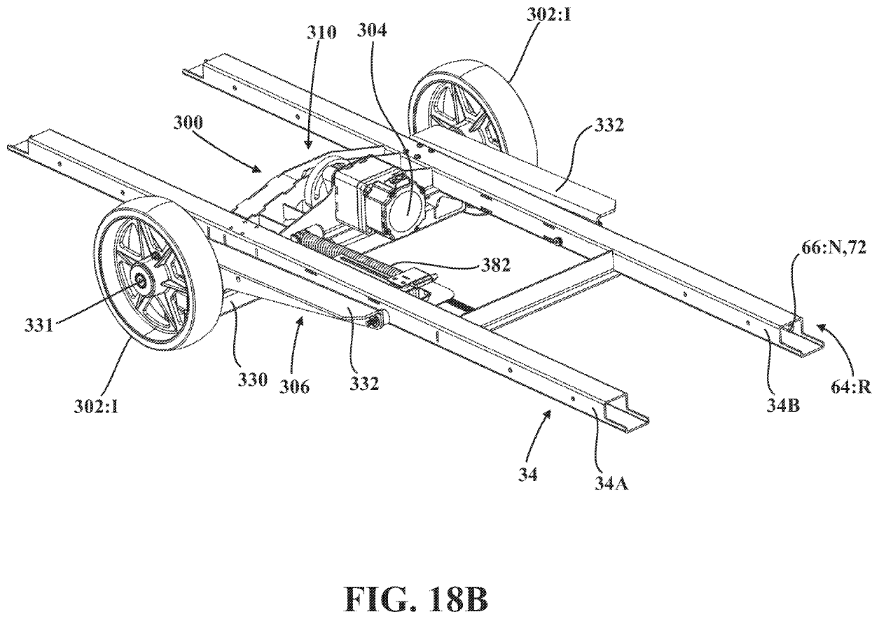

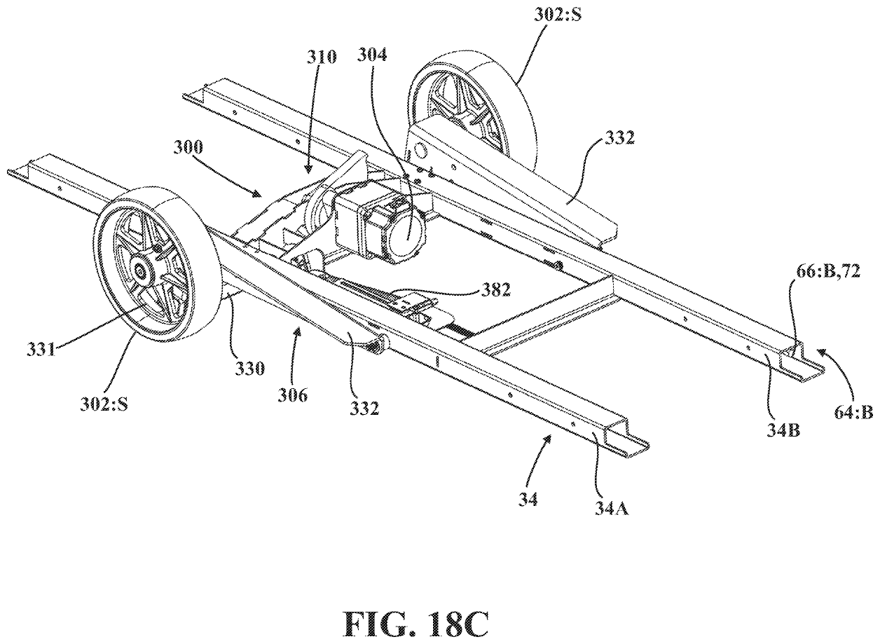

FIGS. 18A-27C illustrate a portion of the patient transport apparatus 30 including another example of the auxiliary wheel assembly 300 and the override assembly 310. Referring to FIGS. 18A-18C, the auxiliary wheel assembly 300 may include the axle assembly 306 for supporting the one or more auxiliary wheels 302. In this example, the axle assembly 306 is coupled to the base 34 (e.g., to the first base rail 34A and the second base rail 34B) for pivoting movement relative to the base 34 to move the one or more auxiliary wheels 302 between the plurality of auxiliary support positions including the deployed position 302D and the stowed position 302S. In this example, the axle assembly 306 includes an axle member 330 including at least one axle shaft 331 for rotatably supporting the at least one auxiliary wheel 302. The axle assembly 306 of this example may further include a pair of swing arms 332 coupled to and extending between the axle member 330 and the base 34 to facilitate pivoting movement of the axle member 330 relative to the base 34.

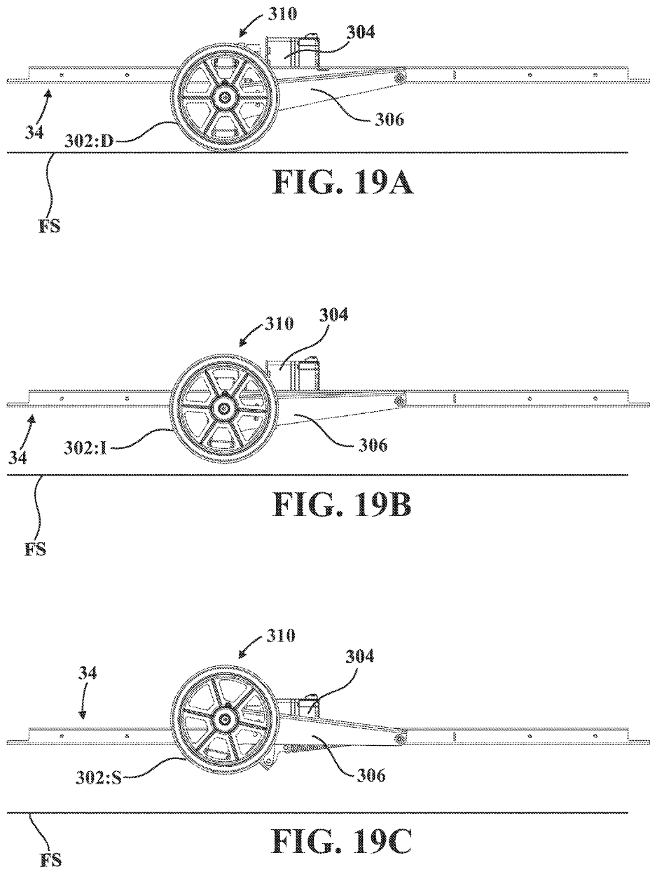

FIGS. 18A through 19C illustrate a sequence of the one or more auxiliary wheels 302 of the auxiliary wheel assembly 300 moving from the deployed position 302D toward the stowed position 302S to at least partially disengage the one or more auxiliary wheels 302 from the floor surface FS. FIGS. 18A and 19A show the one or more auxiliary wheels 302 of the auxiliary wheel assembly 300 in the deployed position 302D. FIGS. 18B and 19B show the one or more auxiliary wheels 302 of the auxiliary wheel assembly 300 in an intermediate position 302I. FIGS. 18C and 19C show the one or more auxiliary wheels 302 of the auxiliary wheel assembly 300 in the stowed position 302S.

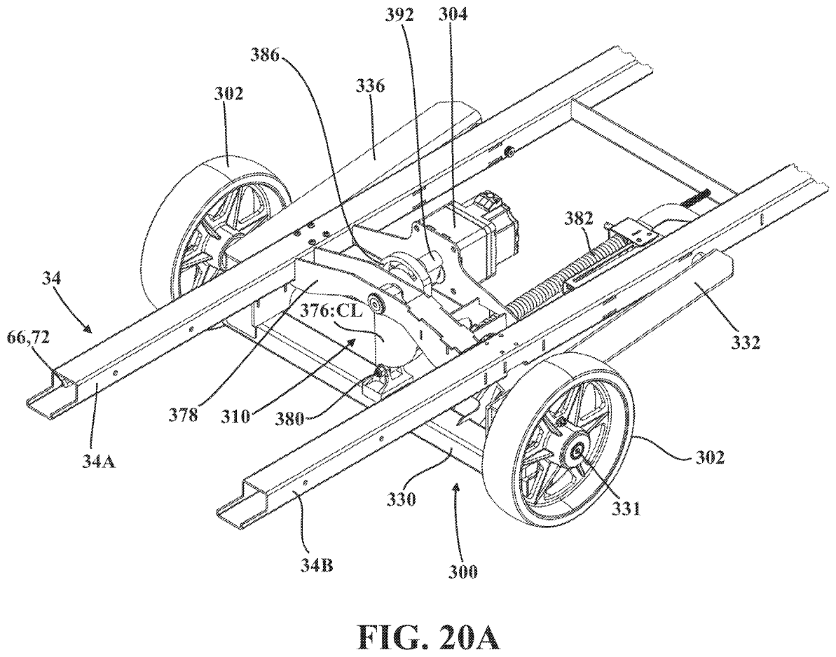

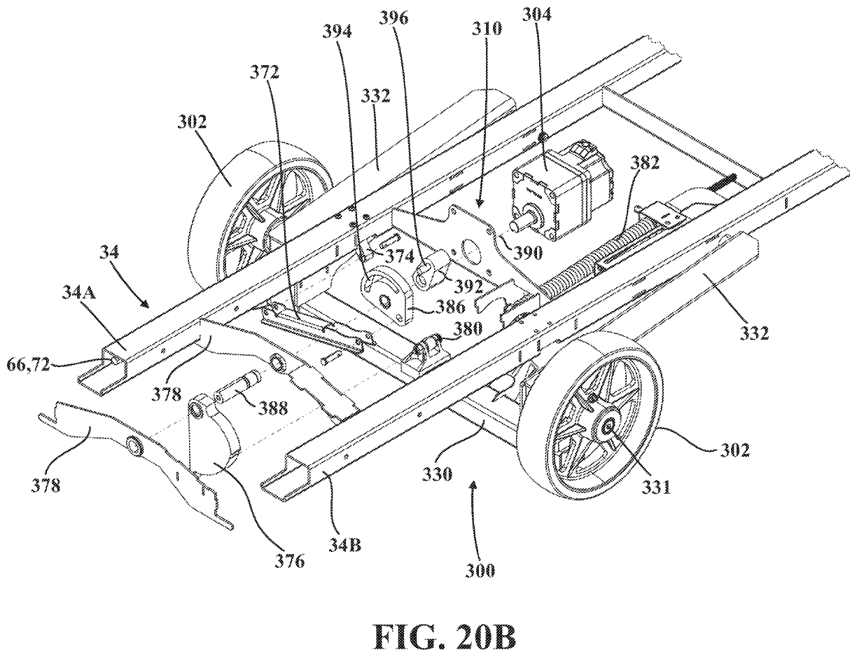

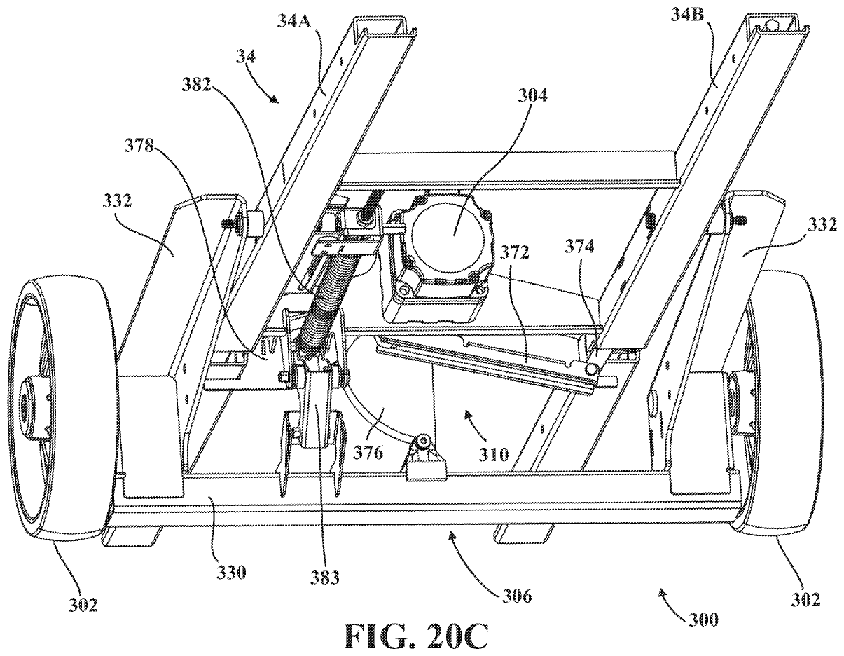

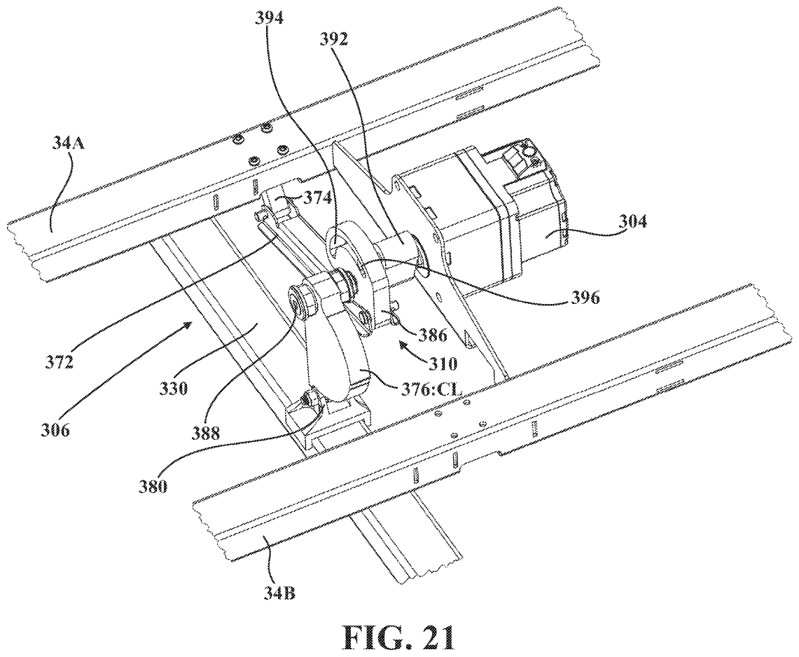

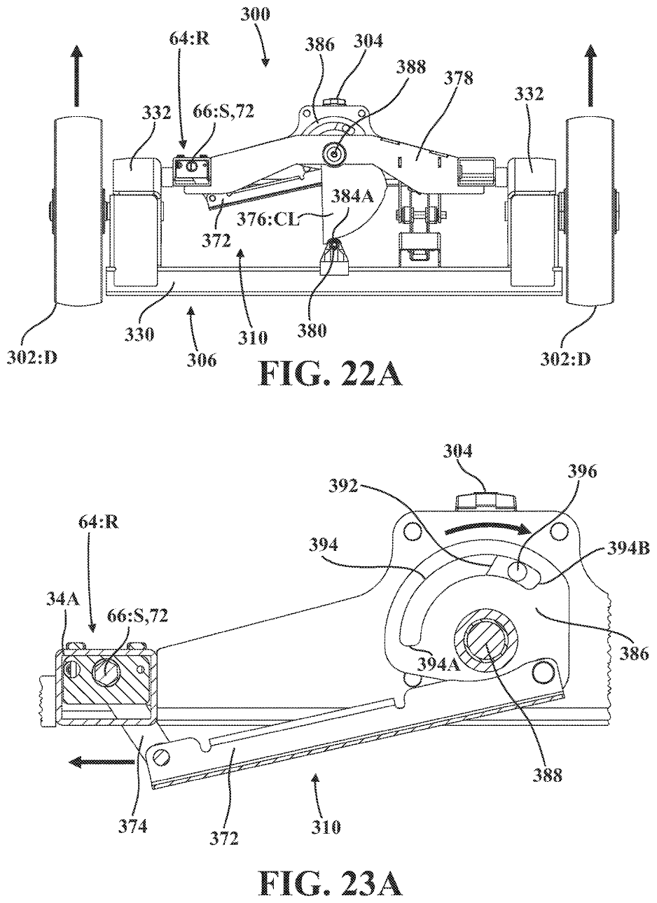

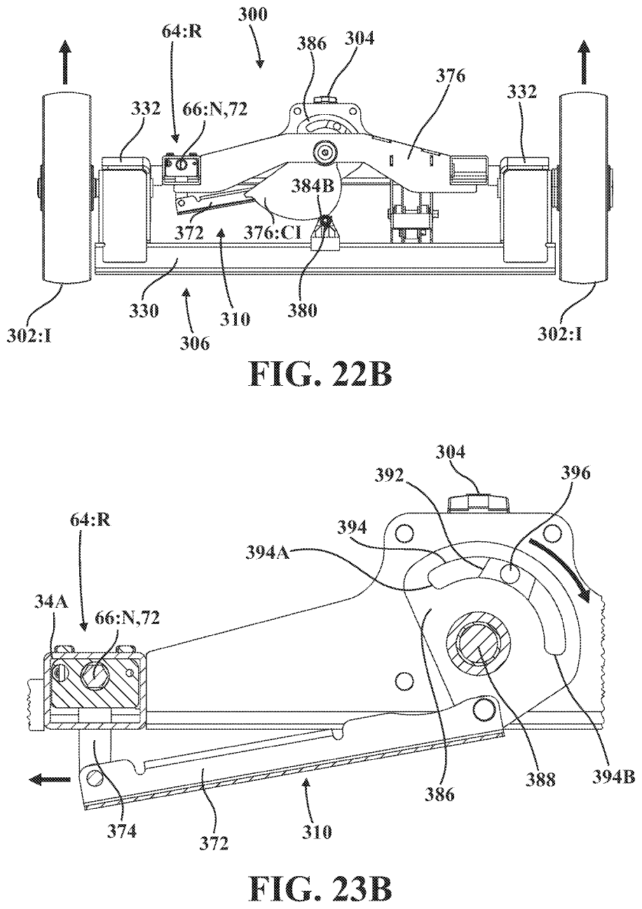

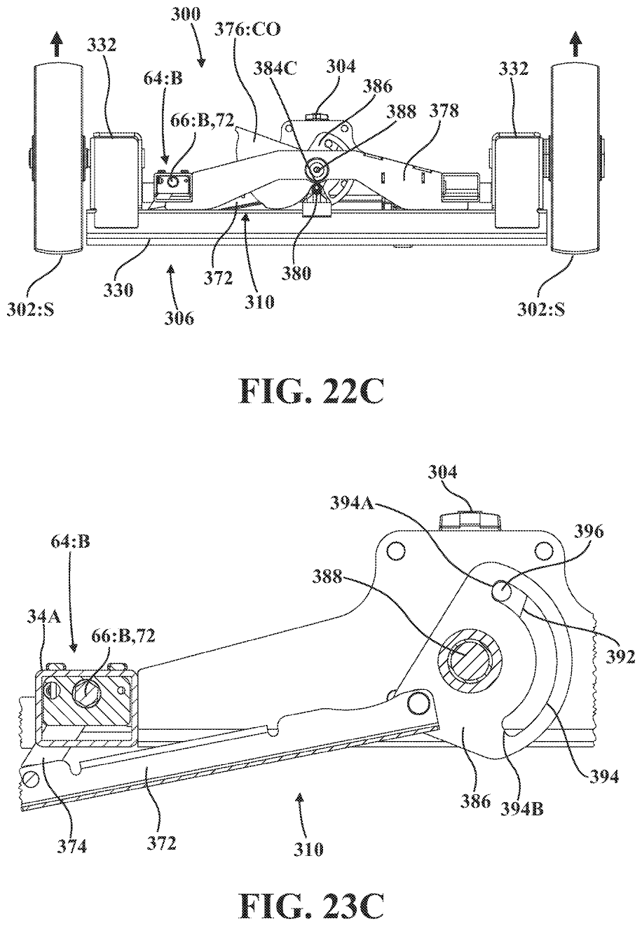

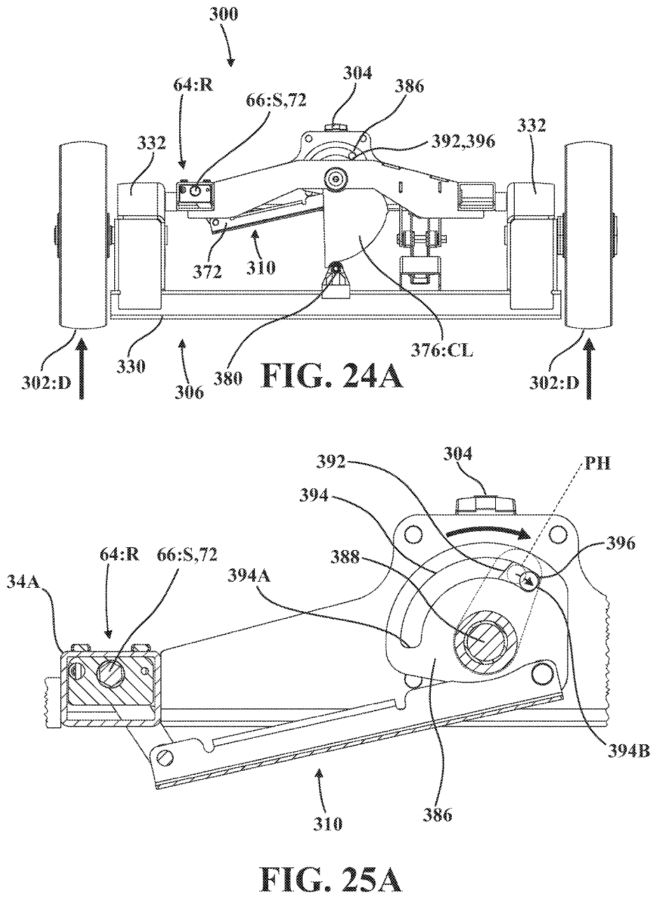

Referring to FIGS. 20A-21, the override assembly 310 of the present example includes a cam member 376 disposed between the base 34 and the axle assembly 306, and operatively attached to the axle assembly 306 to move the axle assembly 306 relative to the base 34. For example, the cam member 376 may be rotatably supported by a cam support bracket 378 extending between the first base rail 34A and the second base rail 34B. Additionally, the cam member 376 may contact the axle member 330 to move the axle member 330 relative to the base 34. The cam member 376 may be configured to move between a plurality of cam positions including a cam lift position CL (shown in FIGS. 22A and 23A) and a cam lower position CO (shown in FIGS. 22C and 23C). In the cam lift position CL, the cam member 376 moves the one or more auxiliary wheels 302 to the deployed position 302D. In the cam lower position CO, the cam member 376 moves the one or more auxiliary wheels 302 to the stowed position 302S. In some versions, as best shown in FIG. 20C, the auxiliary wheel assembly 300 also includes a biasing member 382 operatively attached to the base 34 and the axle assembly 306, the biasing member 382 configured to urge the axle assembly 306 against the cam member 376. For example, with continued reference to FIG. 20C, the biasing member 382 is a spring that is operatively attached at one end to the base 34 and operatively attached at another end to a pivot member 383. In this example, the spring generates tension between the base 34 and the pivot member 383. The pivot member 383 is pivotably mounted to the base 34 and the first axle member 330 such that the biasing member 382 biases the pivot member 383 to urge the axle assembly 306 against the cam member 376.

In some versions, the axle assembly 306 of the auxiliary wheel assembly 300 may include a roller 380 coupled to the axle assembly 306 and disposed between the axle assembly 306 and the cam member 376. The roller 380 may be configured to abut the cam member 376 and rotate to allow the cam member 376 to move between the cam lower position CO and the cam lift position CL. Additionally, in some versions, the cam member 376 defines a plurality of detents 384. The plurality of detents 384 are configured to engage the roller 380 to hold the cam member 376 in a corresponding cam position. For example, the cam member 376 may define a cam lift detent 384A for holding the cam member 176 in the cam lift position CL (shown in FIGS. 22A and 23A), thereby holding the auxiliary wheel in the deployed position 302D. The cam member may also define a cam lower detent 384C for holding the cam member 376 in the cam lower position CO (shown in FIGS. 22C and 23C), thereby holding the auxiliary wheel in the stowed position 302S. In some versions, the cam member 376 includes a cam intermediate detent 384I arranged between the cam lift detent 384A and the cam lower detent 384C for holding the cam member 376 in a cam intermediate position CI between the cam lift position CL and the cam lower position CO (shown in FIGS. 22B and 23B), thereby holding the auxiliary wheel in an intermediate position 302I between the auxiliary wheel in the stowed position 302S and the auxiliary wheel in the deployed position 302D.

With continued reference to FIGS. 20A-21, the auxiliary wheel assembly 300 may further include a cam driver 386 coupled to the cam member 376 for concurrent rotation with the cam member 376. Similar to the cam member 376, the cam driver 386 may be rotatably supported by the cam support bracket 378. For example, both the cam member 376 and the driver 386 may be coupled to a cam shaft 388 that is rotatably supported by the cam support bracket 378. In one example, the cam shaft 388 defines key slots (not shown) that correspond to key slots defined by each of the cam member 376 and the cam driver 386 such that the cam member 376 and the cam driver 386 may be coupled to the cam shaft 388 with keys (not shown) such that the cam driver 386 such that the cam member 376 rotate concurrently. Additionally, as shown in the configurations of FIGS. 20A-21, the actuator 304 may be a rotary actuator 304 configured to generate torque about an actuator axis 390. Further, the auxiliary wheel assembly 300 may further include an actuator driving member 392 coupled to the actuator 304 for concurrent rotation with the actuator 304 about the actuator axis 390. In this example, the cam driver 386 may define a slot 394 extending between a first slot end 394A and a second slot end 394B. Additionally, the actuator driving member 392 may include a projection 396 spaced from the actuator axis 390 and disposed in the slot 394 of the cam driver 386. Accordingly, the projection 396 is configured to translate within the slot 394 of the cam driver 386 and abut one of the first slot end 394A and the second slot end 394B to transfer motion from the actuator 304 to move the cam driver 386 to move the cam member 376 between the cam lift position CL and the cam lower position CO. Operation of the actuator to move the cam member 376 between the cam lift position CL and the cam lower position CO is described in further detail below. Additionally, it should be appreciated that FIGS. 20A-21 show one non-limiting arrangement of the actuator 304, the cam driver 386, and the actuator driving member 392 including slot 394. In other examples (not shown) the actuator 304, the cam driver 386, and the actuator driving member 392 including slot 394 may be arranged elsewhere along the linkage 66, such as adjacent to the brake input device 68. More specifically, in some versions, a single actuator 304 may be employed disposed adjacent to one longitudinal end of the base 34, or may be disposed between the longitudinal ends of the base 34. Furthermore, in some versions one actuator 304 may be utilized to operate the override assembly 310 as well as the braking system 64, but in other versions the override assembly 310 and the braking system 64 may employ separate actuators, which may be similar to each other or may be of different sizes, torque ratings, configurations (e.g., one rotary and one linear), and the like. Other configurations are contemplated. Referring to FIGS. 20A through 23C, the override assembly 310 may further comprise an override member 372 coupled to and extending between the linkage 66 (e.g., link 72 of the braking system 64) and the cam driver 386 to concurrently move the cam member 376 from the cam lift position CL to the cam lower position CO as the braking system 64 moves from the released state R to the braked state B. Similar to above, and as shown in FIGS. 22A-23C, the links 72 of the braking system 64 may be a hex shaft 72. Also similarly, the links 72 of the braking system 64 may further include a pivot arm 374 that extends from the hex shaft 72. The hex shaft 72 may be coupled to the override member 372 (e.g., via the pivot arm 374) to convert rotation of the hex shaft 72 into rotation of the cam driver 386 to concurrently move the cam member 376 from the cam lift position CL to the cam lower position CO as the braking system 64 moves from the released state R to the braked state B. In some examples, the cam lift position CL may correspond to the steer state S of the linkage 66, the cam lift position CL may correspond to the brake state B of the linkage 66, and a cam intermediate position CI may correspond to the neutral state N of the linkage 66.

FIGS. 22A-23C illustrate a sequence of operating the override assembly 310 of the present example to move the one or more auxiliary wheels 302 from the deployed position 302D toward the stowed position 302S to at least partially disengage the one or more auxiliary wheels 302 from the floor surface FS. FIGS. 22A and 23A show the cam member 376 in the cam lift position CL, the braking system 64 in the released state, and the linkage 66 in the steer state S. Accordingly, the cam member 376 abuts the axle assembly 306 such that the one or more auxiliary wheels 302 are arranged in the deployed position 302D. FIGS. 22B and 23B show the cam driver 386 rotating in response to the linkage 66 moving from the steer state S to the neutral state N. Accordingly, the cam driver 386 moves the cam member 376 from the cam lift position CL to the cam intermediate position CI. As a result, the cam member 376 moves the axle assembly 306 to move the one or more auxiliary wheels 302 to the intermediate position 302I. FIGS. 22C and 23C show the cam driver 386 rotating in response to the linkage 66 moving from neutral state N to the brake state B. Accordingly, the cam driver 386 moves the cam member 376 from the cam intermediate position CI to the cam lower position CO to move the one or more auxiliary wheels 302 to the stowed position 302S, and the rotation of the hex shaft 72 places the braking system 64 in the braked state B.

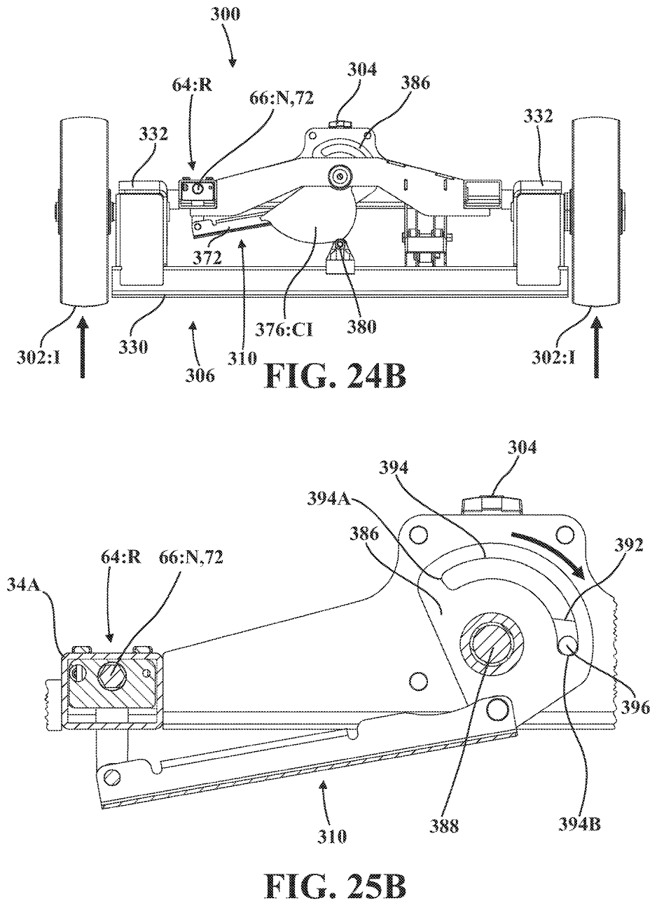

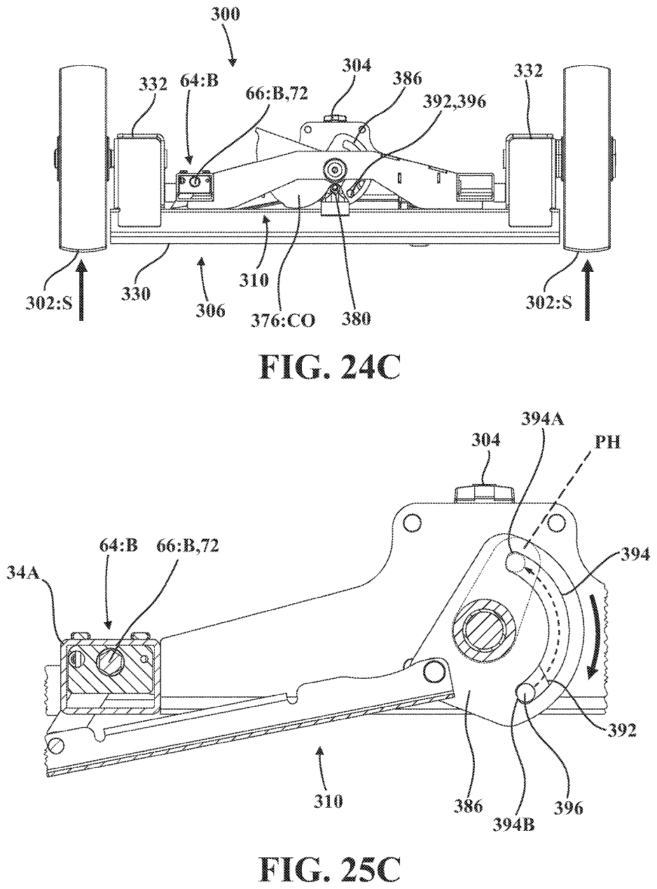

FIGS. 24A-27C illustrate a sequence of operating the actuator 304 to move the auxiliary wheels 302 between the deployed position 302D and the stowed position 302S. In these example, the actuator 304 generates torque to rotate the actuator driving member 392 to abut the projection 396 of the actuator driving member 392 against the second slot end 394B (shown in FIGS. 24A-25C) to concurrently rotate the actuator driving member 392 and the cam driver 386 to move the cam member 376 toward the cam lower position CO. Conversely, the actuator 304 of the present example is also configured to generate torque to rotate the actuator driving member 392 to abut the projection 396 of the actuator driving member 392 against the first slot end 394A to concurrently rotate the actuator driving member 392 and the cam driver 386 to move the cam member 376 toward the cam lift position CL.

With continued reference to FIGS. 24A-27C, in some versions, the slot 394 of the cam driver 386 extends between the first slot end 394A and the second slot end 394B about an arc. The arc may be shaped to permit translation of the projection 396 within the slot 394 without abutting the first slot end 394A and/or the second slot end 394B in response to movement of the cam member 376 due to operation of the override assembly 310, as described below. Additionally, in some versions, such as shown in FIGS. 25C and 27A, actuator 304 is configured to move the actuator driving member 392 to a home position PH after moving the cam member 376 to prevent the projection 396 from abutting one of the first slot end 394A and the second slot end 394B in response to movement of the cam member 376 to operation of the override assembly 310.

FIGS. 24A-25C illustrate a sequence of operating the actuator 304 to move the auxiliary wheels 302 from the deployed position 302D to the stowed position 302S. FIGS. 24A and 25A show the one or more auxiliary wheels 302 in the deployed position 302D. FIGS. 24A and 25A further show the actuator 304 generating torque to rotate the actuator driving member 392 from the home position PH to abut the projection 396 against the second slot end 394B of the cam driver 386. Accordingly, when the projection 396 abuts the second slot end 394B, the cam driver 386 rotates concurrently with the actuator driving member 392 to move the cam member 376 from the cam lift position CL toward the cam lower position CO, as illustrated in FIGS. 24B-25C. FIGS. 24B and 25B show the one or more auxiliary wheels 302 in the intermediate position 302I as the actuator 304 continues to generate torque to rotate the actuator driving member 392 such that the cam driver 386 rotates concurrently with the actuator driving member 392 to move the cam member 376 to the cam intermediate position CI. FIGS. 24C and 25C show the one or more auxiliary wheels 302 reaching the stowed position 302S as the actuator 304 continues to generate torque to rotate the actuator driving member 392 such that the cam driver 386 rotates concurrently with the actuator driving member 392 to move the cam member 376 toward the cam lower position CO.

In some versions, as illustrated in FIG. 25C, the actuator 304 may be configured to return the actuator driving member 392 to the home position PH (e.g., after the cam member 376 reaches the cam lower position CO) to prevent the actuator 304 from being back-driven due to operation of the override assembly 310. In other words, returning the actuator driving member 392 to the home position PH allows the projection 396 to translate within the slot 394 during operation of the override assembly 310 without the projection 396 abutting one of the first slot end 394A and the second slot end 394B such that rotation of the projection 396 back-drives the actuator 304.

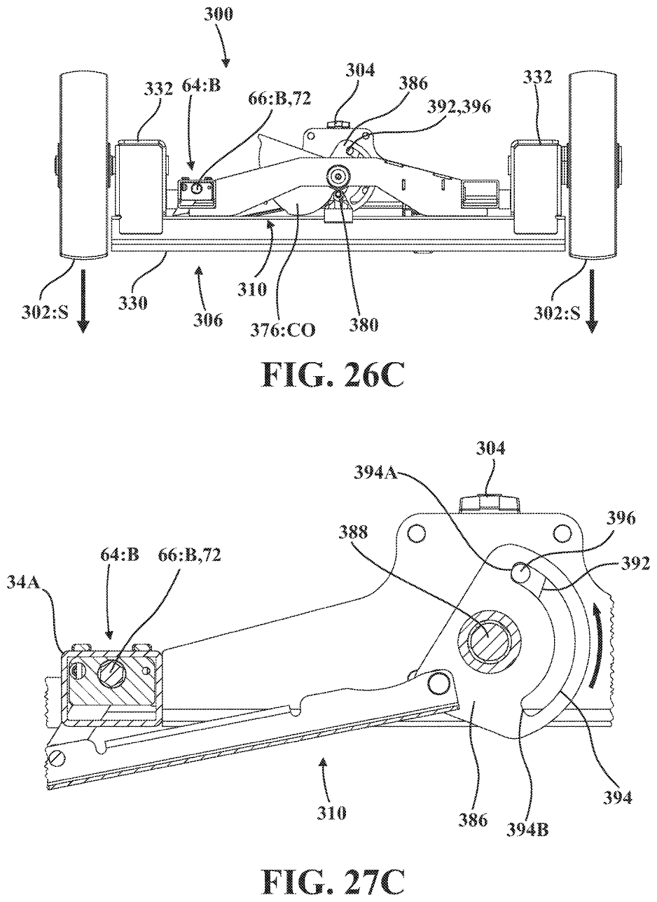

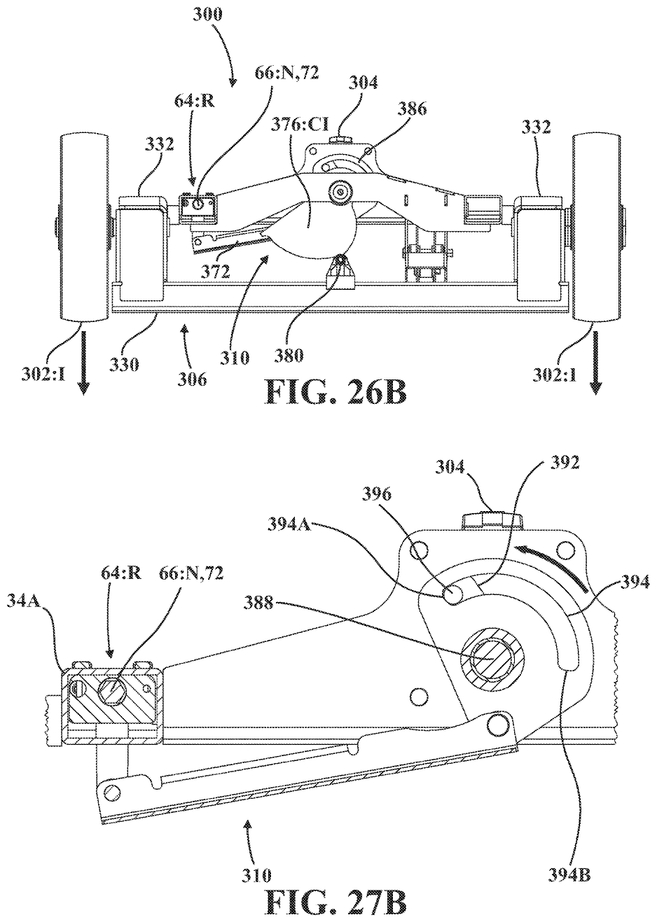

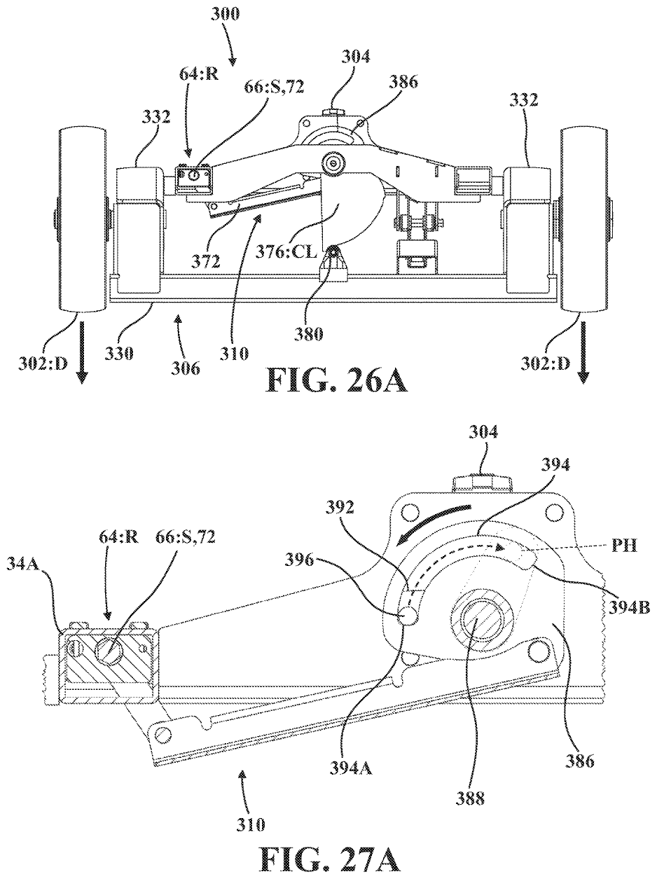

Conversely, FIGS. 26A-27C illustrate a sequence of the actuator 304 moving the auxiliary wheels 302 from the stowed position 302S to the deployed position 302D. FIGS. 26C and 27C show the one or more auxiliary wheels 302 in the stowed position 302S. FIGS. 26C and 27C further show the actuator 304 generating torque to rotate the actuator driving member 392 to abut the projection 396 against the first slot end 394A of the cam driver 386. Accordingly, the cam driver 386 rotates concurrently with the actuator driving member 392 to move the cam member 376 from the cam lower position CO toward the cam lift position CL, as shown in FIGS. 26A-27B. FIGS. 26B and 27B show the one or more auxiliary wheels 302 in the intermediate position 302I as the actuator 304 continues to generate torque to rotate the actuator driving member 392 such that the cam driver 386 rotates concurrently with the actuator driving member 392 to move the cam member 376 to the cam intermediate position CI. FIGS. 26A and 27A show the one or more auxiliary wheels 302 reaching the deployed position 302D as the actuator 304 continues to generate torque to rotate the actuator driving member such that the cam driver 386 rotates concurrently with the actuator driving member 392 to move the cam member 376 toward the cam lift position CL. In some versions, as illustrated by FIG. 27A, the actuator 304 may be configured to return the actuator driving member 392 to the home position PH (e.g., after the cam member 376 reaches the cam lift position CL) to prevent the actuator 304 from being back-driven due to operation of the override assembly 310.

Referring to FIGS. 24A-27C, even when the actuator 304 effectuates the movement of the one or more auxiliary wheels, the linkage 66 remains in coordinated motion with the cam member 376. Thus, the actuator 304 in the present example may be configured to move the braking system 64 between the braked state B and the released state R. Accordingly, in this example, the linkage 66 (and the braking system 64) is in the brake state B when the cam member 376 is in the cam lower position CO, the linkage 66 is in the neutral state N (and the braking system is in the released state R) when the cam member 376 is in the cam intermediate position CI, and the linkage 66 is in the steer state S (and the braking system is in the released state R) when the cam member 376 is in the cam lower position CO.

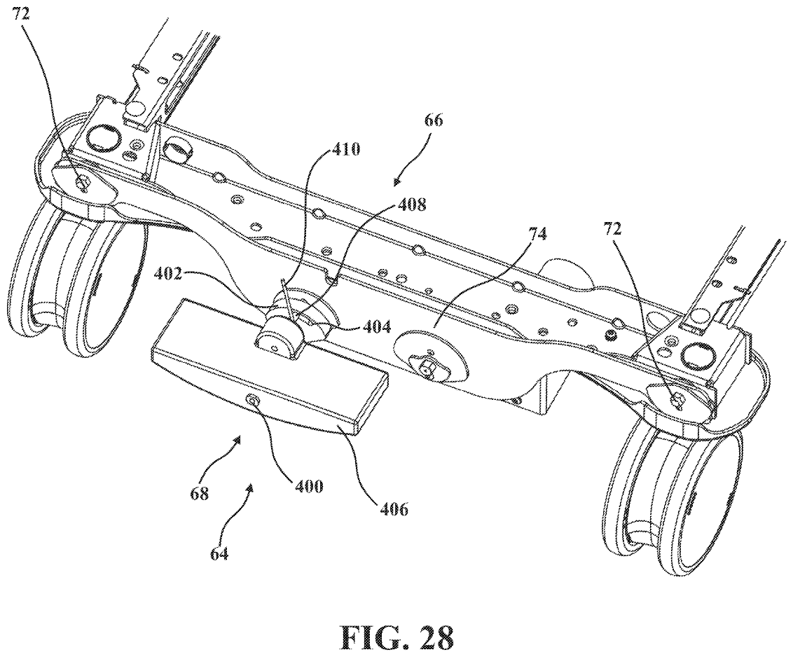

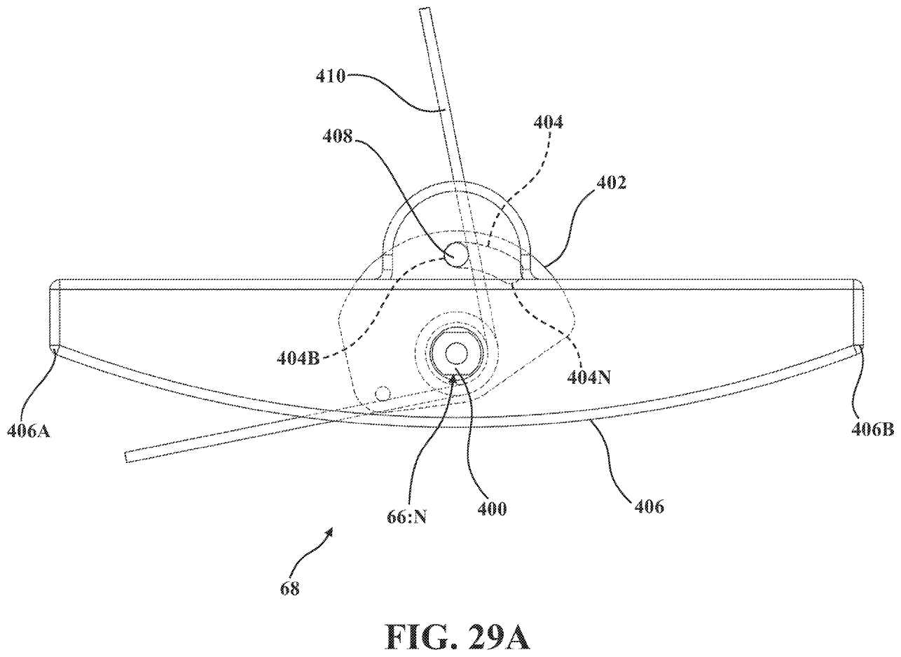

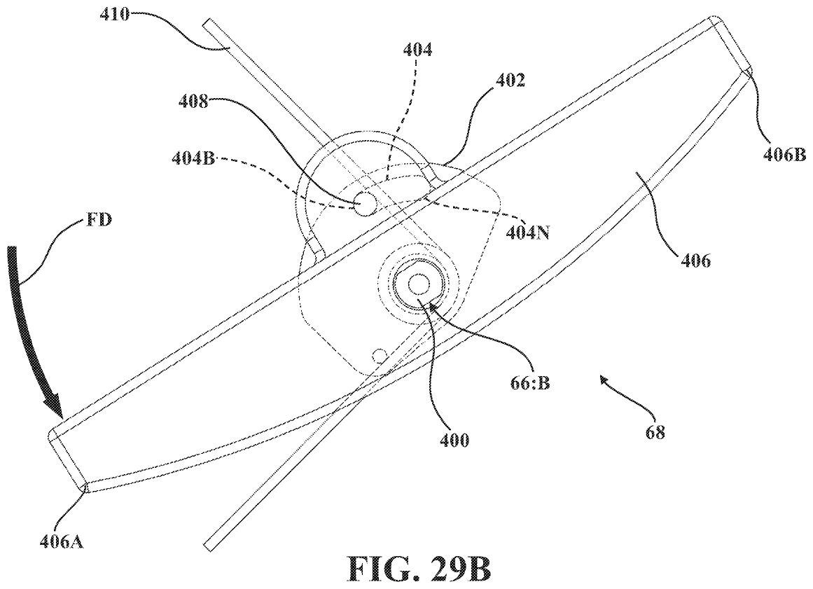

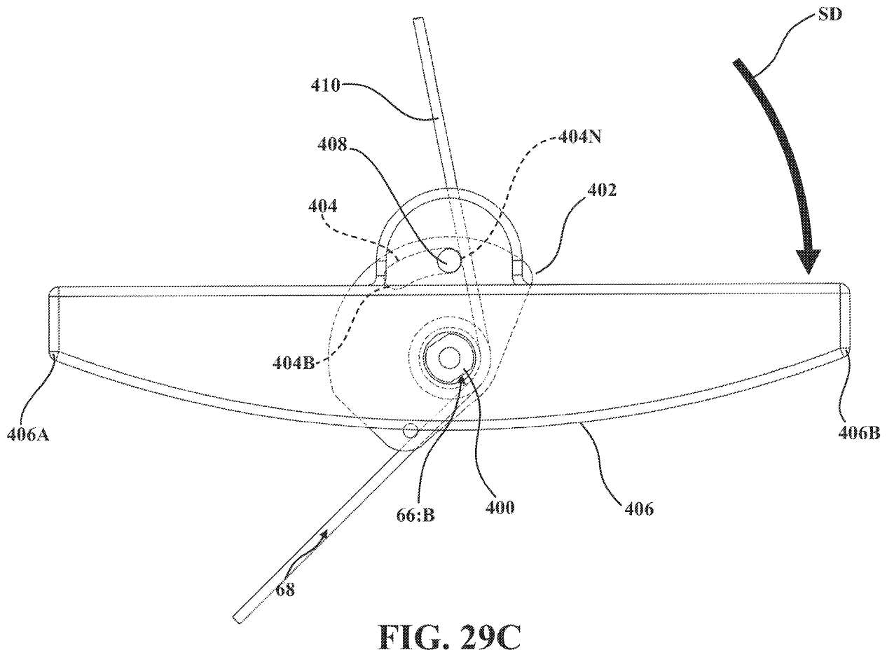

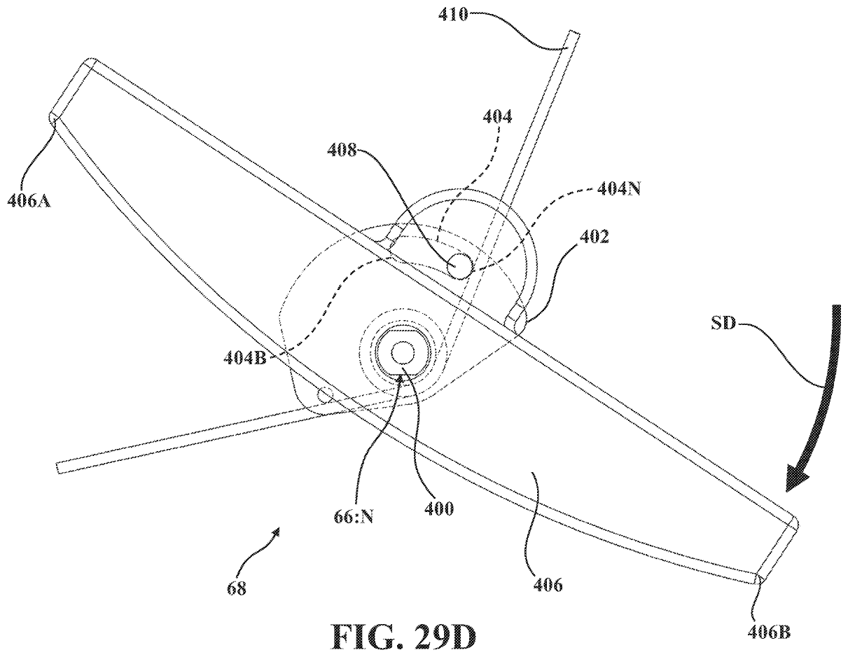

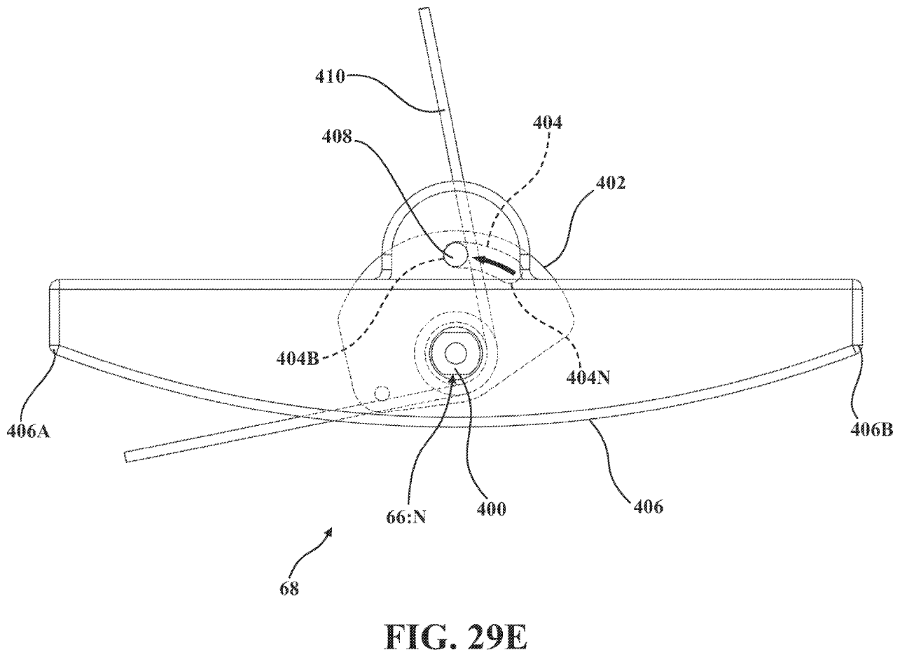

Referring to FIGS. 28-29E, in some examples, the brake input device 68 may further include features to prevent a user from manually engaging the steer state S of the linkage 66. For example, the brake input device 68 may include a shaft 400 operatively attached to the linkage 66 for concurrent movement with the linkage 66, and a shaft driver 402 coupled to the shaft 400 for concurrent rotation with the shaft 400. The shaft driver 402 may define a shaft driver slot 404 extending between a slot brake end 404B and a slot neutral end 404N. The brake input device 68 may include a pedal 406 operatively attached to the shaft 400 for pivoting movement relative to the shaft 400. For example, the pedal 406 may be arranged over the shaft 400 but not rotate concurrently with the shaft 400. The pedal 406 may include a pedal projection 408 spaced from the shaft 400 and disposed in the shaft driver slot 404. Accordingly, the pedal projection 408 may translate within the shaft driver slot 404 as the pedal 406 pivots relative to the shaft 400 such that the pedal projection 408 abuts one of the slot brake end 404B and the slot neutral end 404N to transfer motion from the pedal 406 to the shaft 400.

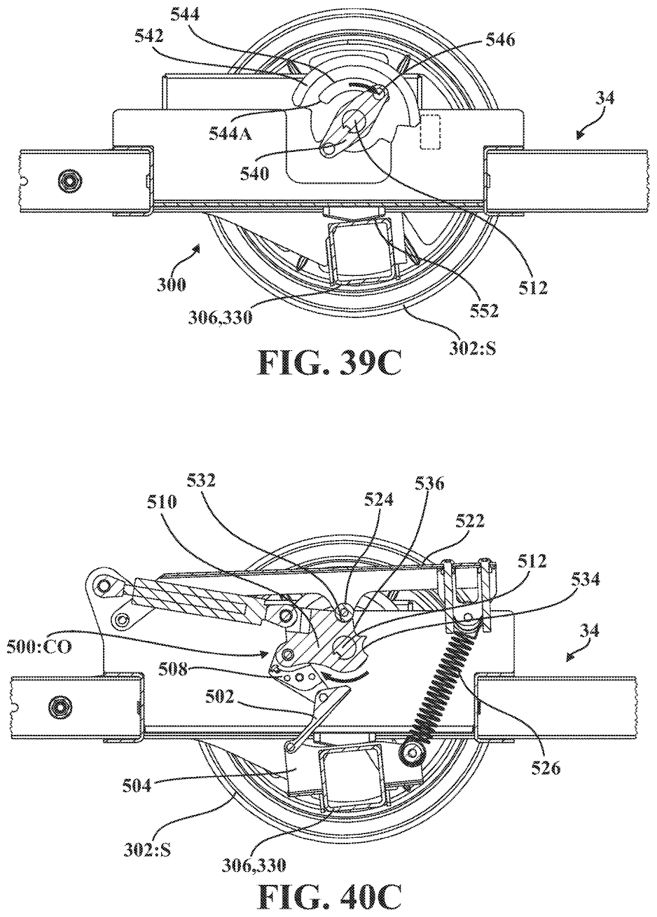

Referring to FIGS. 29A-29E, the pedal projection 408 may be configured to orbit around the shaft 400 in a first direction FD in response to a user engaging a first side 406A of the pedal 406 to abut the pedal projection 408 against the slot brake end 404B to concurrently rotate the pedal 406 and the shaft driver 402 to move the shaft 400 to move the linkage 66 to the braked state B (see transition from FIGS. 29A to 29B). Similarly, the pedal projection 408 may be configured to orbit around the shaft 400 in a second direction SD, opposite the first direction FD, to abut the pedal projection 408 against the slot neutral end 404N to concurrently rotate the pedal 406 and the shaft driver 402 to move the shaft 400 to move the linkage 66 to the neutral state N (see transition from FIGS. 29B to 29D). In some examples, further rotation of the pedal 406 in the second direction SD beyond the rotation shown in FIG. 39D is prevented to inhibit a user from manually moving the linkage 66 into the steer state S. For example, the pedal 406 may include a pedal stop (not shown) extending from the pedal 406 to contact the floor surface FS to prevent further rotation of the pedal 406. Inhibiting a user from manually moving the linkage 66 into the steer state S is advantageous because it may be difficult for a user to generate sufficient toque to move the one or more auxiliary wheels 302 to the deployed position 302D. Accordingly, the translation of the pedal projection 408 within the shaft driver slot 404 prevents a user from rotating the shaft 400 sufficiently to move the linkage 66 into the steer state S. Also, in some configurations, the brake input device 68 may further include a brake input biasing member 410 configured to urge the pedal projection 408 of the pedal 406 toward the slot brake end 404B such that when the linkage 66 is in the neutral state N, the pedal 406 is biased toward a flat position (see transition from FIGS. 29D to 29E).

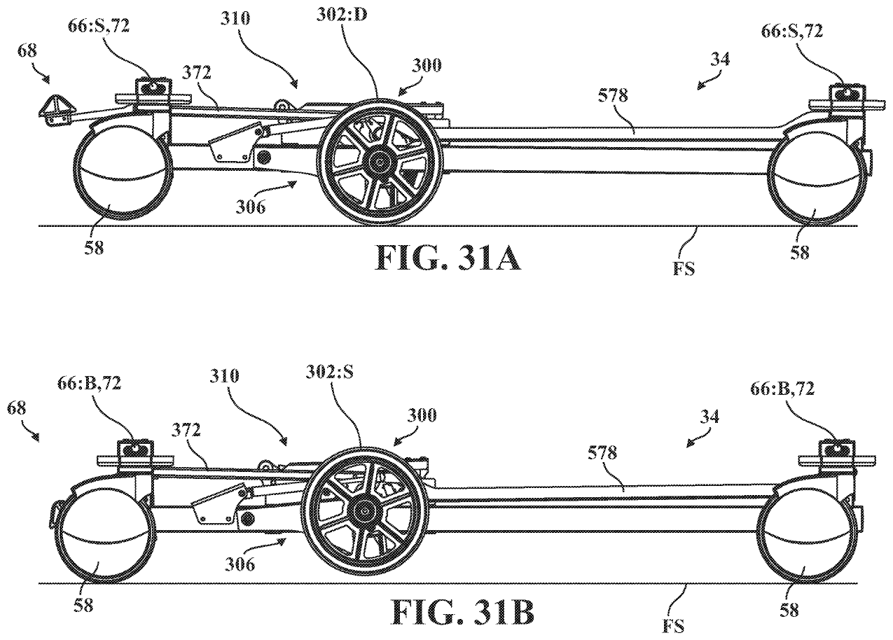

FIGS. 30A through 50C illustrate a portion of the patient transport apparatus 30 including yet another example of the auxiliary wheel assembly 300 and the override assembly 310. Referring to FIGS. 30A-31B, the auxiliary wheel assembly 300 may include the axle assembly 306 for supporting the one or more auxiliary wheels 302. Here, the axle assembly 306 is coupled to the base 34 (e.g., to the first base rail 34A and the second base rail 34B) for pivoting movement relative to the base 34 to move the one or more auxiliary wheels 302 between the plurality of auxiliary support positions including the deployed position 302D and the stowed position 302S. Similar to previous examples, here, the axle assembly 306 includes an axle member 330 including at least one axle shaft 331 for rotatably supporting the at least one auxiliary wheel 302. The axle assembly 306 may further include a pair of swing arms 332 coupled to and extending between the axle member 330 and the base 34 to facilitate pivoting movement of the axle member 330 relative to the base 34.

FIGS. 30A through 31B illustrate a sequence of the one or more auxiliary wheels 302 of the auxiliary wheel assembly 300 moving from the deployed position 302D to the stowed position 302S to at least partially disengage the one or more auxiliary wheels 302 from the floor surface FS. FIGS. 30A and 31A show the one or more auxiliary wheels 302 of the auxiliary wheel assembly 300 in the deployed position 302D. FIGS. 30B and 31B show the one or more auxiliary wheels 302 of the auxiliary wheel assembly 300 in the stowed position 302S.

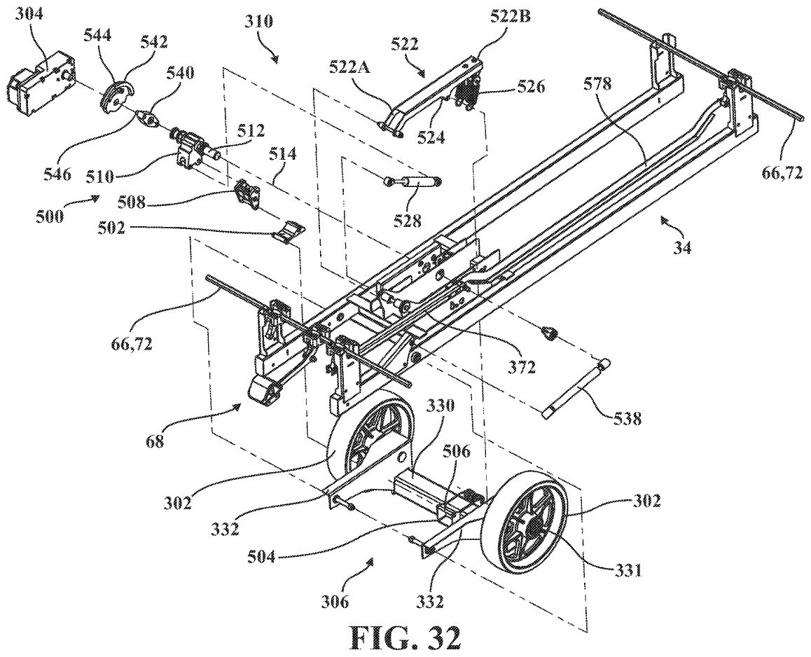

The override assembly 310 of the present example includes a cam assembly 500 operatively attached to the axle assembly 306 to move the axle assembly 306 relative to the base 34 to move the one or more auxiliary wheels 302 between the stowed position 302S and the deployed position 302D. The cam assembly 500 is configured to move between a plurality of cam positions including a cam lower position CO where the cam assembly 500 moves the axle assembly 306 to move the auxiliary wheel 302 to the stowed position 302S, and a cam lift position CL where the cam assembly 500 moves the axle assembly 306 to move the auxiliary wheel 302 to the deployed position 302D. Referring to FIGS. 32 through 37, the cam assembly 500 may include a coupling link 502 operatively attached to the axle assembly 306. For example, the axle assembly 306 may include a mounting bracket 504, and the coupling link 502 may be pivotably attached to the mounting bracket via a pin 506. Of course, other configurations of pivotably attaching the coupling link 502 to the axle assembly 306 are contemplated. The cam assembly 500 may also include an intermediate link 508 coupled to the coupling link 502 (e.g., via a pin 506) for pivotal movement relative to the coupling link 502. The cam assembly 500 may further include a cam member 510. The cam member 510 may be coupled to an override shaft 512 supported by the base 34 for rotation about an override axis 514. The cam member 510 is coupled to the intermediate link 508 (e.g., via a pin 506) such that the coupling link 502 and the intermediate link 508 are configured to pivot relative to each other in response to rotation of the cam member 510 to expand the cam assembly 500 between the cam lower position CO and the cam lift position CL.

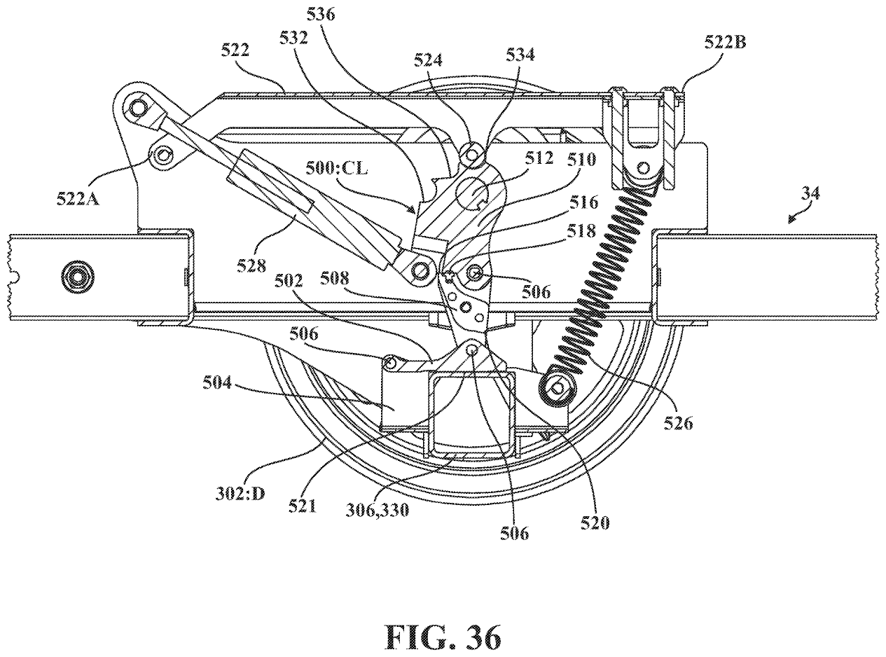

As best shown in FIG. 36, the intermediate link 508 may include a first stop portion 516 configured to abut the cam member 510 to delimit rotation of the intermediate link 508 relative to the cam member 510. For example, the first stop portion 516 may include an elastomeric stop member 518 arranged to abut the cam member 510; however, other configurations for delimiting rotation of the intermediate link 508 relative to the cam member 510 are contemplated. With continued reference to FIG. 36, the coupling link 502 may include a second stop portion 520 configured to abut the intermediate link 508 to delimit rotation of the coupling link 502 relative to the intermediate link 508. Furthermore, the coupling link 502 may further include a third stop portion 521 configured to abut the axle assembly 306 to delimit rotation of the coupling link 502 relative to the axle assembly 306.

With continued reference to FIGS. 32 through 37, the auxiliary wheel assembly 300 may further include a roller arm 522 extending between a first roller arm end portion 522A operatively attached to the base 34 for pivotal movement relative to the base 34, and a second roller arm end portion 522B. The roller arm 522 may include a roller 524 arranged to abut the cam member 510 and rotate to allow the cam assembly 500 to move between the plurality of cam positions. For example, the roller 524 may be arranged between the first roller arm end portion 522A and the second roller arm end portion 522B. The auxiliary wheel assembly 300 may also include a roller arm biasing member 526 extending between one of the first roller arm end portion 522A and the second roller arm end portion 522B, and the axle assembly 306 to urge the roller 524 against the cam member 510 and urge the axle assembly 306 upward to move the auxiliary wheel(s) 302 toward the stowed position 302S. The roller arm biasing member 526 illustrated in FIGS. 32 through 37 is realized as a spring; however, other configurations of urging the roller 524 against the cam member 510 and urging the axle assembly 306 upward to move the auxiliary wheel(s) 302 toward the stowed position 302S are contemplated, including struts, gas springs and the like.

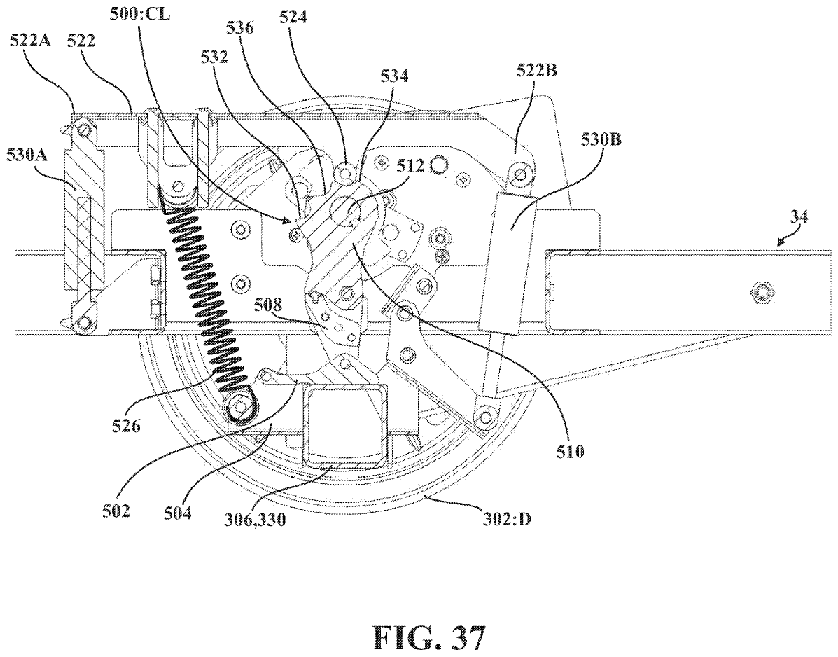

Referring to FIG. 36, the auxiliary wheel assembly 300 may also further include a cam damper 528 extending between the cam member 510 and the base 34 to dampen motion of the cam member 510 relative to the base 34. Accordingly, by damping motion of the cam member 510 relative to the base 34, mechanical shock during movement of the axle assembly 306 and/or the linkage 66 is reduced. Other configurations of limiting mechanical shock during movement of the axle assembly 306 and/or the linkage 66 are contemplated. FIG. 37 shows another exemplary arrangement including a first roller arm damper 530A extending between the first roller arm end portion 522A and the base 34 to couple the first roller arm end portion 522A to the base 34 and to dampen motion of the roller arm 522 relative to the cam member 510 and/or the base 34. The arrangement of FIG. 37 may further include a second roller arm damper 530B extending between the second roller arm end portion 522B and the axle assembly 306 to dampen motion of the roller arm 522 relative to the axle assembly 306 and/or the cam member 510.

As best shown in FIGS. 36 and 37, the cam member 510 may define a plurality of detents configured to engage the roller 524 to hold the cam assembly 500 in a corresponding cam position. For example, the plurality of detents of the cam member 510 may define rounded recesses arranged to at least partially receive the roller 524 where the cam assembly 500 is in one of the plurality of cam positions. For example, the plurality of detents of the cam member 510 may include a cam lower detent 532 for holding the cam assembly 500 in the cam lower position CO. The plurality of detents of the cam member 510 may also include a cam lift detent 534 for holding the cam assembly 500 in the cam lift position CL. The plurality of detents may also further include a cam intermediate detent 536 arranged between the cam lower detent 532 and the cam lift detent 534 for holding the cam assembly 500 in a cam intermediate position CI between the cam lift position CL and the cam lower position CO.

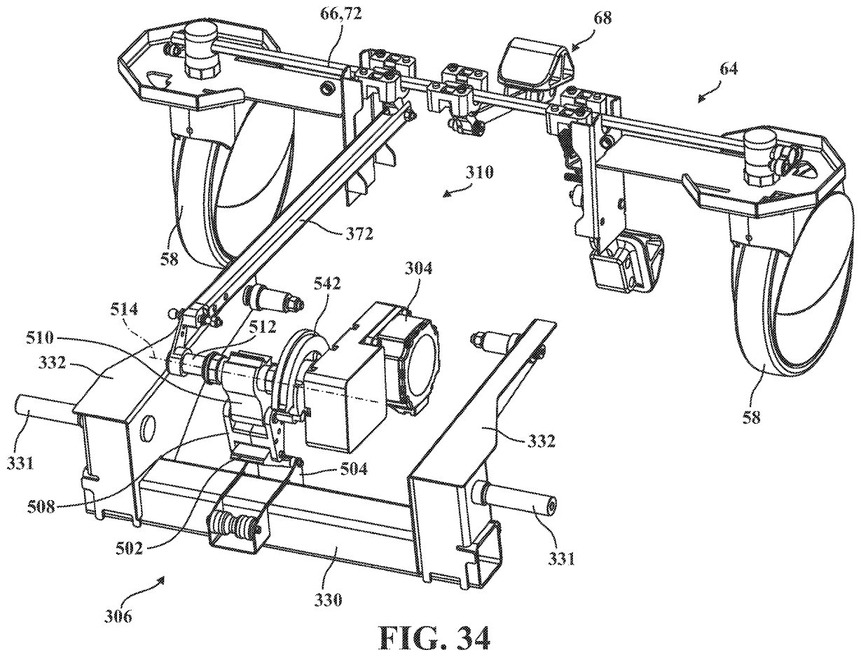

As best shown in FIGS. 32 and 34, the override assembly 310 further includes an override member 372 operatively attached to the linkage 66 of the braking system 64 and the cam member 510 to concurrently move the cam assembly 500 from the cam lift position CL to the cam lower position CO as the linkage 66 moves from the steer state S to the brake state B. For example, the override member 372 may be coupled at a first end 372A to the linkage 66, and at a second end 372B to the override shaft 512 (that supports the cam member 510) such the linkage 66 rotates concurrently with the override shaft 512. Also, in the illustrated configuration, a timing link 578 may extend between the override member and the link 72 at the other end of the patient transport apparatus 30 to ensure that both links 72 rotate concurrently between the steer state S, the neutral state N, and the brake state B. In some examples, the override assembly 310 further includes a linkage damper 538 operatively attached to the linkage 66 (e.g., via the override member 372 or timing link 578) and the base 34 to dampen motion of the linkage 66 and/or the cam assembly 500 relative to the base 34 to further limit mechanical shock, as described above.

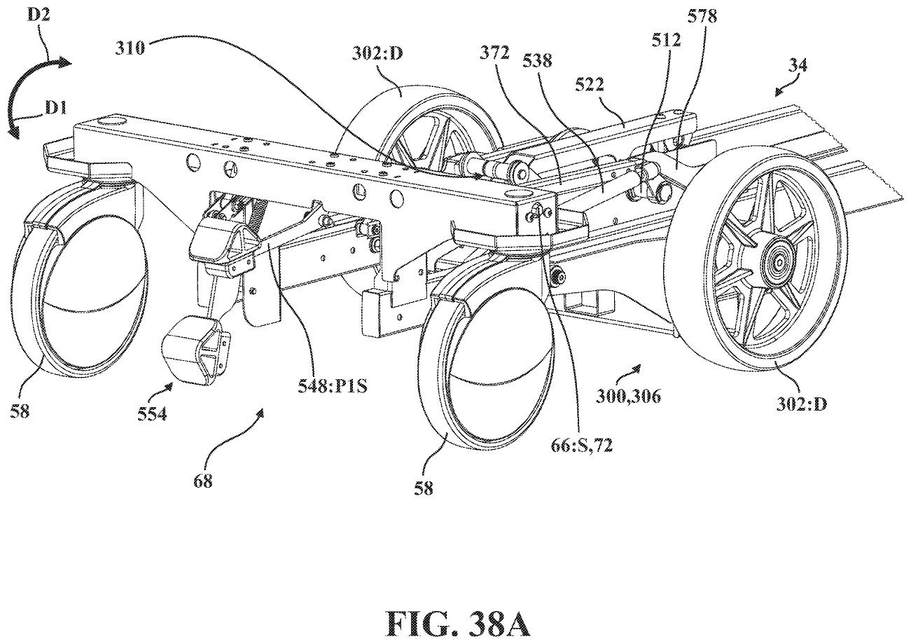

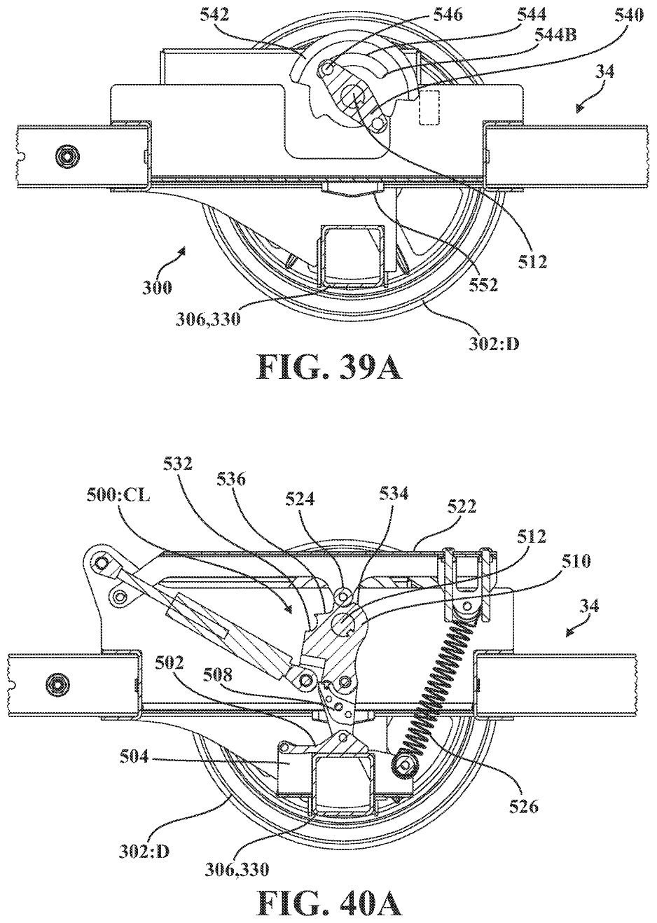

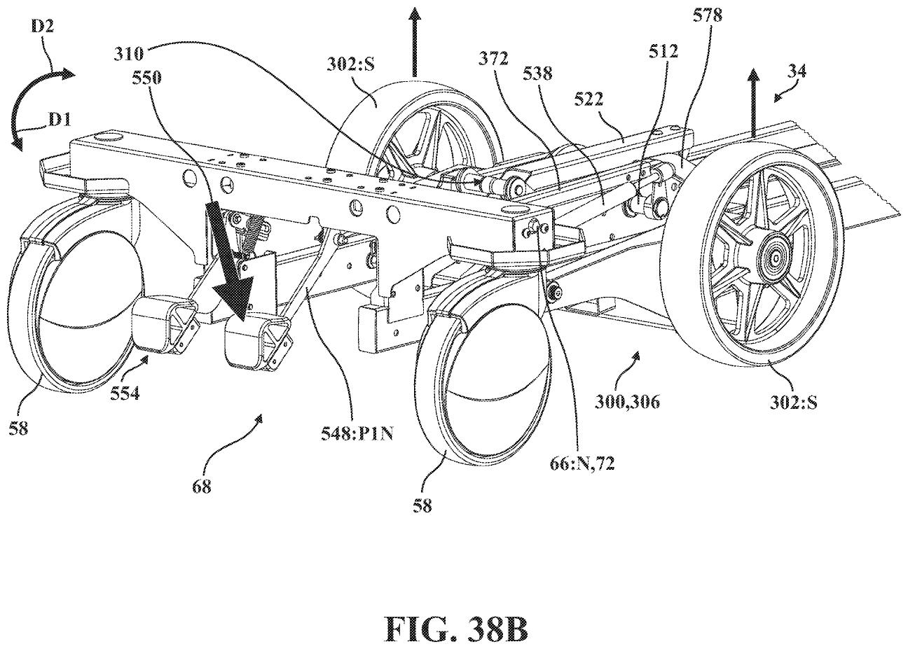

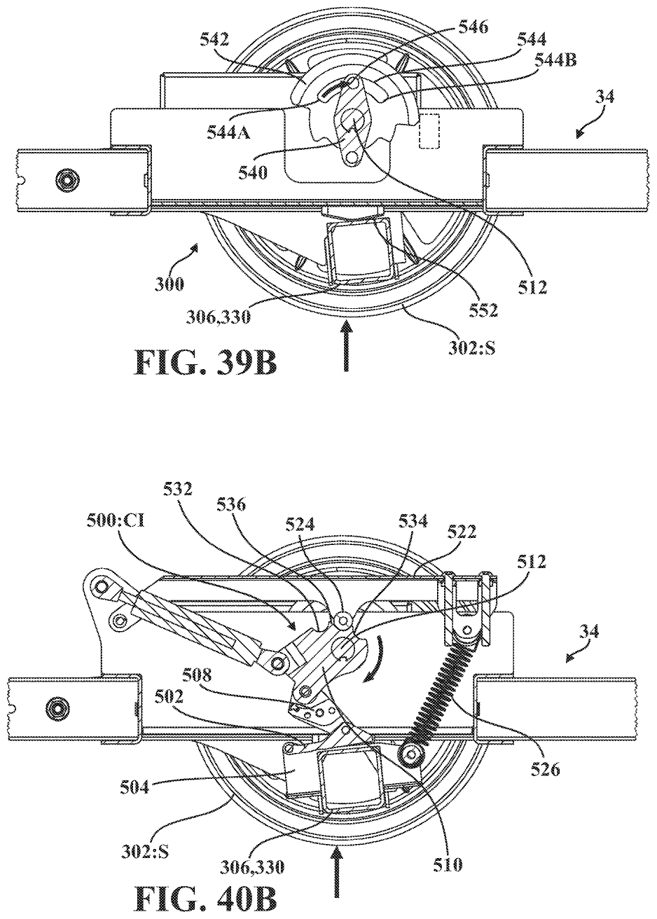

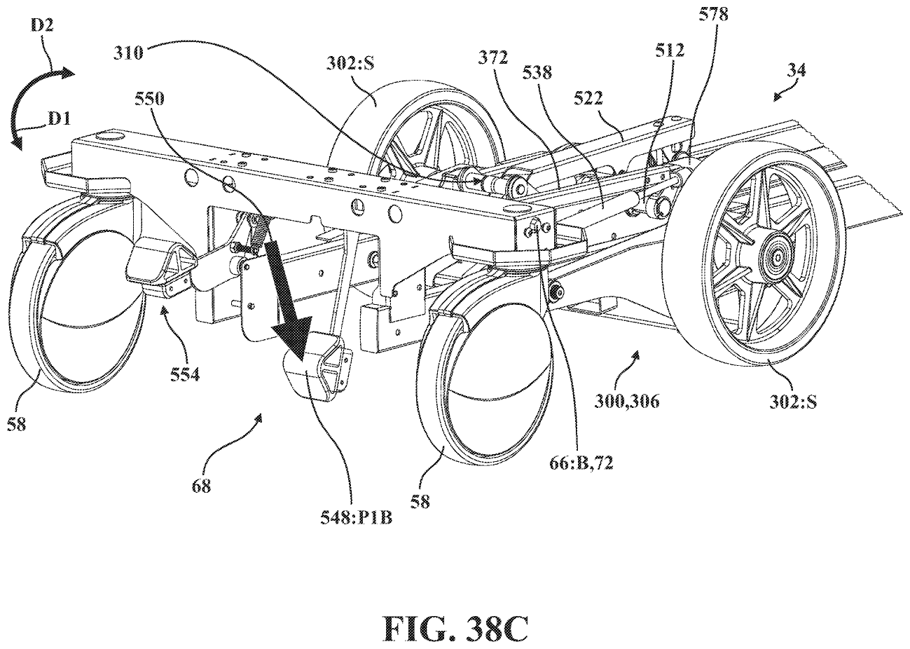

Accordingly, in the present example, when the linkage 66 is in the steer state S, the cam assembly 500 is in the cam lift position CL to move the axle assembly 306 to move the auxiliary wheel 302 to the deployed position 302D. Additionally, when the linkage 66 is in the brake state B, the cam assembly 500 is in the cam lower position CO to move the auxiliary wheel 302 to the stowed position 302S. Furthermore, when the linkage 66 is in the neutral state N, the cam assembly 500 is in the cam intermediate position CI. In these examples, when the cam assembly 500 is in the cam intermediate position CI, the roller arm biasing member 526 urges the axle assembly 306 to move the auxiliary wheel 302 to the stowed position 302S. In other works, when the linkage 66 is in the neutral state N or the brake state B (and thus, the cam assembly 500 is in the cam intermediate position CI or the cam lower position CO), the roller arm biasing member 526 urges the axle assembly 306 to move the auxiliary wheel 302 to the stowed position 302S. Movement of the cam assembly 500 between the plurality of cam positions, and the resulting movement of the axle assembly 306 and the auxiliary wheel 302 are described in further detail below in the context of FIGS. 38A through 50C.

With continued reference to FIGS. 32 through 37, the auxiliary wheel assembly 300 further includes a cam driver 540 operatively attached to the cam member 510 for concurrent rotation with the cam member 510. For example, the cam driver 540 may be coupled to the override shaft 512; however, other configurations are contemplated. As best shown in FIGS. 32 and 34, the actuator 304 may be operatively attached to the cam driver 540 to move the cam assembly 500 between the between the plurality of cam positions (e.g., the cam lower position CO, the cam intermediate position CI, and the cam lift position CL). As described above, the actuator 304 may be configured to generate torque about the actuator axis 390. To operatively attach the actuator 304 to the cam driver 540, the auxiliary wheel assembly 300 may further include an actuator driving member 542 coupled to the actuator for concurrent rotation with the actuator 304 about the actuator axis 390. As described in further detail below, the actuator driving member 542 may define a slot 544 extending between a first slot end 544A and a second slot end 544B. Furthermore, the cam driver 540 may include a projection 546 spaced from the actuator axis 390 and disposed in the slot 544 of the actuator driving member 542 to translate within the slot 544 and abut one of the first slot end 544A and the second slot end 544B to transfer motion from the actuator 304 to the cam member 510 to move the cam assembly 500 between the plurality of cam positions.

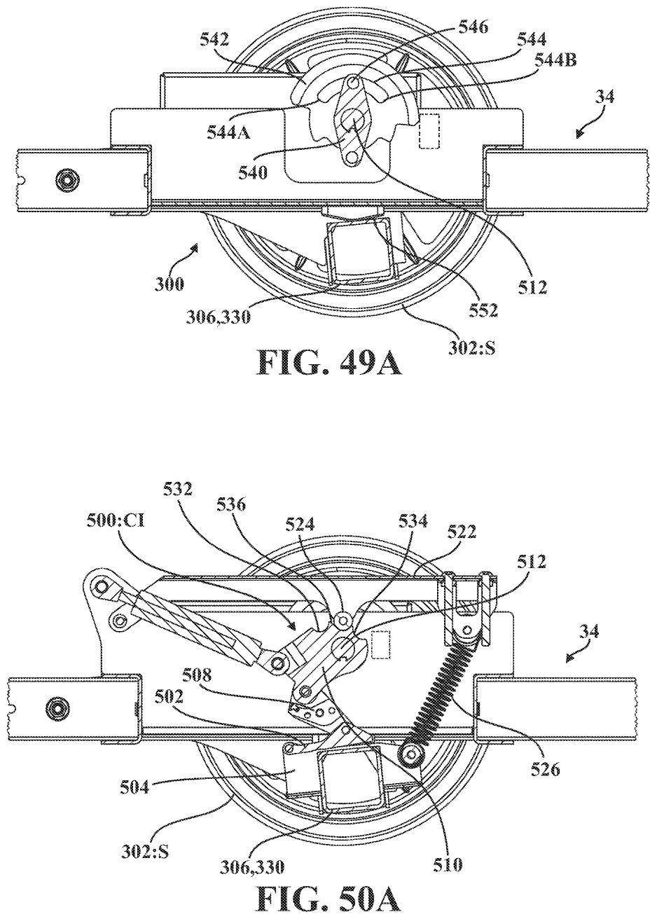

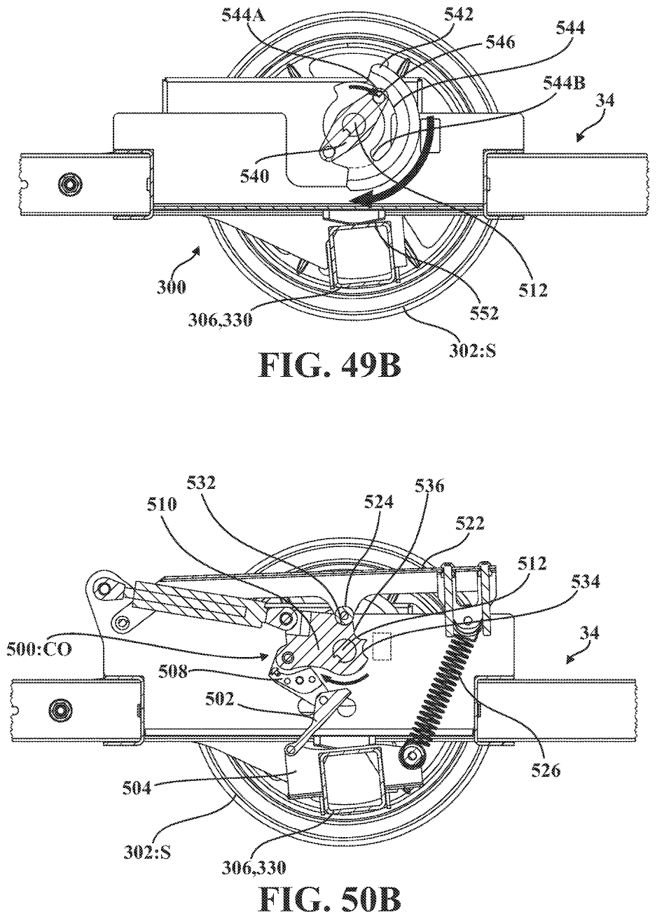

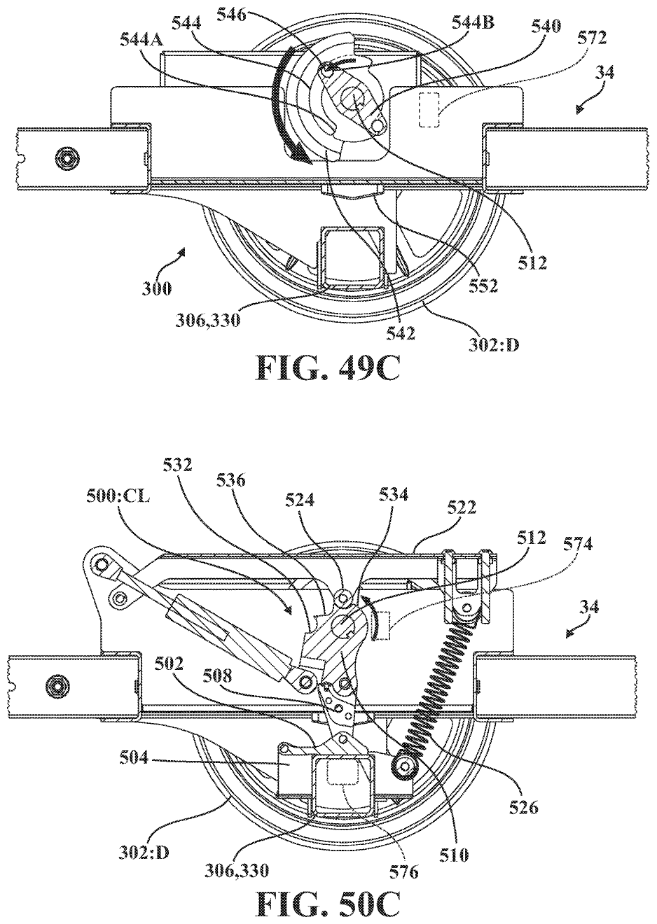

Accordingly, as described in further detail below in the context of FIGS. 49A through 50C, the actuator 304 may be configured to generate torque to rotate the actuator driving member 542 to abut the projection 546 of the cam driver 540 against the first slot end 544A to concurrently rotate the actuator driving member 542 and the cam driver 540 to move cam member 510 to move the cam assembly 500 to the cam lift position CL and the linkage 66 to the steer state S. Likewise, the actuator 304 may be configured to generate torque to rotate the actuator driving member 542 to abut the projection 546 of the cam driver 540 against the second slot end 544B to concurrently rotate the actuator driving member 542 and the cam driver 540 to move the cam member 510 to move the cam assembly 500 toward the cam lower position CO and the linkage 66 to one of the neutral state N and the brake state B.

Referring to FIGS. 38A, 38B and 38C, in the present example, the brake input device 68 includes a first pedal 548 coupled to the linkage 66 (e.g., the link 72) of the braking system 64 for concurrent movement with the linkage 66. In these examples, the first pedal 548 is arranged for user engagement to move the linkage 66 of the braking system 64 in a first direction D1 between a first pedal steer position P1S, a first pedal neutral position P1N, and a first pedal brake position P1B. In the first pedal steer position P1S (shown in FIG. 38A) the linkage 66 is in the steer state S. In the first pedal neutral position P1N (shown in FIG. 38B) the linkage 66 is in the neutral state N. In the first pedal brake position P1B (shown in FIG. 38C), the linkage 66 is in the brake state B.

As described above, the override assembly 310 is configured to lift the one or more auxiliary wheels 302 to at least partially disengage the one or more auxiliary wheels 302 from the floor surface FS in response to movement of the linkage 66 of the brake system 64 from the steer state S to one of the neutral state N and the brake state B. Accordingly, the weight of the patient transport apparatus 30 will be transferred off of the auxiliary wheels 302 and to the wheels 58 such that the brakes 62 of the wheels 58 may inhibit movement of the base 34 along the floor surface FS, and such that any lifting of the wheels 58 via the auxiliary wheels 302 (particularly when the linkage 66 is in the steer state S) is inhibited. FIGS. 38A through 40C illustrate operation of the override assembly 310 to move the auxiliary wheel 302 from the deployed position 302D to the stowed position 302S as the linkage 66 of the brake system 64 moves from the steer state S, through the neutral state N, and ultimately to the brake state B.

FIGS. 38A, 39A, and 40A illustrate operation of patient transport apparatus 30 of the present example with the auxiliary wheel 302 in the deployed position 302D. As best shown in FIG. 38A, here, the first pedal 548 is in the first pedal steer state P1S such that the linkage 66 is arranged in the steer state S, and, thus, the override member 372 (moving concurrently with the linkage 66 and the override shaft 512) arranges the cam member 510 to place the cam assembly 500 in the cam lift position CL. Accordingly, the coupling link 502 and the intermediate link 508 of the cam assembly 500 are arranged in an expanded configuration relative to each other such that the coupling link 502 abuts the axle assembly 306 to urge the auxiliary wheel 302 to the deployed position 302D.

FIGS. 38B, 39B, and 40B illustrate user engagement with the first pedal 548 (indicated with arow 550) to move the linkage 66 in the first direction D1 (i.e., toward the brake state B). Here, the user engagement 550 with the first pedal 548 moves the first pedal 548 to the first pedal neutral state P1N such that the linkage 66 moves to the neutral state N, and thus the override member 372 (moving concurrently with the linkage 66 and the override shaft 512) arranges the cam member 510 to place the cam assembly 500 in the cam intermediate position CI. Accordingly, as best shown in FIG. 40B, the roller arm biasing member 526 urges the axle assembly 306 upward to move the auxiliary wheel 302 to the stowed position 302S. Particularly, the coupling link 502 and the intermediate link 508 move relative to each other into a retracted configuration to permit movement of the axle assembly 306 upward. Also, referring to FIG. 39B, as the override shaft 512 rotates to move the cam assembly 500 to the cam intermediate position CI, the cam driver 540 also rotates. As shown in FIG. 39B, during the illustrated movement, the projection 546 of the cam driver 540 orbits about the actuator axis 390 and within the slot 544 of the actuator driving member 542 such that the projection 546 does not abut either of the first slot end 544A and the second slot end 544B, and thus, operation of the override assembly 310 does not back drive the actuator 304.

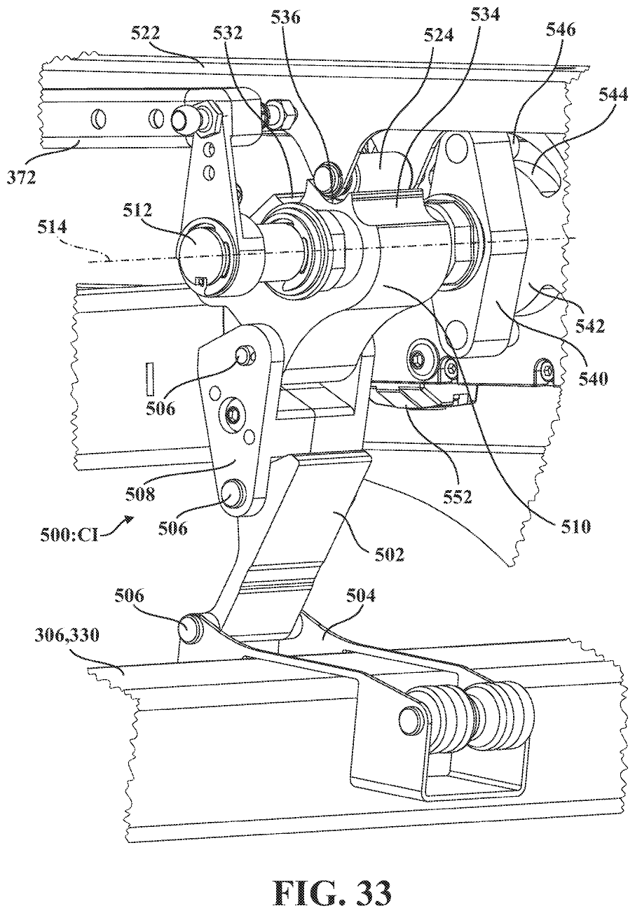

Further, as best shown in FIGS. 33, 39A, 39B, and 39C, the patient transport apparatus 30 may further include a stop member 552 disposed on one of the base 34 and the axle assembly 306. The stop member 552 may be arranged to abut the other of the base 34 and the axle assembly 306 to delimit motion of the axle assembly 306 toward the base 34 where the auxiliary wheel 302 is in the stowed position 302S.

FIGS. 38C, 39C, and 40C illustrate further user engagement with the first pedal 548 (indicated with arow 550) to move the linkage 66 in the first direction D1 (i.e., toward the brake state B). Here, the further user engagement 550 with the first pedal 548 moves the first pedal 548 to the first pedal brake state P1B such that the linkage 66 moves to the brake state B, and thus the override member 372 (moving concurrently with the linkage 66 and the override shaft 512) arranges the cam member 510 to place the cam assembly 500 in the cam lower position CO. Here, as best shown in FIG. 40C, the roller arm biasing member 526 continues to urge the axle assembly 306 upward to retain auxiliary wheel 302 in the stowed position 302S. Also, referring to FIG. 39C, as the override shaft 512 continues to rotate to move the cam assembly 500 to the cam lower position CO, the cam driver 540 also continues to rotate. As shown in FIG. 39C, during the illustrated movement, the projection 546 of the cam driver 540 continues to orbit about the actuator axis 390 and within the slot 544 of the actuator driving member 542 such that the projection 546 does not abut either of the first slot end 544A and the second slot end 544B, and thus, operation of the override assembly 310 does not back drive the actuator 304.

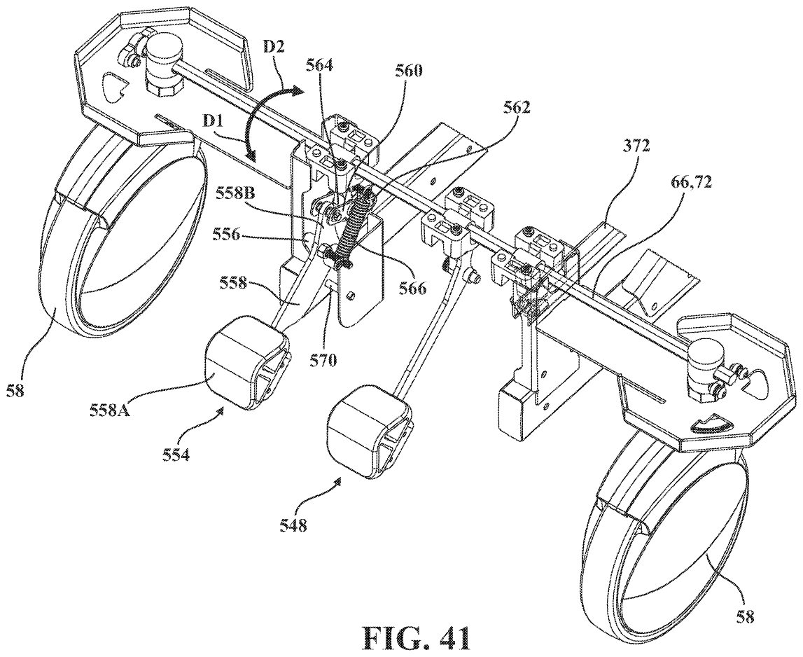

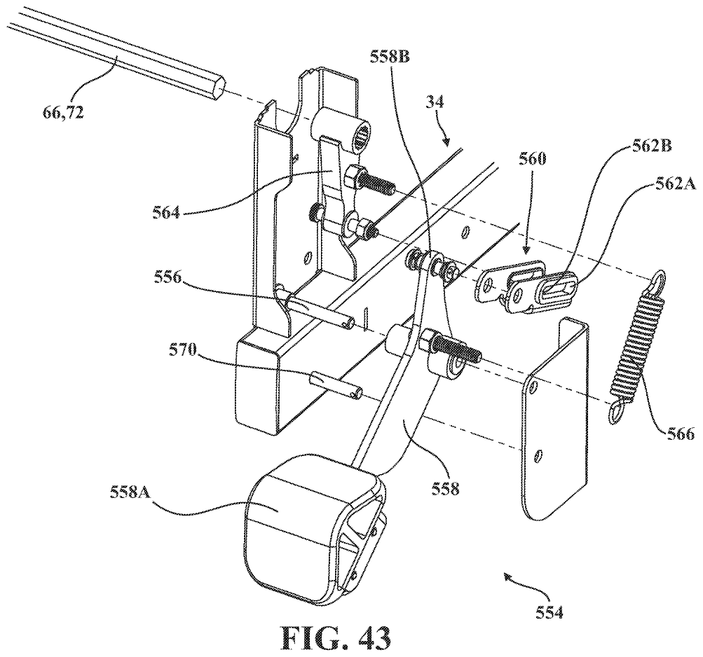

It may also be desirable to move the linkage 66 of the braking system 64 from the brake state B to the neutral state N to permit the wheels 58 to roll relative to the floor surface FS. Accordingly, referring to FIGS. 41 through 43, the brake input device 68 may also include second pedal assembly 554 coupled to the linkage 66 of the braking system 64. The second pedal assembly 554 may be arranged for user engagement to move the linkage 66 of the braking system 64 in a second direction D2, opposite the first direction D1. For example, the second pedal assembly 554 may include a second pedal mount 556 extending from the base 34, and a second pedal 558 extending between a second pedal interface 558A arranged for user engagement and a second pedal connection end 558B. The second pedal 558 may be mounted to the second pedal mount 556 between the second pedal interface 558A and the second pedal connection end 558B and supported for rotation relative to the second pedal mount 556. The second pedal assembly 554 may also include a second pedal drive link 560 coupled to the second pedal connection end 558B for rotation relative to the second pedal connection end 558B. As best shown in FIG. 43, the second pedal drive link 560 may define a second pedal drive link slot 562 extending between a first pedal slot end 562A and a second pedal slot end 562B. Here, the linkage 66 of the braking system 64 may include a linkage projection 564 disposed within the second pedal drive link slot 562 for movement within the second pedal drive link slot 562, thereby slidably coupling the second pedal 558 to the linkage 66. Accordingly, in response to user engagement with the second pedal interface 558A, the first pedal slot end 562A is configured to abut the linkage projection 564 to transfer motion from the second pedal 558 to the linkage 66 of the braking system 64 to move the linkage 66 in the second direction D2. Additionally, the brake input device 68 may further include a second pedal biasing member 566 configured to urge the second pedal interface 558A upward to abut the second pedal slot end 562B against the linkage projection 564 in the absence of user engagement with the second pedal interface 558A.

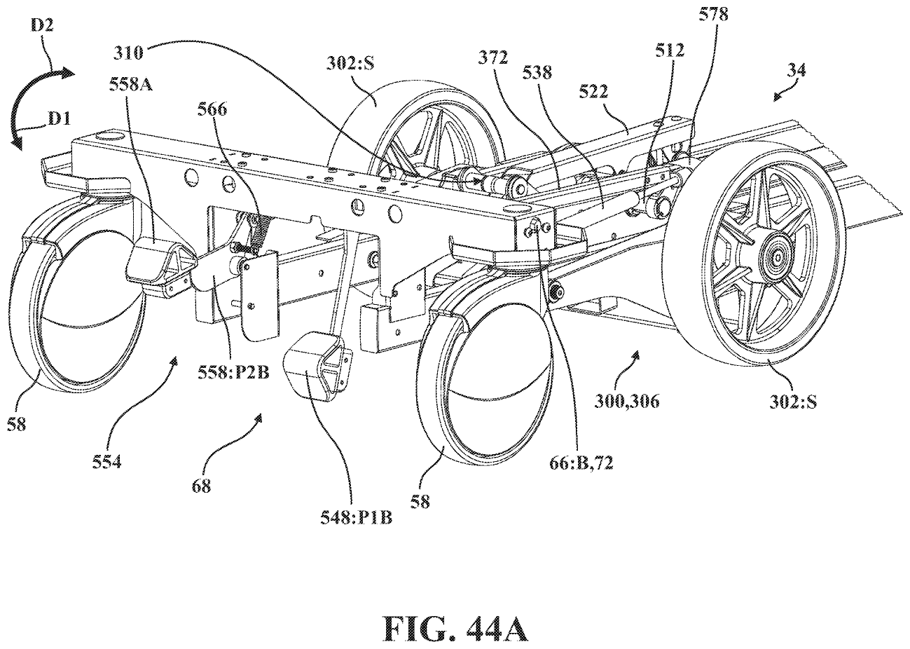

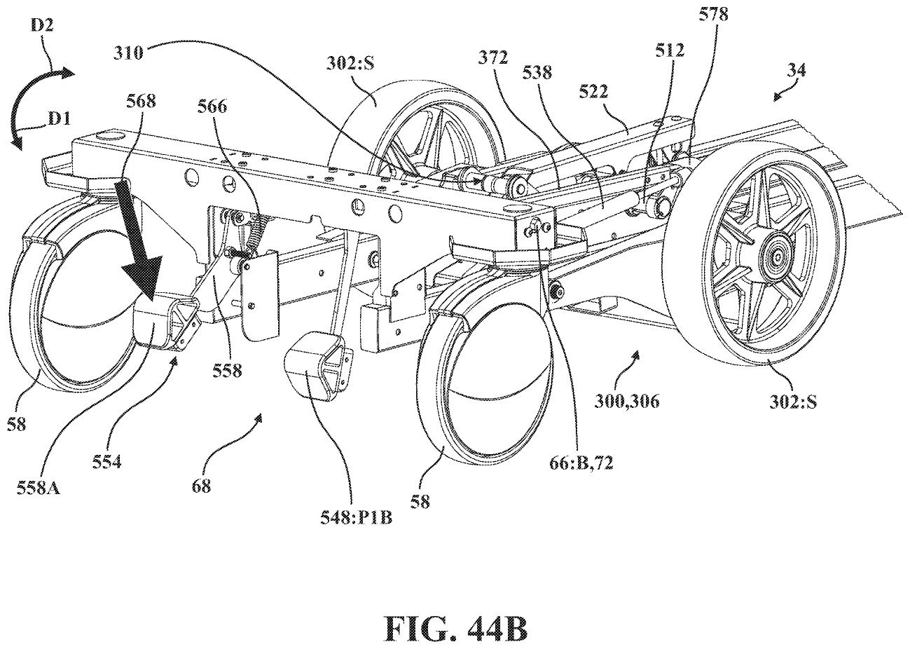

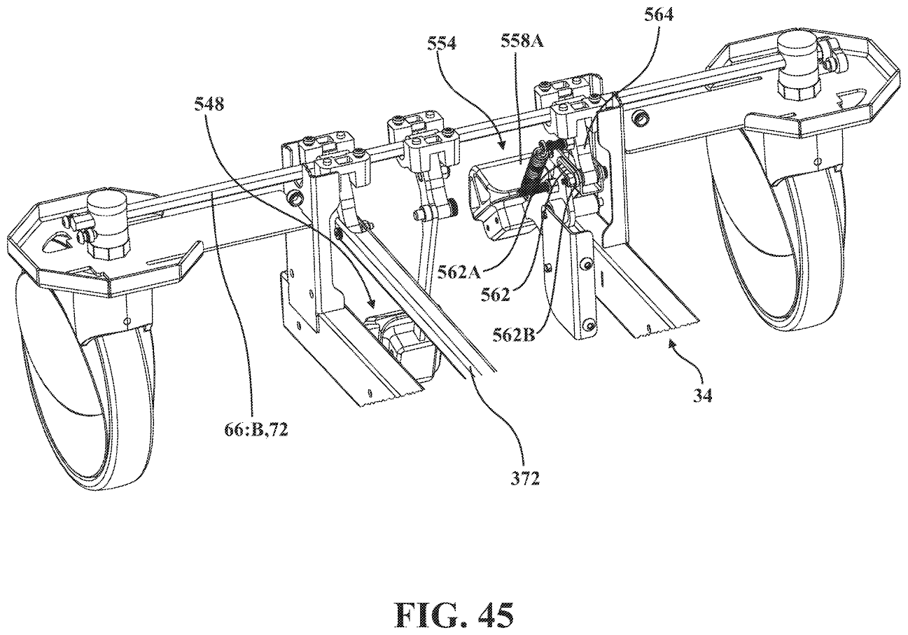

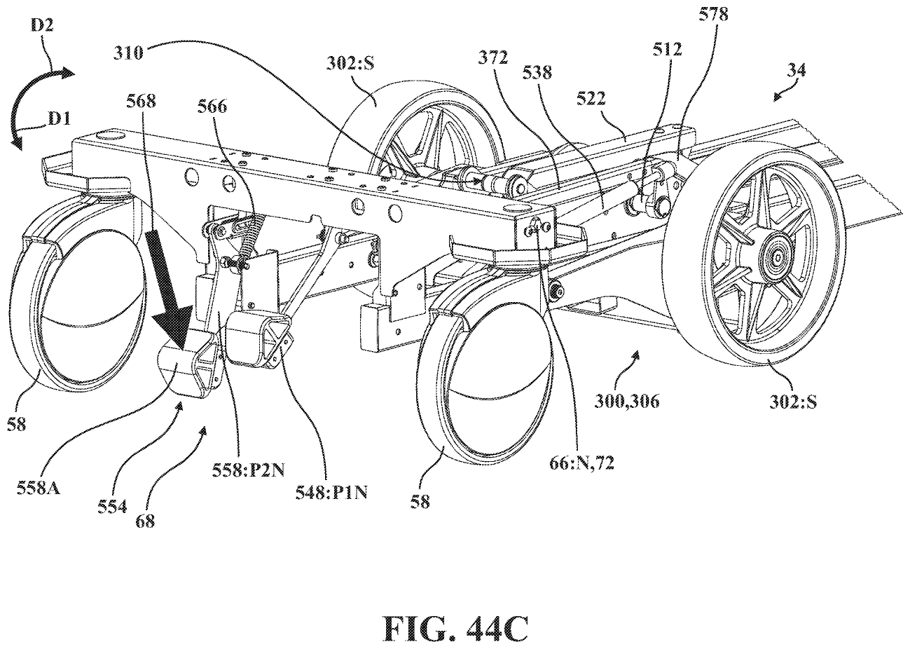

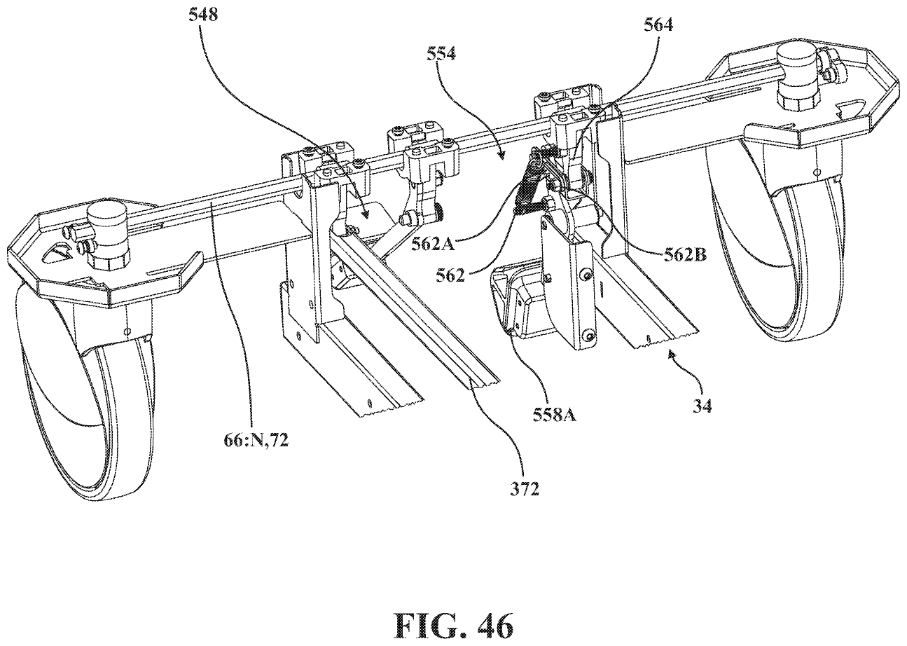

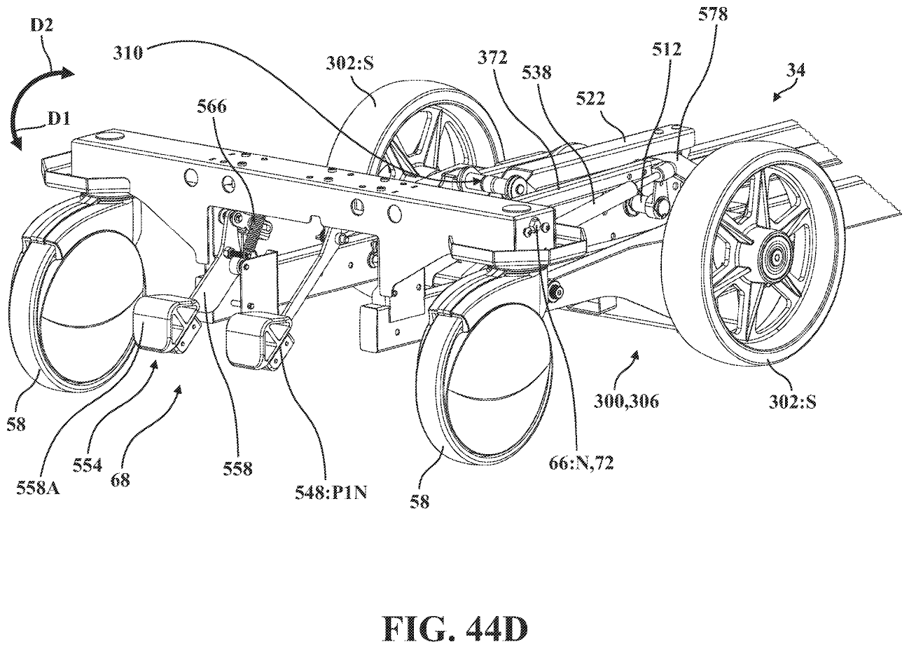

FIGS. 44A through 48 illustrate operation of the second pedal assembly 554 to move the linkage 66 of the braking system 64 from the brake state B to the neutral state N. Referring to FIG. 44A, where the linkage 66 of the braking system 64 is in the brake state B, the second pedal interface 558A is in a second pedal brake position P2B. In the second pedal brake position P2B, the second pedal interface 558A is arranged for user engagement. Referring to FIGS. 44B and 45, in response to user engagement with the second pedal interface 558A (indicated by arrow 568), the second pedal 558 is configured to move the second pedal drive link 560 such that the first pedal slot end 562A abuts the linkage projection 564. Referring next to FIGS. 44C and 46, in response to further user engagement with the second pedal interface 558A (indicated by arrow 568) to a second pedal neutral position P2N, the second pedal 558 and the second pedal drive link 560 are configured to move the linkage 66 of the braking system 64 in the second direction D2 such that the linkage 66 of the braking system 64 moves from the brake state B to the neutral state N. Referring lastly to FIG. 44D, once the second pedal 558 and the second pedal drive link 560 move the linkage 66 of the braking system 64 to the brake state B (i.e., once there is an absence of user engagement with the second pedal interface 558A), the second pedal biasing member 566 may be configured to urge the second pedal interface 558A upward to abut the second pedal slot end 562B against the linkage projection 564. In some examples, further rotation of the second pedal 558 beyond the rotation shown in FIG. 44C is prevented to inhibit a user from manually moving the linkage 66 into the steer state S. For example, the second pedal assembly 554 may include a pedal stop 570 extending base 34 to prevent further rotation of the second pedal 558. Inhibiting a user from manually moving the linkage 66 into the steer state S is advantageous because it may be difficult for a user to generate sufficient toque to move the one or more auxiliary wheels 302 to the deployed position 302D.

Referring next to FIGS. 49A through 50C, as described above, the actuator 304 may be configured to generate torque to rotate the actuator driving member 542 to abut the projection 546 of the cam driver 540 against the one of the first slot end 544A and the second slot end 544B to concurrently rotate the actuator driving member 542 and the cam driver 540 to move cam member 510 to move the cam assembly 500 between the plurality of cam positions, and, as a result, move the linkage 66 of the braking assembly between the steer state S, the neutral state N, and the brake state B. Thus, advantageously, in this configuration, the need for a separate electronic braking assembly 70 is eliminated, as the actuator 304 in combination with the components described herein in the context of this example are capable of moving the braking system between the braked state and the released state.

Additionally, in some versions, the slot 544 of the actuator driving member 542 extends between the first slot end 544A and the second slot end 544B about an arc. The arc may be shaped to permit translation of the projection 546 within the slot 544 without abutting the first slot end 544A and/or the second slot end 544B in response to movement of the cam member 510 due to operation of the override assembly 310, as described above. Additionally, in some versions, such as shown in FIGS. 49A and 50A, actuator 304 is configured to move the actuator driving member 542 to a home position PH after moving the cam member 510 to prevent the projection 546 from abutting one of the first slot end 544A and the second slot end 544B in response movement of the cam member 510 due to operation of the override assembly 310.

For example, FIGS. 49A and 50A show the actuator driving member 542 in the home position PH and the cam assembly 500 in the cam intermediate position CI, (and, thus, the linkage 66 of the braking system 64 in the neutral state N). Referring to FIGS. 49B and 50B, the actuator 304 may be configured to generate torque to rotate the actuator driving member 542 to abut the projection 546 of the cam driver 540 against the second slot end 544B to concurrently rotate the actuator driving member 542 and the cam driver 540 to move the cam member 510 to move the cam assembly 500 toward the cam lower position CO (and, thus, the linkage 66 to the brake state B). Likewise, referring to FIGS. 49C and 50C, the actuator 304 may also be configured to generate torque to rotate the actuator driving member 542 to abut the projection 546 of the cam driver 540 against the first slot end 544A to concurrently rotate the actuator driving member 542 and the cam driver 540 to move cam member 510 to move the cam assembly 500 to the cam lift position CL (and, thus, the linkage 66 of the braking system 64 to the steer state S). It should also be appreciated that the actuator 304 may be configured to rotate the actuator driving member 542 in the necessary direction to move the cam assembly 500 to the cam intermediate position CI (between the cam lower position CO and the cam lift position CL) and thus move the linkage 66 to the neutral state N. It should further be appreciate that after each operation of the actuator 304 to move the cam assembly 500 and the linkage 66 of the braking system 64, the actuator 304 may be configured to move the actuator driving member 542 back to the home position PH to prevent the projection from abutting one of the first slot end 544A and the second slot end 544B in response to movement of the cam member 510 due to operation of the override assembly 310.

Additionally, in some configurations, it may be desirable to know the angular position of the actuator driving member 542 and/or the override shaft 512 (and, thus, the cam member 510) to inform operation of the actuator 304. Accordingly, in some versions, the override assembly 310 may include an actuator driving member position sensor 572 (illustrated schematically in FIG. 49A) arranged to detect the angular position of the actuator driving member 542 and communicate with a controller of the patient transport apparatus 30 to operate the actuator 304 based on the sensed position of the actuator driving member 542. The actuator driving member position sensor 572 may be realized as an angular encoder, limit switches, or where the actuator 304 is a brushless electric motor, by counting pulses of the motor. The angular position of the actuator driving member 542 may also be ascertained relative to the angular position of the override shaft 512. Of course, other configurations of the actuator driving member position sensor 572 for ascertaining the angular position of the actuator driving member 542 are contemplated. Similarly, the override assembly 310 may additionally or alternatively include an cam member position sensor 574 (illustrated schematically in FIG. 50A) arranged to detect the angular position of the override shaft 512 (and, thus, the angular position of the cam member 510 and the linkage 66 of the braking system 64) and communicate with a controller of the patient transport apparatus 30 to operate the actuator 304 based on the sensed position of the override shaft 512. The cam member position sensor 574 may be realized as an angular encoder, limit switches, or the like. The angular position of the override shaft may also be ascertained relative to the angular position of the actuator driving member 542. Of course, other configurations of the cam member position sensor 574 for ascertaining the angular position of the override shaft 512 are contemplated. Also, in some versions, the axle assembly 306 may include an object collision sensor 576 arranged to detect premature contact of the coupling link 502 with the axle assembly 306 when moving the auxiliary wheel 302 to the deployed position 302D due to a foreign object (e.g., a caretaker's foot) being below the auxiliary wheel 302. The object collision sensor 576 may be, for example, a limit switch or the like. The object collision sensor 576 may be configured to communicate with a controller of the patient transport apparatus 30 to terminate operation of the actuator 304 in the event a premature collision with a foreign object is detected.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The present disclosure also comprises the following clauses, with specific features laid out in dependent clauses, that may specifically be implemented as described in greater detail with reference to the configurations and drawings above.

### CLAUSES

I. A patient transport apparatus, the patient transport apparatus comprising:
   a support structure including a base and a patient support deck;
   a plurality of wheels coupled to the base for supporting movement of the patient transport apparatus over a floor surface;
   a braking system including a linkage coupled to one or more of the plurality of wheels, the braking system operable between:
      a braked state to inhibit movement of the base along the floor surface, and
      a released state;
   a brake input device in communication with the linkage and arranged for user engagement to change operation of the braking system between the braked state and the released state, wherein the linkage is in a brake state where the braking system is in the braked state, and the brake input device is further configured to move the linkage between a neutral state and a steer state where the braking system is in the released state;
   an auxiliary wheel assembly including an auxiliary wheel, an axle assembly supporting the auxiliary wheel, the axle assembly coupled to the base for pivoting movement relative to the base, and an actuator configured to move the axle assembly and the auxiliary wheel between a plurality of auxiliary support positions including:
      a deployed position where the auxiliary wheel engages the floor surface to at least partially support movement of the patient transport apparatus over the floor surface, and
      a stowed position where the auxiliary wheel is spaced from the floor surface; and
   an override assembly coupled to the linkage of the braking system and to the auxiliary wheel assembly to move the auxiliary wheel from the deployed position to the stowed position in response to movement of the linkage from the steer state to one of the neutral state and the brake state to at least partially disengage the auxiliary wheel from the floor surface.
II. The patient transport apparatus of clause I, wherein the override assembly further comprises a cam assembly operatively attached to the axle assembly to move the axle assembly relative to the base, the cam assembly configured to move between a plurality of cam positions including:
   a cam lower position where the auxiliary wheel is in the stowed position, and
   a cam lift position where the cam assembly moves the auxiliary wheel to the deployed position.
III. The patient transport apparatus of clause II, wherein the cam assembly comprises a coupling link operatively attached to the axle assembly, an intermediate link coupled to the coupling link for pivotal movement relative to the coupling link, and a cam member coupled to the intermediate link, wherein the coupling link and the intermediate link are configured to pivot relative to each other in response to rotation of the cam member to expand the cam assembly between the cam lower position and the cam lift position.
IV. The patient transport apparatus of clause III, wherein the auxiliary wheel assembly further comprises a roller arm extending between a first roller arm end portion operatively attached to the base for pivotal movement relative to the base, and a second roller arm end portion, the roller arm including a roller arranged to abut the cam member and rotate to allow the cam assembly to move between the cam lower position and the cam lift position.
V. The patient transport apparatus of clause IV, wherein the auxiliary wheel assembly further comprises a roller arm biasing member extending between one of the first roller arm end portion and the second roller arm end portion, and the axle assembly to urge the roller against the cam member and urge the axle assembly to move the auxiliary wheel toward the stowed position.
VI. The patient transport apparatus of clause V, wherein the auxiliary wheel assembly further comprises a cam damper extending between the cam member and the base to dampen motion of the cam member relative to the base.
VII. The patient transport apparatus of any one of clauses V or VI, wherein the cam member defines a plurality of detents configured to engage the roller to hold the cam assembly in a corresponding cam position, the plurality of detents including:
   a cam lower detent for holding the cam assembly in the cam lower position; and
   a cam lift detent for holding the cam assembly in the cam lift position.
VIII. The patient transport apparatus of clause VII, wherein the plurality of detents further includes a cam intermediate detent arranged between the cam lower detent and the cam lift detent for holding the cam assembly in a cam intermediate position between the cam lift position and the cam lower position.
IX. The patient transport apparatus of clause VIII, wherein when the cam assembly is in the cam intermediate position, the roller arm biasing member urges the axle assembly to move the auxiliary wheel to the stowed position.
X. The patient transport apparatus of clause IX, wherein override assembly further comprises an override member operatively attached to the linkage of the braking system and the cam member to concurrently move the cam assembly between the cam lift position and the cam lower position as the linkage moves between the steer state and the brake state.
XI. The patient transport apparatus of clause X, wherein override assembly further comprises a linkage damper operatively attached to the linkage and the base to dampen motion of the linkage relative to the base.
XII. The patient transport apparatus of any one of clauses X or XI, wherein the auxiliary wheel assembly further comprises a cam driver coupled to the cam member for concurrent rotation with the cam member.
XIII. The patient transport apparatus of clause XII, wherein the actuator is operatively attached to the cam driver to move the cam assembly between the plurality of cam positions.
XIV. The patient transport apparatus of clause XIII, wherein:
   the actuator is configured to generate torque about an actuator axis;
   the auxiliary wheel assembly further comprises an actuator driving member coupled to the actuator for concurrent rotation with the actuator about the actuator axis, the actuator driving member defining a slot extending between a first slot end and a second slot end; and
   the cam driver includes a projection spaced from the actuator axis and disposed in the slot of the actuator driving member to translate within the slot and abut one of the first slot end and the second slot end to transfer motion from the actuator to the cam member to move the cam assembly between plurality of cam positions.
XV. The patient transport apparatus of clause XIV, wherein the actuator is configured to generate torque to rotate the actuator driving member to abut the projection of the cam driver against the first slot end to concurrently rotate the actuator driving member and the cam driver to move the cam member to move the cam assembly to the cam lift position and the linkage to the steer state, and
   wherein the actuator is configured to generate torque to rotate the actuator driving member to abut the projection of the cam driver against the second slot end to concurrently rotate the actuator driving member and the cam driver to move the cam member to move the cam assembly toward the cam lower position and the linkage to one of the neutral state and the brake state.
XVI. The patient transport apparatus of clause XV, wherein the slot of the actuator driving member extends between the first slot end and the second slot end about an arc, the arc being shaped to permit translation of the projection within the slot without abutting one of the first slot end and the second slot end in response to movement of the cam member due to operation of the override assembly.
XVII. The patient transport apparatus of clause XVI, wherein the actuator is configured to move the actuator driving member to a home position after moving the cam member to prevent the projection from abutting one of the first slot end and the second slot end in response to movement of the cam member due to operation of the override assembly.
XVIII. The patient transport apparatus of any one of clauses XVI or XVII, wherein the override assembly further includes an actuator driving member position sensor arranged to detect the angular position of the actuator driving member, and the patient transport apparatus is configured to operate the actuator based on the sensed position of the actuator driving member.
XIX. The patient transport apparatus of any one of clauses XVI to XVIII, wherein the override assembly further includes a cam member position sensor arranged to detect the angular position of the cam member, and the patient transport apparatus is configured to operate the actuator based on the sensed position of the cam member.
XX. The patient transport apparatus of any one of clauses XVI to XIX, wherein the brake input device further comprises a first pedal coupled to the linkage of the braking system for concurrent movement with the linkage, the first pedal arranged for user engagement to move the linkage of the braking system in a first direction between:
   a first pedal steer position where the linkage is in the steer state;
   a first pedal neutral position where the first pedal moves the linkage in the first direction to the neutral state; and
   a first pedal brake position where the first pedal moves the linkage in the first direction to the brake state.
XXI. The patient transport apparatus of clause XX, further comprising a second pedal assembly coupled to the linkage of the braking system and arranged for user engagement to move the linkage of the braking system in a second direction, opposite the first direction.
XXII. The patient transport apparatus of clause XXI, wherein the second pedal assembly comprises:
   a second pedal mount extending from the base;
   a second pedal extending between a second pedal interface arranged for user engagement and a second pedal connection end, wherein the second pedal is mounted to the second pedal mount between the second pedal interface and the second pedal connection end and supported for rotation relative to the second pedal mount; and
   a second pedal drive link coupled to the second pedal connection end for rotation relative to the second pedal connection end, the second pedal drive link defining a second pedal drive link slot extending between a first pedal slot end and a second pedal slot end, wherein the linkage of the braking system includes a linkage projection disposed within the second pedal drive link slot for movement within the second pedal drive link slot, wherein, in response to user engagement with the second pedal interface, the first pedal slot end is configured to abut the linkage projection to transfer motion from the second pedal to the linkage of the braking system to move the linkage in the second direction.
XXIII. The patient transport apparatus of clause XXII, wherein the brake input device further comprises a second pedal biasing member configured to urge the second pedal interface upward to abut the second pedal slot end against the linkage projection in the absence of user engagement with the second pedal interface.
XXIV. The patient transport apparatus of clause XXIII, wherein where the linkage is in the brake state, the second pedal interface is in a second pedal brake position and arranged for user engagement to move the second pedal drive link such that the first pedal slot end abuts the linkage projection to move the linkage in the second direction from the brake state to the neutral state.
XXV. A patient transport apparatus, the patient transport apparatus comprising:
   a support structure including a base and a patient support deck;
   a plurality of wheels coupled to the base for supporting movement of the patient transport apparatus over a floor surface;
   a braking system including a linkage coupled to one or more of the plurality of wheels, the braking system operable between:
      a braked state to inhibit movement of the base along the floor surface, and
      a released state;
   a brake input device in communication with the linkage and arranged for user engagement to change operation of the braking system between the braked state and the released state;
   an auxiliary wheel assembly coupled to the support structure and including an auxiliary wheel and an actuator configured to move the auxiliary wheel between a plurality of auxiliary support positions including:
      a deployed position where the auxiliary wheel engages the floor surface to at least partially support movement of the patient transport apparatus over the floor surface, and
      a stowed position where the auxiliary wheel is spaced from the floor surface; and
   an override assembly coupled to the linkage of the braking system and to the auxiliary wheel assembly to move the auxiliary wheel away from the deployed position and toward the stowed position in response to movement of the braking system from the released state toward the braked state to concurrently:
      inhibit movement of the base along the floor surface in the braked state, and
      at least partially disengage the auxiliary wheel from the floor surface.
XXVI. The patient transport apparatus of clause XXV, wherein the auxiliary wheel assembly further comprises an auxiliary frame coupled to the base, wherein the auxiliary wheel and the actuator are operatively attached to the auxiliary frame.
XXVII. The patient transport apparatus of clause XXVI, wherein the auxiliary frame comprises:
   a first auxiliary rail extending longitudinally along the patient transport apparatus and coupled to a first base rail of the base;
   a second auxiliary rail extending longitudinally along the patient transport apparatus and coupled to a second base rail of the base;
   a first crossmember extending between the first auxiliary rail and the second auxiliary rail at a first end of the auxiliary wheel assembly; and
   a second crossmember extending between the first auxiliary rail and the second auxiliary rail at a second end of the auxiliary wheel assembly.
XXVIII. The patient transport apparatus of clause XXVII, wherein the auxiliary wheel assembly further comprises an axle assembly supporting the auxiliary wheel, the axle assembly being operatively attached to the first crossmember for pivoting movement relative to the first crossmember to move the auxiliary wheel between the plurality of auxiliary support positions including the deployed position and the stowed position.
XXIX. The patient transport apparatus of clause XXVIII, wherein the actuator is coupled to the axle assembly at a first actuator end and is operatively attached to the second crossmember at a second actuator end and is configured to move the axle assembly to move the auxiliary wheel between the deployed position and the stowed position.
XXX. The patient transport apparatus of clause XXIX, wherein the axle assembly further comprises:
   a first axle subassembly rotatably supporting the auxiliary wheel, the first axle subassembly operatively attached to the first crossmember for pivoting movement relative to the first crossmember; and
   a second axle subassembly operatively attached to the first axle subassembly and the first crossmember for pivoting movement relative to the first crossmember, wherein the first actuator end is coupled to the second axle subassembly for moving the axle assembly to move the auxiliary wheel between the deployed position and the stowed position.
XXXI. The patient transport apparatus of clause XXX, further comprising a first spring cartridge arranged between the first axle subassembly and the first crossmember to bias the axle assembly toward the deployed position and allow the axle assembly to deflect toward the stowed position in response to engagement of the auxiliary wheel with uneven floor surfaces.
XXXII. The patient transport apparatus of any one of clauses XXX or XXXI, further comprising a second spring cartridge arranged between the second axle subassembly and the first axle subassembly to allow the second axle subassembly to deflect relative to the first axle subassembly in response to engagement of the auxiliary wheel with uneven floor surfaces.
XXXIII. The patient transport apparatus of any one of clauses XXX to XXXII, wherein the first crossmember further comprises a first pair of brackets extending longitudinally from a first end of the first crossmember and a second pair of brackets extending longitudinally from a second end of the first crossmember, wherein the first pair of brackets and the second pair of brackets define coaxial bores defining a pivot axis.
XXXIV. The patient transport apparatus of clause XXXIII, wherein the first axle subassembly is coupled to the first and second pair of brackets via one or more shafts disposed in the coaxial bores for pivoting movement about the pivot axis.
XXXV. The patient transport apparatus of clause XXXIII, wherein the second axle subassembly is coupled to the first and second pair of brackets via a shaft disposed in the coaxial bores for pivoting movement about the pivot axis.
XXXVI. The patient transport apparatus of any one of clauses XXVI to XXXV, wherein:
   the auxiliary wheel assembly further comprises an axle assembly supporting the auxiliary wheel, the axle assembly being coupled to the auxiliary frame for pivoting movement relative to the auxiliary frame to move the auxiliary wheel between the plurality of auxiliary support positions including the deployed position and the stowed position; and
   the actuator is coupled to the axle assembly at a first actuator end and is operatively attached to the auxiliary frame at a second actuator end and is configured to move the axle assembly to move the auxiliary wheel between the deployed position and the stowed position.
XXXVII. The patient transport apparatus of clause XXXVI, wherein the override assembly further comprises:
   a carriage extending longitudinally between a first carriage end spaced from the auxiliary frame and a second carriage end coupled to the auxiliary frame; and
   a trolley coupled to the second actuator end of the actuator and engaged with the carriage to guide movement of the second actuator end along the carriage between:
      an operational position where the second actuator end is secured in spaced relation at a first distance from the auxiliary frame to support the actuator for moving the auxiliary wheel between the deployed position and the stowed position, and
      an override position where the second actuator end is secured in spaced relation at a second distance, less than the first distance, from the auxiliary frame to move the actuator to at least partially disengage the auxiliary wheel from the floor surface.
XXXVIII. The patient transport apparatus of clause XXXVII, wherein the override assembly further comprises an override linkage coupled to and arranged between the auxiliary frame and the second actuator end, the override linkage configured for movement between:
   an extended state where the override linkage moves the second actuator end to the operational position, and
   a collapsed state where the override linkage moves the second actuator end to the override position.
XXXIX. The patient transport apparatus of clause XXXVIII, wherein the linkage is in a brake state when the braking system is in the braked state, and the brake input device is further configured to move the linkage between a neutral state and a steer state when the braking system is in the released state.
XL. The patient transport apparatus of clause XXXIX, wherein override assembly further comprises an override member coupled to and extending between the linkage of the braking system and the override linkage to concurrently move the override linkage from the extended state to the collapsed state as the linkage moves from the steer state to the brake state.
XLI. The patient transport apparatus of any one of clauses XXXIX or XL, wherein the override linkage comprises:
   a first link including a first link mounting end coupled to the second actuator end for pivoting movement relative to the second actuator end, and a first link pivot end; and
   a second link including a second link mounting end coupled to the auxiliary frame for pivoting movement relative to the auxiliary frame, and a second link pivot end coupled to the first link pivot end for pivoting movement relative to the first link pivot end.
XLII. The patient transport apparatus of clause XLI, wherein override assembly further comprises an override member coupled to and extending between the linkage of the braking system and one of the first link pivot end and the second link pivot end to concurrently move the override linkage from the extended state to the collapsed state as the linkage moves from the steer state to the brake state.
XLIII. The patient transport apparatus of clause XLII, wherein the linkage of the braking system includes
   a hex shaft that rotates in response to the linkage moving between the brake state and the steer state; and
   a pivot arm that extends from the hex shaft and is coupled to the override member to convert rotation of the hex shaft into translation of the override member to concurrently move the override linkage from the extended state to the collapsed state as the linkage moves from the steer state to the brake state.
XLIV. The patient transport apparatus of any one of clauses XXV to XLIII, wherein the auxiliary wheel assembly further comprises an axle assembly supporting the auxiliary wheel, the axle assembly coupled to the base for pivoting movement relative to the base to move the auxiliary wheel between the plurality of auxiliary support positions including the deployed position and the stowed position.
XLV. The patient transport apparatus of clause XLIV, further comprising a stop member disposed on one of the base and the axle assembly, the stop member arranged to abut the other of the base and the axle assembly to delimit motion of the axle assembly toward the base where the auxiliary wheel is in the stowed position.
XLVI. The patient transport apparatus of any one of clauses XLIV or XLV, wherein the override assembly further comprises a cam member disposed between the base and the axle assembly, wherein the cam member is operatively attached to the axle assembly to move the axle assembly relative to the base, the cam member configured to move between a plurality of cam positions including:
   a cam lower position where the auxiliary wheel is in the stowed position, and
   a cam lift position where the cam member moves the auxiliary wheel to the deployed position.
XLVII. The patient transport apparatus of clause XLVI, wherein the auxiliary wheel assembly further comprises a roller coupled to the axle assembly and disposed between the axle assembly and the cam member, the roller configured to abut the cam member and rotate to allow the cam member to move between the plurality of cam positions.
XLVIII. The patient transport apparatus of clause XLVII, wherein the cam member defines a plurality of detents configured to engage the roller to hold the cam member in a corresponding cam position, the plurality of detents including:
   a cam lower detent for holding the cam member in the cam lower position; and
   a cam lift detent for holding the cam member in the cam lift position.
XLIX. The patient transport apparatus of clause XLVIII, wherein the plurality of detents further includes a cam intermediate detent arranged between the cam lower detent and the cam lift detent for holding the cam member in a cam intermediate position between the cam lift position and the cam lower position.
L. The patient transport apparatus of clause XLIX, wherein when the cam member is in the cam intermediate position, the cam member moves the axle assembly to an intermediate position between the stowed position and the deployed position.
LI. The patient transport apparatus of any one of clauses XLVI to L, wherein the auxiliary wheel assembly further comprises a biasing member coupled to the base and operatively attached to the axle assembly, the biasing member configured to urge the axle assembly against the cam member.
LII. The patient transport apparatus of any one of clauses XLVI to LI, wherein the auxiliary wheel assembly further comprises a cam driver coupled to the cam member for concurrent rotation with the cam member.
LIII. The patient transport apparatus of clause LII, wherein the linkage is in a brake state when the braking system is in the braked state, and the brake input device is further configured to move the linkage between a neutral state and a steer state when the braking system is in the released state.
LIV. The patient transport apparatus of clause LIII, wherein override assembly further comprises an override member coupled to and extending between the linkage of the braking system and the cam driver to concurrently move the cam member from the cam lift position to the cam lower position as the linkage moves from the steer state to the brake state.
LV. The patient transport apparatus of clause LIV, wherein the actuator is operatively attached to the cam driver to move the cam member between the plurality of cam positions.
LVI. The patient transport apparatus of clause LV, wherein:
   the actuator is configured to generate torque about an actuator axis;
   the cam driver defines a slot extending between a first slot end and a second slot end; and
   the auxiliary wheel assembly further comprises an actuator driving member coupled to the actuator for concurrent rotation with the actuator about the actuator axis, the actuator driving member including a projection spaced from the actuator axis and disposed in the slot of the cam driver to translate within the slot and abut one of the first slot end and the second slot end to transfer motion from the actuator to move the cam member between the plurality of cam positions.
LVII. The patient transport apparatus of clause LVI, wherein the actuator is configured to generate torque to rotate the actuator driving member to abut the projection of the actuator driving member against the first slot end to concurrently rotate the actuator driving member and the cam driver to move the cam member toward the cam lift position.
LVIII. The patient transport apparatus of any one of clauses LVI or LVII, wherein the actuator is configured to generate torque to rotate the actuator driving member to abut the projection of the actuator driving member against the second slot end to concurrently rotate the actuator driving member and the cam driver to move the cam member toward the cam lower position.
LIX. The patient transport apparatus of any one of clauses LVI to LVIII, wherein the slot of the cam driver extends between the first slot end and the second slot end about an arc, the arc being shaped to permit translation of the projection within the slot without abutting one of the first slot end and the second slot end in response to movement of the cam member due to operation of the override assembly.
LX. The patient transport apparatus of clause LIX, wherein the actuator is configured to move the actuator driving member to a home position after moving the cam member to prevent the projection from abutting one of the first slot end and the second slot end in response to movement of the cam member due to operation of the override assembly.
LXI. The patient transport apparatus of any one of clauses XXV to LX, further comprising:
   an electrical braking assembly including:
      a driving member coupled to the linkage, and
      a brake actuator coupled to the driving member and configured to move the driving member to a first position and a second position; and
   wherein a movement of the driving member to the first position causes the linkage to place the braking system in the braked state and a movement of the driving member to the second position causes the linkage to place the braking system in the released state.
LXII. The patient transport apparatus of clause LXI, further comprising:
   a user interface having an input device arranged for user engagement; and
   a controller disposed in electrical communication with the electrical braking assembly and the user interface, the controller configured to drive the actuator in response to user engagement with the input device to move the braking system between the braked state and the released state; and
   wherein the controller is configured to operate the actuator to move the auxiliary wheel to the stowed position in response to the braking system being placed in the braked state.
LXIII. The patient transport apparatus of clause LXII, wherein the auxiliary wheel assembly further comprises an auxiliary wheel drive system including a motor operatively attached to the auxiliary wheel and configured to generate torque to rotate the auxiliary wheel.
LXIV. The patient transport apparatus of any one of clauses XXV to LXIII, further comprising a spring cartridge arranged between the support structure and the auxiliary wheel to bias the auxiliary wheel toward the deployed position and allow the auxiliary wheel to deflect in response to engagement with uneven floor surfaces.
LXV. The patient transport apparatus of any one of clauses XXV to LXIV, wherein the brake input device further comprises:
   a shaft operatively attached to the linkage of the braking system for concurrent movement with the linkage;
   a shaft driver coupled to the shaft for concurrent rotation with the shaft, the shaft driver defining a shaft driver slot extending between a slot brake end and a slot neutral end; and
   a pedal operatively attached to the shaft for pivoting movement relative to the shaft, the pedal including a pedal projection spaced from the shaft and disposed in the shaft driver slot to translate within the shaft driver slot and abut one of the slot brake end and the slot neutral end to transfer motion from the pedal to the shaft.
LXVI. The patient transport apparatus of clause LXV, wherein the pedal projection is configured to orbit around the shaft in a first direction in response to a user engaging a first side of the pedal to abut the pedal projection against the slot brake end to concurrently rotate the pedal and the shaft driver to move linkage to the braked state.
LXVII. The patient transport apparatus of clause LXVI, wherein the pedal projection is configured to orbit around the shaft in a second direction, opposite the first direction, in response to a user engaging a second side of the pedal, opposite the first side, to abut the pedal projection against the slot neutral end to concurrently rotate the pedal and the shaft driver to move the linkage to a neutral state.
LXVIII. The patient transport apparatus of any one of clauses LXV to LXVII, wherein the brake input device further comprises a brake input biasing member configured to urge the pedal projection of the pedal toward the slot brake end.
LXIX. The patient transport apparatus of any one of clauses XLIV to LXVIII, wherein the override assembly further comprises a cam assembly operatively attached to the axle assembly to move the axle assembly relative to the base, the cam assembly configured to move between a plurality of cam positions including:
   a cam lower position where the auxiliary wheel is in the stowed position, and
   a cam lift position where the cam assembly moves the auxiliary wheel to the deployed position.
LXX. The patient transport apparatus of clause LXIX, wherein the cam assembly comprises a coupling link operatively attached to the axle assembly, an intermediate link coupled to the coupling link for pivotal movement relative to the coupling link, and a cam member coupled to the intermediate link, wherein the coupling link and the intermediate link are configured to pivot relative to each other in response to rotation of the cam member to expand the cam assembly between the cam lower position and the cam lift position.
LXXI. The patient transport apparatus of clause LXX, wherein the intermediate link includes a first stop portion configured to abut the cam member to delimit rotation of the intermediate link relative to the cam member.
LXXII. The patient transport apparatus of any one of clauses LXX or LXXI, wherein the coupling link includes a second stop portion configured to abut the intermediate link to delimit rotation of the coupling link relative to the intermediate link.
LXXIII. The patient transport apparatus of any one of clauses LXX to LXXII, wherein the coupling link includes a third stop portion configured to abut the axle assembly to delimit rotation of the coupling link relative to the axle assembly.
LXXIV. The patient transport apparatus of any one of clauses LXX to LXXIII, wherein the auxiliary wheel assembly further comprises a roller arm extending between a first roller arm end portion operatively attached to the base for pivotal movement relative to the base, and a second roller arm end portion, the roller arm including a roller arranged to abut the cam member and rotate to allow the cam assembly to move between the cam lower position and the cam lift position.
LXXV. The patient transport apparatus of clause LXXIV, wherein the auxiliary wheel assembly further comprises a roller arm biasing member extending between one of the first roller arm end portion and the second roller arm end portion, and the axle assembly to urge the roller against the cam member and urge the axle assembly to move the auxiliary wheel toward the stowed position.
LXXVI. The patient transport apparatus of clause LXXV, wherein the auxiliary wheel assembly further comprises a roller arm damper extending between one of the first roller arm end portion and the second roller arm end portion, and the base to dampen motion of the roller arm relative to the base.
LXXVII. The patient transport apparatus of any one of clauses LXXV or LXXVI, wherein the auxiliary wheel assembly further comprises a cam damper extending between the cam member and the base to dampen motion of the cam member relative to the base.
LXXVIII. The patient transport apparatus of any one of clauses LXXV to LXXVII, wherein the cam member defines a plurality of detents configured to engage the roller to hold the cam assembly in a corresponding cam position, the plurality of detents including:
   a cam lower detent for holding the cam assembly in the cam lower position; and
   a cam lift detent for holding the cam assembly in the cam lift position.
LXXIX. The patient transport apparatus of clause LXXVIII, wherein the plurality of detents further includes a cam intermediate detent arranged between the cam lower detent and the cam lift detent for holding the cam assembly in a cam intermediate position between the cam lift position and the cam lower position.
LXXX. The patient transport apparatus of clause LXXIX, wherein when the cam assembly is in the cam intermediate position, the roller arm biasing member urges the axle assembly to move the auxiliary wheel to the stowed position.
LXXXI. The patient transport apparatus of any one of clauses LXX to LXXX, wherein the linkage is in a brake state when the braking system is in the braked state, and the brake input device is further configured to move the linkage between a neutral state and a steer state when the braking system is in the released state.
LXXXII. The patient transport apparatus of clause LXXXI, wherein override assembly further comprises an override member operatively attached to the linkage of the braking system and the cam member to concurrently move the cam assembly from the cam lift position to the cam lower position as the linkage moves from the steer state to the brake state.
LXXXIII. The patient transport apparatus of clause LXXXII, wherein override assembly further comprises a linkage damper operatively attached to the linkage and the base to dampen motion of the linkage relative to the base.
LXXXIV. The patient transport apparatus of any one of clauses LXXXII or LXXXIII, wherein the auxiliary wheel assembly further comprises a cam driver coupled to the cam member for concurrent rotation with the cam member.
LXXXV. The patient transport apparatus of clause LXXXIV, wherein the actuator is operatively attached to the cam driver to move the cam assembly between the plurality of cam positions.
LXXXVI. The patient transport apparatus of clause LXXXV, wherein:
   the actuator is configured to generate torque about an actuator axis;
   the auxiliary wheel assembly further comprises an actuator driving member coupled to the actuator for concurrent rotation with the actuator about the actuator axis, the actuator driving member defining a slot extending between a first slot end and a second slot end; and
   the cam driver includes a projection spaced from the actuator axis and disposed in the slot of the actuator driving member to translate within the slot and abut one of the first slot end and the second slot end to transfer motion from the actuator to the cam member to move the cam assembly between plurality of cam positions.
LXXXVII. The patient transport apparatus of clause LXXXVI, wherein the actuator is configured to generate torque to rotate the actuator driving member to abut the projection of the cam driver against the first slot end to concurrently rotate the actuator driving member and the cam driver to move the cam member to move the cam assembly to the cam lift position and the linkage to the steer state.
LXXXVIII. The patient transport apparatus of clause LXXXVII, wherein the actuator is configured to generate torque to rotate the actuator driving member to abut the projection of the cam driver against the second slot end to concurrently rotate the actuator driving member and the cam driver to move the cam member to move the cam assembly toward the cam lower position and the linkage to one of the neutral state and the brake state.
LXXXIX. The patient transport apparatus of clause LXXXVIII, wherein the slot of the actuator driving member extends between the first slot end and the second slot end about an arc, the arc being shaped to permit translation of the projection within the slot without abutting one of the first slot end and the second slot end in response to movement of the cam member due to operation of the override assembly.
XC. The patient transport apparatus of clause LXXXIX, wherein the actuator is configured to move the actuator driving member to a home position after moving the cam member to prevent the projection from abutting one of the first slot end and the second slot end in response to movement of the cam member due to operation of the override assembly.
XCI. The patient transport apparatus of any one of clauses LXXXIX or XC, wherein the override assembly further includes an actuator driving member position sensor arranged to detect the angular position of the actuator driving member, and the patient transport apparatus is configured to operate the actuator based on the sensed position of the actuator driving member.
XCII. The patient transport apparatus of any one of clauses LXXXIX to XCI, wherein the override assembly further includes a cam member position sensor arranged to detect the angular position of the cam member, and the patient transport apparatus is configured to operate the actuator based on the sensed position of the cam member.
XCIII. The patient transport apparatus of any one of clauses LXXXIX to XCII, wherein the brake input device further comprises a first pedal coupled to the linkage of the braking system for concurrent movement with the linkage, the first pedal arranged for user engagement to move the linkage of the braking system in a first direction between:
   a first pedal steer position where the linkage is in the steer state;
   a first pedal neutral position where the first pedal moves the linkage in the first direction to the neutral state; and
   a first pedal brake position where the first pedal moves the linkage in the first direction to the brake state.
XCIV. The patient transport apparatus of clause XCIII, further comprising a second pedal assembly coupled to the linkage of the braking system and arranged for user engagement to move the linkage of the braking system in a second direction, opposite the first direction.
XCV. The patient transport apparatus of clause XCIV, wherein the second pedal assembly comprises:
   a second pedal mount extending from the base;
   a second pedal extending between a second pedal interface arranged for user engagement and a second pedal connection end, wherein the second pedal is mounted to the second pedal mount between the second pedal interface and the second pedal connection end and supported for rotation relative to the second pedal mount; and
   a second pedal drive link coupled to the second pedal connection end for rotation relative to the second pedal connection end, the second pedal drive link defining a second pedal drive link slot extending between a first pedal slot end and a second pedal slot end, wherein the linkage of the braking system includes a linkage projection disposed within the second pedal drive link slot for movement within the second pedal drive link slot, wherein, in response to user engagement with the second pedal interface, the first pedal slot end is configured to abut the linkage projection to transfer motion from the second pedal to the linkage of the braking system to move the linkage in the second direction.
XCVI. The patient transport apparatus of clause XCV, wherein the brake input device further comprises a second pedal biasing member configured to urge the second pedal interface upward to abut the second pedal slot end against the linkage projection in the absence of user engagement with the second pedal interface.
XCVII. The patient transport apparatus of clause XCVI, wherein where the linkage is in the brake state, the second pedal interface is in a second pedal brake position and arranged for user engagement to move the second pedal drive link such that the first pedal slot end abuts the linkage projection to move the linkage in the second direction from the brake state to the neutral state.

1. A patient transport apparatus, the patient transport apparatus comprising:
a support structure including a base and a patient support deck;
a plurality of wheels coupled to the base for supporting movement of the patient transport apparatus over a floor surface;
a braking system including a linkage coupled to one or more of the plurality of wheels, the braking system operable between:
a braked state to inhibit movement of the base along the floor surface, and
a released state;
a brake input device in communication with the linkage and arranged for user engagement to change operation of the braking system between the braked state and the released state, wherein the linkage is in a brake state where the braking system is in the braked state, and the brake input device is further configured to move the linkage between a neutral state and a steer state where the braking system is in the released state;
an auxiliary wheel assembly including an auxiliary wheel, an axle assembly supporting the auxiliary wheel, the axle assembly coupled to the base for pivoting movement relative to the base, and an actuator configured to move the axle assembly and the auxiliary wheel between a plurality of auxiliary support positions including:
a deployed position where the auxiliary wheel engages the floor surface to at least partially support movement of the patient transport apparatus over the floor surface, and
a stowed position where the auxiliary wheel is spaced from the floor surface; and
an override assembly coupled to the linkage of the braking system and to the auxiliary wheel assembly to move the auxiliary wheel from the deployed position to the stowed position in response to movement of the linkage from the steer state to one of the neutral state and the brake state to at least partially disengage the auxiliary wheel from the floor surface.

2. The patient transport apparatus of claim 1, wherein the override assembly further comprises a cam assembly operatively attached to the axle assembly to move the axle assembly relative to the base, the cam assembly configured to move between a plurality of cam positions including:
a cam lower position where the auxiliary wheel is in the stowed position, and
a cam lift position where the cam assembly moves the auxiliary wheel to the deployed position.

3. The patient transport apparatus of claim 2, wherein the cam assembly comprises a coupling link operatively attached to the axle assembly, an intermediate link coupled to the coupling link for pivotal movement relative to the coupling link, and a cam member coupled to the intermediate link, wherein the coupling link and the intermediate link are configured to pivot relative to each other in response to rotation of the cam member to expand the cam assembly between the cam lower position and the cam lift position.

4. The patient transport apparatus of claim 3, wherein the auxiliary wheel assembly further comprises a roller arm extending between a first roller arm end portion operatively attached to the base for pivotal movement relative to the base, and a second roller arm end portion, the roller arm including a roller arranged to abut the cam member and rotate to allow the cam assembly to move between the plurality of cam positions.

5. The patient transport apparatus of claim 4, wherein the auxiliary wheel assembly further comprises a roller arm biasing member extending between one of the first roller arm end portion and the second roller arm end portion, and the axle assembly to urge the roller against the cam member and urge the axle assembly to move the auxiliary wheel toward the stowed position.

6. The patient transport apparatus of claim 5, wherein the auxiliary wheel assembly further comprises a cam damper extending between the cam member and the base to dampen motion of the cam member relative to the base.

7. The patient transport apparatus of claim 5, wherein the cam member defines a plurality of detents configured to engage the roller to hold the cam assembly in a corresponding cam position, the plurality of detents including:
a cam lower detent for holding the cam assembly in the cam lower position; and
a cam lift detent for holding the cam assembly in the cam lift position.

8. The patient transport apparatus of claim 7, wherein the plurality of detents further includes a cam intermediate detent arranged between the cam lower detent and the cam lift detent for holding the cam assembly in a cam intermediate position between the cam lift position and the cam lower position.

9. The patient transport apparatus of claim 8, wherein when the cam assembly is in the cam intermediate position, the roller arm biasing member urges the axle assembly to move the auxiliary wheel to the stowed position.

10. The patient transport apparatus of claim 9, wherein override assembly further comprises an override member operatively attached to the linkage of the braking system and the cam member to concurrently move the cam assembly between the cam lift position and the cam lower position as the linkage moves between the steer state and the brake state.

11. The patient transport apparatus of claim 10, wherein override assembly further comprises a linkage damper operatively attached to the linkage and the base to dampen motion of the linkage relative to the base.

12. The patient transport apparatus of claim 10, wherein the auxiliary wheel assembly further comprises a cam driver coupled to the cam member for concurrent rotation with the cam member.

13. The patient transport apparatus of claim 12, wherein the actuator is operatively attached to the cam driver to move the cam assembly between the plurality of cam positions.

14. The patient transport apparatus of claim 13, wherein:
the actuator is configured to generate torque about an actuator axis;
the auxiliary wheel assembly further comprises an actuator driving member coupled to the actuator for concurrent rotation with the actuator about the actuator axis, the actuator driving member defining a slot extending between a first slot end and a second slot end; and
the cam driver includes a projection spaced from the actuator axis and disposed in the slot of the actuator driving member to translate within the slot and abut one of the first slot end and the second slot end to transfer motion from the actuator to the cam member to move the cam assembly between plurality of cam positions.

15. The patient transport apparatus of claim 14, wherein the actuator is configured to generate torque to rotate the actuator driving member to abut the projection of the cam driver against the first slot end to concurrently rotate the actuator driving member and the cam driver to move the cam member to move the cam assembly to the cam lift position and the linkage to the steer state, and
wherein the actuator is configured to generate torque to rotate the actuator driving member to abut the projection of the cam driver against the second slot end to concurrently rotate the actuator driving member and the cam driver to move the cam member to move the cam assembly toward the cam lower position and the linkage to one of the neutral state and the brake state.

16. The patient transport apparatus of claim 15, wherein the slot of the actuator driving member extends between the first slot end and the second slot end about an arc, the arc being shaped to permit translation of the projection within the slot without abutting one of the first slot end and the second slot end in response to movement of the cam member due to operation of the override assembly.

17. The patient transport apparatus of claim 16, wherein the actuator is configured to move the actuator driving member to a home position after moving the cam member to prevent the projection from abutting one of the first slot end and the second slot end in response to movement of the cam member due to operation of the override assembly.

18. The patient transport apparatus of claim 16, wherein the override assembly further includes an actuator driving member position sensor arranged to detect the angular position of the actuator driving member, and the patient transport apparatus is configured to operate the actuator based on the sensed position of the actuator driving member.

19. The patient transport apparatus of claim 16, wherein the override assembly further includes a cam member position sensor arranged to detect the angular position of the cam member, and the patient transport apparatus is configured to operate the actuator based on the sensed position of the cam member.

20. The patient transport apparatus of claim 16, wherein the brake input device further comprises a first pedal coupled to the linkage of the braking system for concurrent movement with the linkage, the first pedal arranged for user engagement to move the linkage of the braking system in a first direction between:
a first pedal steer position where the linkage is in the steer state;
a first pedal neutral position where the first pedal moves the linkage in the first direction to the neutral state; and
a first pedal brake position where the first pedal moves the linkage in the first direction to the brake state.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)
